(19) United States
(12) Patent Application Publication
(10) Pub. No.: US 2005/0171923 A1
(43) Pub. Date: Aug. 4, 2005

(54) Method and apparatus for identifying diagnostic components of a system

(76) Inventors: Harri Kiiveri, Western Australia (AU); Albert Trajstman, Victoria (AU); Mervyn Thomas, Chapel Hill (AU)

Correspondence Address: LADAS & PARRY, 5670 WILSHIRE BOULEVARD, SUITE 2100, LOS ANGELES, CA, 90036-5679, US

(21) Appl. No.: 10/492,886

(22) PCT Filed: Oct. 17, 2002
(86) PCT No.: PCT/AU02/01417

(30) Foreign Application Priority Data
Oct. 17, 2001 (AU) PR 8321
Feb. 15, 2002 (AU) PS 0556
Apr. 19, 2002 (AU) PS 1844

(51) Int. Cl. G06F 7/00

(52) U.S. Cl. 707/1

(57) ABSTRACT

Method and apparatus is described for identifying a subset of components of a system, the subset being capable of predicting a feature of a test sample. The method comprises generating a linear combination of components and component weights in which values for each component are determined from data generated from a plurality of training samples, each training sample having a known feature. A model is defined for the probability distribution of a feature wherein the model is conditional on the linear combination and wherein the model is not a combination of a binomial distribution for a two class response with a probit function linking the linear combination and the expectation of the response. A prior distribution is constructed for the component weights of the linear combination comprising a hyperprior having a high probability density close to zero, and the prior distribution and the model are combined to generate a posterior distribution. A subset of components is identified having component weights that maximise the posterior distribution.

### FIELD OF THE INVENTION

The present invention relates to a method and apparatus for identifying components of a system from data generated from samples from the system, which components are capable of predicting a feature of the sample within the system and, particularly, but not exclusively, the present invention relates to a method and apparatus for identifying components of a biological system from data generated by a biological method, which components are capable of predicting a feature of interest associated with a sample from the biological system.

### BACKGROUND OF THE INVENTION

There are any number of “systems” in existence which can be classified into different features of interest. The term “system” essentially includes all types of systems for which data can be provided, including chemical systems, financial systems (e.g. credit systems for individuals, groups or organisations, loan histories), geological systems, and many more. It is desirable to be able to utilise data generated from the systems (e.g. statistical data) to identify particular features of samples from the system (e.g. to assist with analysis of a financial system to identify the groups which exist in the financial system (e.g. in very simple terms those who have “good” credit and those who are a credit risk). Where there is a large amount of statistical data, the identification of components from that data which are predictive of a particular feature of a sample from the system is a difficult task, generally because there is a large amount of data to process, the majority of which may not provide any indication or little indication of the features of interest of a particular sample from which the data is taken. In addition, components that are identified using training sample data are often ineffective at identifying features on test samples data when the test sample data has a high degree of variability relative to the training sample data. This is often the case in situations when, for example, data is obtained from many different sources, as it is often impossible to control the conditions under which the data is collected from each individual source.

An example of a type of system where these problems are particularly pertinent, is a biological system and the following description refers specifically to biological systems. The present invention is not limited to use with biological systems, however, and it has general application to any system.

Recent advances in biotechnology have resulted in the development of biological methods for large scale screening of systems and analysis of samples. Such methods include, for example, DNA, RNA or antibody microarray analysis, proteomics analysis, proteomics electrophoresis gel analysis and high throughput screening techniques. These types of methods often result in the generation of data that can have up to 30,000 or more components for each sample that is tested.

It is obviously important to be able to identify features of interest in samples from biological systems. For example, to classify groups such as “diseased” and “non-diseased”. Many of these biological methods would be useful as diagnostic tools predicting features of a sample in the biological systems (e.g. for identifying diseases by screening tissues or body fluids, or as tools for determining, for example, the efficacy of pharmaceutical compounds).

Use of biological methods such as biotechnology arrays in such applications to date has been limited owing to the large amount of data that is generated from these types of methods, and the lack of efficient methods for screening the data for meaningful results. Consequently, analysis of biological data using prior art methods either fails to make full use of the information inn the data, or is time consuming, prone to false positive and negative results and requires large amounts of computer memory if a meaningful result is to be obtained from the data. This is problematic in large scale screening scenarios where rapid and accurate screening is required.

There is therefore a need for an improved method, in particular for analysis of biological data, and, more generally, for an improved method of analysing data from any system in order to predict a feature of interest for a sample from the system.

### SUMMARY OF THE INVENTION

In a first aspect, the invention provides a method for identifying a subset of components of a system, the subset being capable of predicting a feature of a test sample, the method comprising the steps of;
(a) generating a linear combination of components and component weights in which values for each component are determined from data generated from a plurality of training samples, each training sample having a known feature;
(b) defining a model for the probability distribution of a feature wherein the model is conditional on the linear combination and wherein the model is not a combination of a binomial distribution for a two class response with a probit function linking the linear combination and the expectation of the response;
(c) constructing a prior distribution for the component weights of the linear combination comprising a hyperprior having a high probability density close to zero;
(d) combining the prior distribution and the model to generate a posterior distribution;
(e) identifying a subset of components having component weights that maximise the posterior distribution.

The method utilises training samples having a known feature in order to identify a subset of components which can predict a feature for a training sample. Subsequently, knowledge of the subset of components can be used for tests, for example clinical tests, to predict a feature such as whether a tissue sample is malignant or benign, or what is the weight of a tumour, or provide an estimated time for survival of a patient having a particular condition. As used herein, the term “feature” refers to any response or identifiable trait or character that is associated with a sample. For example, a feature may be a particular time to an event for a particular sample, or the size or quantity of a sample, or the class or group into which a sample can be classified.

The method of the present invention estimates the component weights utilising a Bayesian statistical method. Preferably, where there are a large amount of components generated from the system (which will usually be the case for the method of the present invention to be effective) the method preferably makes an a priori assumption that the majority of the components are unlikely to be components that will form part of the subset of components for predicting a feature. The assumption is therefore made that the majority of component weights are likely to be zero. A model is constructed which, with this assumption in mind, sets the component weights so that the posterior probability of the weights is maximised. Components having a weight below a pre-determined threshold (which will be the majority of them in accordance with the a priori assumption) are dispensed with. The process is iterated until the remaining diagnostic components are identified. This method is quick, mainly because of the a priori assumption which results in rapid elimination of the majority of components.

Most features of a system typically exhibit a probability distribution, and the probability distribution of a feature can be modelled using statistical models which are based on the data generated from the training samples. The method of the invention utilises statistical models which model the probability distribution for a feature of interest or a series of features of interest. Thus, for a feature of interest having a particular probability distribution, an appropriate model is defined that models that distribution. The method may use any model that is conditional on the linear combination, and is preferably a mathematical equation in the form of a likelihood function that provides a probability distribution based on the data obtained from the training samples. Preferably, the likelihood function is based on a previously described model for describing some probability distribution. In one embodiment, the model is a likelihood function based on a model selected from the group consisting of a multinomial or binomial logistic regression, generalised linear model, Cox's proportional hazards model, accelerated failure model, parametric survival model, a chi-squared distribution model or an exponential distribution model.

In one embodiment, the likelihood function is based on a multinomial or binomial logistic regression. The binomial or multinomial logistic regression preferably models a feature having a multinomial or binomial distribution. A binomial distribution is a statistical distribution having two possible classes or groups such as an on/off state. Examples of such groups include dead/alive, improved/not improved, depressed/not depressed. A multinomial distribution is a generalisation of the binomial distribution in which a plurality of classes or groups are possible for each of a plurality of samples, or in other words, a sample may be classified into one of a plurality of classes or groups. Thus, by defining a likelihood function based on a multinomial or binomial logistic regression, it is possible to identify subsets of components that are capable of classifying a sample into one of a plurality of pre-defined groups or classes. To do this, training samples are grouped into a plurality of sample groups (or “classes”) based on a predetermined feature of the training samples in which the members of each sample group have a common feature and are assigned a common group identifier. A likelihood function is formulated based on a multinomial or binomial logistic regression conditional on the linear combination (which incorporates the data generated from the grouped training samples). The feature may be any desired classification by which the training samples are to be grouped. For example, the features for classifying tissue samples may be that the tissue is normal, malignant or benign; the feature for classifying cell samples may be that the cell is a leukemia cell or a healthy cell, that the training samples are obtained from the blood of patients having or not having a certain condition, or that the training samples are from a cell from one of several types of cancer as compared to a normal cell.

Preferably, the likelihood function based on the logistic regression is of the form:

$$L = {\prod }_{i = 1}^{n} ( {\prod }_{g = 1}^{G - 1} {\{ \frac{{ⅇ}^{{x}_{i}^{T} {β}_{g}}}{( 1 + {\sum }_{g = 1}^{G - 1} {ⅇ}^{{x}_{i}^{T} {β}_{g}} )} \}}^{{e}_{ig}} {\{ \frac{1}{1 + {\sum }_{h = 1}^{G - 1} {ⅇ}^{{x}_{i}^{T} {β}_{h}}} \}}^{{e}_{iG}} )$$

wherein
xᵢ^{T}β_{g} is a linear combination generated from input data from training sample i with component weights β_{g};
xᵢ^{T} is the components for the i^{th} Row of X and β_{g} is a set of component weights for sample class g;
e_{ig}=1 if training sample i is a member of class g, e_{ig}=0 otherwise; and
X is data from n training samples comprising p components.

In another embodiment, the likelihood function is based on an ordered categorical logistic regression. The ordered categorical logistic regression models a multinomial distribution in which the classes are in a particular order (ordered classes such as for example, classes of increasing or decreasing disease severity). By defining a likelihood function based on an ordered categorical logistic regression, it is possible to identify a subset of components that is capable of classifying a sample into a class wherein the class is one of a plurality of predefined ordered classes. By defining a series of group identifiers in which each group identifier corresponds to a member of an ordered class, and grouping the training samples into one of the ordered classes based on predetermined features of the training samples, a likelihood function can be formulated based on a categorical ordered logistic regression which is conditional on the linear combination (which incorporates the data generated from the grouped training samples).

Preferably, the likelihood function based on the categorical ordered logistic regression is of the form:

$$L = {\prod }_{i = 1}^{N} {\prod }_{k = 1}^{G - 1} {( \frac{{γ}_{ik}}{{γ}_{ik + 1}} )}^{{r}_{ik}} {( \frac{{γ}_{ik + 1} - {γ}_{ik}}{{γ}_{ik + 1}} )}^{{r}_{ik + 1} - {r}_{ik}}$$

$$log it ( \frac{{γ}_{ik + 1} - {γ}_{ik}}{{γ}_{ik + 1}} ) = log it ( \frac{{π}_{ik}}{{γ}_{ik + 1}} ) = {θ}_{k} + {x}_{i}^{T} {β}^{*}$$

Wherein
γᵢₖ is the probability that training sample i belongs to a class with identifier less than or equal to k (where the total of ordered classes is G);
xᵢ^{T}β* is a linear combination generated from input data from training sample i with component weights β*;
xᵢ^{T} is the components for the i^{th} Row of X;
rᵢⱼ is as defined as;

$${r}_{ij} = {\sum }_{g = 1}^{j} {c}_{ig}$$

$$where$$

$${c}_{ij} = \{ \begin{matrix}1 , & if observation i in class j \\ 0 , & otherwise\end{matrix}$$

In another embodiment of the present invention, the likelihood function is based on a generalised linear model. The generalised linear model preferably models a feature which has a distribution belonging to the regular exponential family of distributions. Examples of regular exponential family distributions include normal distribution, Gaussian distribution, Poisson distribution, gamma distribution and inverse gamma distribution. Thus, in another embodiment of the method of the invention, a subset of components is identified that is capable of predicting a predefined characteristic of a sample that lies within a regular exponential family of distributions by defining a generalised linear model which models the characteristic to be predicted. Examples of a characteristic that may be predicted using a generalised linear model include any quantity of a sample that exhibits the specified distribution such as, for example, the weight, size, counts, group membership or other dimensions or quantities or properties of a sample.

Preferably, the generalised linear model is of the form:

$$log p ( y \vert β , φ ) = {\sum }_{i = 1}^{N} \{ \frac{{y}_{i} {θ}_{i} - b ( {θ}_{i} )}{{a}_{i} ( φ )} + c ( {y}_{i} , φ ) \}$$

Wherein
y=(y₁, . . . , yₙ)^{T}, and yᵢ is the characteristic measured on the i^{th} sample;
aᵢ(φ)=φ/wᵢ with the wᵢ being a fixed set of known weights and φ a single scale parameter;
the functions b(.) and c(.)are preferably as defined by Nelder and Wedderburn (1972);

Preferably,
E{yᵢ}=b′(θᵢ)
Var{y}=b″(θᵢ)aᵢ(φ)=τᵢ²aᵢ(φ).

Preferably, each observation has a set of covariates xᵢ and a linear predictor ηᵢ=xᵢ^{T} β. The relationship between the mean of the i^{th} observation and its linear predictor is preferably given by the link function ηᵢ=g(μᵢ)=g(b′(θᵢ)). The inverse of the link is denoted by h, which is preferably:
E{yᵢ}=b′(θᵢ)=h(ηᵢ).

In another embodiment, the method of the present invention may be used to predict the time to an event for a sample by utilising a likelihood function based on a hazard model which preferably estimates the probability of a time to an event given that the event has not taken place at the time of obtaining the data. In one embodiment, the likelihood function is based on a model selected from the group consisting of Cox's proportional hazards model, parametric survival model and accelerated failure times model. Cox's proportional hazards model permits the time to an event to be modelled on a set of components and component weights without making restrictive assumptions about the form of the hazard function. The accelerated failure model is a general model for data consisting of survival times in which the component measurements are assumed to act multiplicatively on the time-scale, and so affect the rate at which an individual proceeds along the time axis. Thus, the accelerated survival model can be interpreted in terms of the speed of progression of, for example, disease. The parametric survival model is one in which the distribution function for the time to an event (eg survival time) is modelled by a known distribution or has a specified parametric formulation. Among the commonly used survival distributions are the Weibull, exponential and extreme value distributions.

Preferably, a subset of components capable of predicting the time to an event for a sample is identified by defining a likelihood based on Cox's proportional hazards model, a parametric survival model or an accelerated survival times model, which comprises measuring the time elapsed for a plurality of samples from the time the sample is obtained to the time of the event.

Preferably, the likelihood function for predicting the time to an event is of the form:
Log (Partial) Likelihood=

$${\sum }_{i = 1}^{N} {g}_{i} ( {β}_{∼} , {φ}_{∼} ; X , {y}_{∼} , {c}_{∼} )$$

where {tilde under (β)}¹=(β₁,β₂, . . . ,βₚ) and {tilde under (φ)}¹=(φ₁,φ₂, . . . ,φ_{q}) are the model parameters.

Preferably, the likelihood function based on Cox's proportional hazards model is of the form:

$$L ( {t}_{∼} \vert {β}_{∼} ) = {\prod }_{j = 1}^{N} {( \frac{exp ( {Z}_{j} {β}_{∼} )}{{\sum }_{i ∈ {ℜ}_{j}} exp ( {Z}_{i} {β}_{∼} )} )}^{{d}_{j}}$$

Where Z is preferably a matrix that is the re-arrangement of the rows of X where the ordering of the rows of Z corresponds to the ordering induced by the ordering of the survival times and d is the result of ordering the censoring index with the same permutation required to order survival times. Also Zⱼ is the j^{th} row of the matrix Z and dⱼ is the j^{th} element of d and where {tilde under (β)}^{T}=(β₁,β₂, . . . ,βₚ) and [symbol] ⱼ={i:i=j,j+1, . . . ,N}=the risk set at the j^{th} ordered event time t₍ⱼ₎.

Preferably the log likelihood function based on the Parametric Survival model is of the form:

$$log ( L ) = {\sum }_{i = 1}^{N} \{ {c}_{i} log ( {μ}_{i} ) - {μ}_{i} + {c}_{i} ( log ( \frac{λ ( {y}_{i} )}{Λ ( {y}_{i} ; {φ}_{∼} )} ) ) \}$$

where
μᵢ=Λ(yᵢ;{tilde under (φ)})exp(Xᵢ{tilde under (β)});
cᵢ=1 if the i^{th} sample is uncensored and cᵢ=0 if the i^{th} sample is uncensored.

This form of the likelihood function is shared by the Weibull, exponential and extreme value distributions. The functions λ(.) and Λ(.) are as defined by Aitkin and Clayton (1980).

For any defined models, the component weights are typically estimated using a Bayesian statistical model (Kotz and Johnson, 1983) in which a posterior distribution of the component weights is formulated which combines the likelihood function and a prior distribution. The component weights are estimated by maximising the posterior distribution of the weights given the data generated for each training sample. Thus, the objective function to be maximised consists of the likelihood function based on a model for the feature as discussed above and a prior distribution for the weights.

Preferably, the prior distribution is of the form:

$$p ( β ) = {\int }_{{v}^{2}}^{} p ( β \vert {v}^{2} ) p ( {v}^{2} ) ⅆ {v}^{2}$$

wherein v is a p×1 vector of hyperparameters, and where p(β|v²) is N(0,diag{v²}) and p(v²) is some hyperprior distribution for v². This hyperprior distribution (which is preferably the same for all embodiments of the method) may be expressed using different notational conventions, and in the detailed description of the preferred embodiments (see below), the following notational conventions are adopted merely for convenience for the particular preferred embodiment:

As used herein, when the likelihood function for the probability distribution is based on a multinomial or binomial logistic regression, the notation for the prior distribution is:

$$P ( {β}_{1} … , {β}_{i - 1} ) = {\int }_{{τ}^{2}} {\prod }_{g = 1}^{G - 1} P ( {β}_{g} \vert {τ}_{g}^{2} ) P ( {τ}_{g}^{2} ) ⅆ {τ}^{2} where$$

$${β}^{T} = ( {β}_{1}^{T} , … {β}_{G - 1}^{T} ) and {τ}^{T} = ( {τ}_{1}^{T} , … , {τ}_{G - 1}^{T} ) .$$

and p(β_{g}|τ_{g}²) is N(0,diag{τ_{g}²}) and P(τ_{g}²) is some hyperprior distribution for τ_{g}².

As used herein, when the likelihood function for the probability distribution is based on a categorical ordered logistic regression, the notation for the prior distribution is:

$$P ( {β}_{1} , {β}_{2} , … , {β}_{n} ) = {\int }_{τ} {\prod }_{i = 1}^{N} P ( {β}_{i} \vert {τ}_{i} ) P ( {τ}_{i} ) ⅆ τ$$

where β₁,β₂, . . . ,βₙ are component weights, P(βᵢ|τᵢ) is N(0,τᵢ²) and P(τᵢ) some hyperprior distribution for τᵢ.

As used herein, when the likelihood function for the distribution is based on a generalised linear model, the notation for the prior distribution is:

$$p ( β ) = {\int }_{{τ}^{2}}^{} p ( β \vert {ν}^{2} ) p ( {ν}^{2} ) ⅆ {ν}^{2}$$

wherein v is a p×1 vector of hyperparameters, and where p(β|v²) is N(0,diag{v²}) and p(v²) is some prior distribution for v².

As used herein, when the likelihood function for the distribution is based on a hazard model, the notation for the prior distribution is:

$$p ( {β}^{*} ) = {\int }_{{τ}^{2}}^{} p ( {β}^{*} \vert {ν}^{2} ) p ( {ν}^{2} ) ⅆ {ν}^{2}$$

where p(β*|v²) is N(0,diag{v²}) and p(v²) some hyperprior distribution for v².

The prior distribution comprises a hyperprior that ensures that zero weights are preferred whenever possible.

Preferably, the hyperprior is a Jeffrey's hyperprior (Kotz and Johnson, 1983).

As discussed above, the prior distribution and the likelihood function are combined to generate a posterior distribution. The posterior distribution is preferably of the form:
p(βφv|y)αL(y|βφ)p(β|v²)p(v²)
wherein L({tilde under (y)}|{tilde under (β)},{tilde under (φ)}) is the likelihood function.

The component weights in the posterior distribution are preferably estimated in an iterative procedure such that the probability density of the posterior distribution is maximised. During the iterative procedure, component weights having a value less than a pre-determined threshold are eliminated, preferably by setting those component weights to zero. This results in elimination of the corresponding component.

Preferably, the iterative procedure is an EM algorithm. The EM algorithm produces a sequence of component weight estimates that converge to give component weights that maximise the probability density of the posterior distribution. The EM algorithm consists of two steps, known as the E or Expectation step and the M, or Maximisation step. In the E step, the expected value of the log-posterior function conditional on the observed data and current parameter values is determined. In the M step, the expected log-posterior function is maximised to give updated component weight estimates that increase the likelihood. The two steps are alternated until convergence of the E step and the M step is achieved, or in other words, until the expected value and the maximised value of the log-posterior function converge.

It is envisaged that the method of the present invention may be applied to any system from which measurements can be obtained, and preferably systems from which very large amounts of data are generated. Examples of systems to which the method of the present invention may be applied include biological systems, chemical systems, agricultural systems, weather systems, financial systems including, for example, credit risk assessment systems, insurance systems, marketing systems or company record systems, electronic systems, physical systems, astrophysics systems and mechanical systems. For example, in a financial system, the samples may be particular stock and the components may be measurements made on any number of factors which may affect stock prices such as company profits, employee numbers, number of shareholders etc.

The method of the present invention is particularly suitable for use in analysis of biological systems. The method of the present invention may be used to identify subsets of components for classifying samples from any biological system which produces measurable values for the components and in which the components can be uniquely labelled. In other words, the components are labelled or organised in a manner which allows data from one component to be distinguished from data from another component. For example, the components may be spatially organised in, for example, an array which allows data from each component to be distinguished from another by spatial position, or each component may have some unique identification associated with it such as an identification signal or tag. For example, the components may be bound to individual carriers, each carrier having a detectable identification signature such as quantum dots (see for example, Rosenthal, 2001, Nature Biotech 19: 621-622; Han et al. (2001) Nature Biotechnology 19: 631-635), fluorescent markers (see for example, Fu et al, (1999) Nature Biotechnology 17: 1109-1111), bar-coded tags (see for example, Lockhart and Trulson (2001) Nature Biotechnology 19: 1122-1123).

In a particularly preferred embodiment, the biological system is a biotechnology array. Examples of biotechnology arrays (examples of which are described in Schena et al., 1995, Science 270: 467-470; Lockhart et al. 1996, Nature Biotechnology 14: 1649; U.S. Pat. No. 5,569,5880) include oligonucleotide arrays, DNA arrays, DNA microarrays, RNA arrays, RNA microarrays, DNA microchips, RNA microchips, protein arrays, protein microchips, antibody arrays, chemical arrays, carbohydrate arrays, proteomics arrays, lipid arrays. In another embodiment, the biological system may be selected from the group including, for example, DNA or RNA electrophoresis gels, protein or proteomics electrophoresis gels, biomolecular interaction analysis such as Biacore analysis, amino acid analysis, ADMETox screening (see for example High-throughput ADMETox estimation: In Vitro and In Silico approaches (2002), Ferenc Darvas and Gyorgy Dorman (Eds), Biotechniques Press), protein electrophoresis gels and proteomics electrophoresis gels.

The components may be any measurable component of the system. In the case of a biological system, the components may be, for example, genes or portions thereof, DNA sequences, RNA sequences, peptides, proteins, carbohydrate molecules, lipids or mixtures thereof, physiological components, anatomical components, epidemiological components or chemical components.

The training samples may be any data obtained from a system in which the feature of the sample is known. For example, training samples may be data generated from a sample applied to a biological system. For example, when the biological system is a DNA microarray, the training sample may be data obtained from the array following hybridisation of the array with RNA extracted from cells having a known feature, or cDNA synthesised from the RNA extracted from cells, or if the biological system is a proteomics electrophoresis gel, the training sample may be generated from a protein or cell extract applied to the system.

The inventors envisage that the method of the present invention may be used in one embodiment in re-evaluating or evaluating test data from subjects who have presented mixed results in response to a test treatment. Thus, in a second aspect, the present invention provides a method for identifying a subset of components of a subject which are capable of classifying the subject into one of a plurality of predefined groups wherein each group is defined by a response to a test treatment comprising the steps of:
(a) exposing a plurality of subjects to the test treatment and grouping the subjects into response groups based on responses to the treatment;
(b) measuring components of the subjects;
(c) identifying a subset of components that is capable of classifying the subjects into response groups using a statistical analysis method.

Preferably, the statistical analysis method is a method according to the first aspect of the invention.

Once a subset of components has been identified, that subset can be used to classify subjects into groups such as those that are likely to respond to the test treatment and those that are not. In this manner, the method of the present invention permits treatments to be identified which may be effective for a fraction of the population, and permits identification of that fraction of the population that will be responsive to the test treatment.

In a third aspect, the present invention provides an apparatus for identifying a subset of components of a subject, the subset being capable of classifying the subject into one of a plurality of predefined response groups wherein each response group is formed by exposing a plurality of subjects to a test treatment and grouping the subjects into response groups based on the response to the treatment, the apparatus comprising;
(a) means for receiving measured components of the subjects;
(b) means for identifying a subset of components that is capable of classifying the subjects into response groups using a statistical analysis method.

Preferably, the statistical analysis method is the method according to the first or second aspect.

In a fourth aspect, the present invention provides a method for identifying a subset of components of a subject which are capable of classifying the subject as being responsive or non-responsive to treatment with a test compound comprising the steps of:
(a) exposing a plurality of subjects to the compound and grouping the subjects into response groups based on each subjects response to the compound;
(b) measuring components of the subjects;
(c) identifying a subset of components that is capable of classifying the subjects into response groups using a statistical analysis method.

Preferably, the statistical analysis method is the method according to the first aspect.

In a fifth aspect, the present invention provides an apparatus for identifying a subset of components of a subject, the subset being capable of classifying the subject into one of a plurality of predefined response groups wherein each response group is formed by exposing a plurality of subjects to a compound and grouping the subjects into response groups based on the response to the compound, the apparatus comprising;
(c) means for receiving measured components of the subjects;
(d) means for identifying a subset of components that is capable of classifying the subjects into response groups using a statistical analysis method.

Preferably, the statistical analysis method is the method according to the first or second aspect of the invention.

The components that are measured in the second to fifth aspects of the invention may be, for example, genes or small nucleotide polymorphisms (SNPs), proteins, antibodies, carbohydrates, lipids or any other measureable component of the subject.

In a particularly preferred embodiment, the compound is a pharmaceutical compound or a composition comprising a pharmaceutical compound and a pharmaceutically acceptable carrier.

The identification method of the present invention may be implemented by appropriate computer software and hardware.

In accordance with a sixth aspect, the present invention provides an apparatus for identifying a subset of components of a system from data generated from the system from a plurality of samples from the system, the subset being capable of predicting a feature of a test sample, the apparatus comprising;
(a) means for generating a linear combination of components and component weights in which values for each component are introduced from data generated from a plurality of training samples, each training sample having a known feature;
(b) means for defining a model for the probability distribution of a feature wherein the model is conditional on the linear combination and wherein the model is not a combination of a binomial distribution for a two class response with a probit function linking the linear combination and the expectation of the response;
(c) means for constructing a prior distribution for the component weights of the linear combination comprising a hyperprior having a high probability density close to zero;
(d) means for combining the prior distribution and the model to generate a posterior distribution;
(e) means for identifying a subset of components having component weights that maximise the posterior distribution.

The apparatus may comprise an appropriately programmed computing device.

In accordance with a seventh aspect, the present invention provides a computer program arranged, when loaded onto a computing apparatus, to control the computing apparatus to implement a method in accordance with the first aspect of the present invention.

The computer program may implement any of the preferred algorithms and method steps of the first or second aspect of the present invention which are discussed above.

In accordance with a eighth aspect of the present invention, there is provided a computer readable medium providing a computer program in accordance with the fourth aspect of the present invention.

In accordance with a ninth aspect of the present invention, there is provided a method of testing a sample from a system to identify a feature of the sample, the method comprising the steps of testing for a subset of components which is diagnostic of the feature, the subset of components having been determined by a method in accordance with the first or second aspect of the present invention.

Preferably, the system is a biological system.

In accordance with a tenth aspect of the present invention, there is provided an apparatus for testing a sample from a system to determine a feature of the sample, the apparatus including means for testing for components identified in accordance with the method of the first or second aspect of the present invention.

In accordance with an eleventh aspect, the present invention provides a computer program which when run on a computing device, is arranged to control the computing device, in a method of identifying components from a system which are capable of predicting a feature of a test sample from the system, and wherein a linear combination of components and component weights is generated from data generated from a plurality of training samples, each training sample having a known feature, and a posterior distribution is generated by combining a prior distribution for the component weights comprising a hyperprior having a high probability distribution close to zero, and a model that is conditional on the linear combination wherein the model is not a combination of a binomial distribution for a two class response with a probit function linking the linear combination and the expectation of the response, to estimate component weights which maximise the posterior distribution.

Where aspects of the present invention are implemented by way of a computing device, it will be appreciated that any appropriate computer hardware e.g. a PC or a mainframe or a networked computing infrastructure, may be used.

In a twelfth aspect, the present invention provides a method for identifying a subset of components of a biological system, the subset being capable of predicting a feature of a test sample from the biological system, the method comprising the steps of:
(a) generating a linear combination of components and component weights in which values for each component are determined from data generated from a plurality of training samples, each training sample having a known feature;
(b) defining a model for the probability distribution of a feature wherein the model is conditional on the linear combination;
(c) constructing a prior distribution for the component weights of the linear combination comprising a hyperprior having a high probability density close to zero;
(d) combining the prior distribution and the model to generate a posterior distribution;
identifying a subset of components having component weights that maximise the posterior distribution.

### BRIEF DESCRIPTION OF THE FIGURES

FIG. 1 illustrates the results of a permutation test on prediction success of an embodiment of the present invention. Class labels were randomly permuted 200 times, and the analysis repeated for each permutation. The histogram shows the distribution of prediction success under permutation. The number of samples that were correctly classified is shown on the x-axis and the frequency is shown on the y-axis.

FIG. 2 illustrates the results of a permutation test on prediction success of an embodiment of the present invention. Class labels were randomly permuted 200 times, and the analysis repeated for each permutation. The histogram shows the distribution of prediction success under permutation of the class labels. The x-axis is the percentage of the total of samples and the y-axis (lambda) is the percent of cases correctly classified.

FIG. 3 illustrates a plot of the curve for a generalised linear model used in one embodiment of the method of the invention. The fitted curve (solid line) is produced when 5 components selected by the method are used in the model, and the true curve (dotted line) is shown as a dotted line, and the data (nf, y-axis) from 200 observations (x-axis) based on the 5 components is shown as circles.

FIG. 4 illustrates a plot of the fitted probabilities for a single gene identified using an embodiment of the method of the invention. The gene index is shown on the x-axis and the probability of the sample belonging to a particular ordered class is shown on the y-axis. The lines denote classes as follows: dashed line=class 1, solid line=class 2, dotted line=class 3, dotted and dashed line class 4.

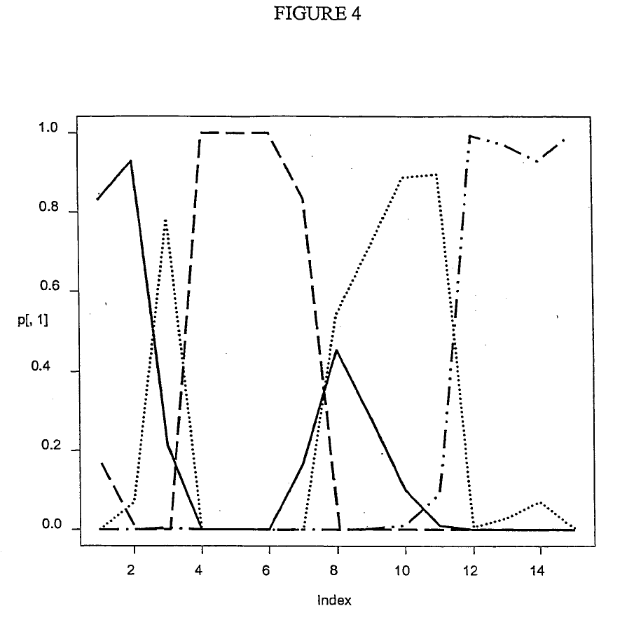

FIG. 5 is a schematic representation of a personal computer used to implement a system according to the present invention.

### DETAILED DESCRIPTION OF THE PREFERRED EMBODIMENTS

The present invention identifies preferably a minimum number of components which can be used to identify whether a particular training sample has a particular feature. The minimum number of components is “diagnostic” of that feature, or enables discrimination between samples having a different feature. Essentially, from all the data which is generated from the system, the method of the present invention enables identification of a minimum number of components which can be used to test for a particular feature. Once those components have been identified by this method, the components can be used in future to assess new samples. The method of the present invention utilises a statistical method to eliminate components that are not required to correctly predict the feature.

The inventors have found that component weights of a linear combination of components of data generated from the training samples can be estimated in such a way as to eliminate the components that are not required to correctly predict the feature of the training sample. The result is that a subset of components are identified which can correctly predict the feature of the training sample. The method of the present invention thus permits identification from a large amount of data a relatively small number of components which are capable of correctly predicting a feature.

The method of the present invention also has the advantage that it requires usage of less computer memory than prior art methods which use joint rather than marginal information on components. Accordingly, the method of the present invention can be performed rapidly on computers such as, for example, laptop machines. By using less memory, the method of the present invention also allows the method to be performed more quickly than prior art methods which use joint (rather than marginal) information on components for analysis of, for example, biological data.

A first embodiment relating to a multiclass logistic regression model will now be described.

A. Multi Class Logistic Regression Model

The method of this embodiment utilises the training samples in order to identify a subset of components which can classify the training samples into pre-defined groups. Subsequently, knowledge of the subset of components can be used for tests, for example clinical tests, to classify samples into groups such as disease classes. For example, a subset of components of a DNA microarray may be used to group clinical samples into clinically relevant classes such as, for example, healthy or diseased.

In this way, the present invention identifies preferably a minimum number of components which can be used to identify whether a particular training sample belongs to a particular group. The minimum number of components is “diagnostic” of that group, or enables discrimination between groups. Essentially, from all the data which is generated from the system, the method of the present invention enables identification of a minimum number of components which can be used to test for a particular group. Once those components have been identified by this method, the components can be used in future to classify new samples into the groups. The method of the present invention preferably utilises a statistical method to eliminate components that are not required to correctly identify the group the sample belongs to.

The samples are grouped into sample groups (or “classes”) based on a pre-determined classification. The classification may be any desired classification by which the training samples are to be grouped. For example, the classification may be whether the training samples are from a leukemia cell or a healthy cell, or that the training samples are obtained from the blood of patients having or not having a certain condition, or that the training samples are from a cell from one of several types of cancer as compared to a normal cell.

In one embodiment, the input data is organised into an n×p data matrix X=(xᵢⱼ) with n training samples and p components. Typically, p will be much greater than n.

In another embodiment, data matrix X may be replaced by an n×n kernel matrix K to obtain smooth functions of X as predictors instead of linear predictors. An example of the kernel matrix K is kᵢⱼ=exp(−0.5*(xᵢ−xⱼ)^{t}(xᵢ−xⱼ)/σ²) where the subscript on x refers to a row number in the matrix X. Ideally, subsets of the columns of K are selected which give sparse representations of these smooth functions. Further examples of kernel matrices are given in table 2 below. (is table 3 needed at all ?)

Associated with each sample class (group) may be a class label yᵢ, where yᵢ=k,kε{1, . . . ,G}, which indicates which of G sample classes a training sample belongs to. We write the n×1 vector with elements yᵢ as y. Given the vector {tilde under (y)} we can define indicator variables

$${e}_{ig} = \{ \begin{matrix}1 , & {y}_{i} = g \\ 0 , & otherwise\end{matrix} \qquad ( 1 A )$$

In one embodiment, the component weights are estimated using a Bayesian statistical model (see Kotz and Johnson, 1983). Preferably, the weights are estimated by maximising the posterior distribution of the weights given the data generated from each training sample. This results in an objective function to be maximised consisting of two parts. The first part a likelihood function and the second a prior distribution for the weights which ensures that zero weights are preferred whenever possible. In a preferred embodiment, the likelihood function is derived from a multiclass logistic model. Preferably, the likelihood function is computed from the probabilities:

$$\begin{matrix}{p}_{ig} = \frac{{ⅇ}^{{x}_{i}^{T} {β}_{g}}}{( 1 + {\sum }_{h = 1}^{G - 1} {ⅇ}^{{x}_{i}^{T} {β}_{h}} )} , g = 1 , … , G - 1 \\ and & ( 2 A ) \\ {p}_{iG} = \frac{1}{( 1 + {\sum }_{h = 1}^{G - 1} {ⅇ}^{{x}_{i}^{T} {β}_{h}} )} & ( 3 A )\end{matrix}$$

Wherein
p_{ig} is the probability that the training sample with input data Xᵢ will be in sample class g;
xᵢ^{T}β_{g} is a linear combination generated from input data from training sample i with component weights βᵢ;
xᵢ^{T} is the components for the i^{th} Row of X and β_{g} is a set of component weights for sample class g;

Typically, as discussed above, the component weights are estimated in a manner which takes into account the a priori assumption that most of the component weights are zero.

In one embodiment, components weights β_{g} in equation (2A) are estimated in a manner whereby most of the values are zero, yet the samples can still be accurately classified.

In one embodiment, the prior specified for the parameters β₁, . . . ,β_{G-1} is of the form:

$$P ( {β}_{1} … , {β}_{G - 1} ) = {\int }_{{τ}^{2}} {\sum }_{g = 1}^{G - 1} P ( {β}_{g} \vert {τ}_{g}^{2} ) P ( {τ}_{g}^{2} ) ⅆ {τ}^{2} \qquad ( 4 A )$$

where β^{T}=(β₁^{T}, . . . β_{G-1}^{T}) and τ^{T}=(τ₁^{T}, . . . ,τ_{G-1}^{T}). and p(β_{g}|τ_{g}²) is N(0,diag{τ_{g}²}) and

$$p ( {τ}_{g}^{2} ) α {\prod }_{i = 1}^{n} 1 / {τ}_{ig}^{2}$$

is a Jeffreys hyperprior, Kotz and Johnson(1983).

In one embodiment, the likelihood function is L({tilde under (y)}|β₁, . . . ,β_{G-1}) of the form in equation (8A) and the posterior distribution of β and {tilde under (τ)} given y is
p(βτ|y)αL(y|β)p(β|τ)p(τ) (5A)

In one embodiment, the first derivative is determined from the following equation:

$$\frac{\partial log L}{\partial {β}_{g}} = {X}^{T} ( {{e}_{g}}_{\sim} - {p}_{g} ) , g = 1 , … , G - 1 \qquad ( 6 A )$$

wherein {tilde under (e)}_{g}^{T}=(e_{ig},i=1,n), p_{g}^{T}=(p_{ig},i=1,n) are vectors indicating membership of sample class g and probability of class g respectively.

In one embodiment, the second derivative is determined from the following algorithm:

$$\frac{{\partial }^{2} log L}{\partial {β}_{g} \partial {β}_{h}} = - {X}^{T} diag \{ {δ}_{hg} {p}_{g} - {p}_{h} {p}_{g} \} X \qquad ( 7 A )$$

Equation 6 and equation 7 may be derived as follows:
(a) Using equations (1A), (2A) and (3A), the likelihood function of the data can be written as:

$$L = {\prod }_{i = 1}^{n} ( {\prod }_{g = 1}^{G - 1} {\{ \frac{{ⅇ}^{{x}_{i}^{T} {β}_{g}}}{( 1 + {\sum }_{g = 1}^{G - 1} {ⅇ}^{{x}_{i}^{T} {β}_{g}} )} \}}^{{e}_{ig}} {\{ \frac{1}{1 + {\sum }_{h = 1}^{G - 1} {ⅇ}^{{x}_{i}^{T} {β}_{h}}} \}}^{{e}_{iG}} ) \qquad ( 8 A )$$
(b) Taking logs of equation (8A) and using the fact that

$${\sum }_{h = 1}^{G} {e}_{ih} = 1$$

for all i gives:

$$log L = {\sum }_{i = 1}^{n} ( {\sum }_{g = 1}^{G - 1} {e}_{ig} {x}_{i}^{T} {β}_{g} - log ( + {\sum }_{g = 1}^{G - 1} {ⅇ}^{{x}_{i}^{T} {β}_{g}} ) ) \qquad ( 9 A )$$
(c) Differentiating equation (9A) with respect to β_{g} gives

$$\frac{\partial log L}{\partial {β}_{g}} = {X}^{T} ( {{e}_{g}}_{\sim} - {p}_{g} ) , g = 1 , … , G - 1 \qquad ( 10 A )$$

whereby {tilde under (e)}_{g}^{T}=(e_{ig},i=1,n), p_{g}^{T}=(p_{ig},i=1,n) are vectors indicating membership of sample class g and probability of class g respectively.
(d) The second derivative of equation (9A) has elements

$$\frac{{\partial }^{2} log L}{\partial {B}_{g} \partial {B}_{h}} = - {X}^{T} diag \{ {δ}_{hg} {p}_{g} - {p}_{h} {p}_{g} \} X \\ where {δ}_{hg} = \{ \begin{matrix}1 , & h = g \\ 0 , & otherwise\end{matrix} \qquad ( 11 A )$$

Component weights which maximise the posterior distribution of the likelihood function may be specified using an EM algorithm comprising an E step and an M step.

Typically, the EM algorithm comprises the steps:
(a) performing an E step by calculating the conditional expected value of the posterior distribution of component weights using the function:

$$Q = log L - \frac{1}{2} {\sum }_{g = 1}^{G = 1} {γ}_{g}^{T} diag {\{ {\hat{γ}}_{g} \}}^{- 2} {γ}_{g} \qquad ( 12 A )$$

where xᵢ^{T}β_{g}=xᵢ^{T}P_{g}\hat{γ}_{g} in equation (8A)
(b) performing an M step by applying an iterative procedure to maximise Q as a function of γ whereby:

$${γ}^{t + 1} = {γ}^{t} - {{α}^{t} ( \frac{{\partial }^{2} Q}{\partial {γ}^{2}} )}^{- 1} ( \frac{\partial Q}{\partial γ} ) \qquad ( 13 A )$$

where α¹ is a step length such that 0≦α′≦1;
β_{g}=P_{g}β_{g};
wherein P_{g} are matrices of zeroes and ones such that P^{T}_{g}β_{g} selects non-zero elements of β_{g}; and
β=(γ_{g}, g=1, . . . , G-1).

Equation (12A) may be derived as follows:

Calculate the conditional expected value of 5A) given the observed data y and a set of parameter estimates \hat{β}.
Q=Q(β|{tilde under (y)},\hat{β})=E{log p({tilde under (β)},τ|y)|y,\hat{β})

Consider the case when components of β (and \hat{β}) are set to zero i.e for g=1, . . . ,G-1, β_{g}=P_{g}γ_{g} and \hat{β}_{g}=P_{g}\hat{γ}_{g}, where the P_{g} are matrices of zeroes and ones such that P_{g}^{T}β_{g} selects the non zero elements of β_{g}. In the following we write γ=(γ_{g}, g=1, . . . ,G-1). Note that the γ_{g} are actually subsets of the components of β_{g}. We use them to keep the notation as simple as possible.

Ignoring terms not involving γ and using (4A), (5A), (9A) we get:

$$\begin{matrix}Q = log L - \frac{1}{2} {\sum }_{g = 1}^{G = 1} {\sum }_{i = 1}^{n} E \{ \frac{{γ}_{ig}^{2}}{{τ}_{ig}^{2}} \vert γ , {\hat{γ}}_{\sim} \} \\ = log L - \frac{1}{2} {\sum }_{g = 1}^{G = 1} {γ}_{g}^{T} diag {\{ {\hat{γ}}_{g} \}}^{- 2} {γ}_{g} \\ where {x}_{i}^{T} {β}_{g} = {x}_{i}^{T} {P}_{g} {\hat{γ}}_{g} in ( 8 A ) \end{matrix} \qquad ( 14 A )$$

Note that the conditional expectation can be evaluated from first principles given (4A).

The iterative procedure may be derived as follows:

To obtain the derivatives required in (13A), first note that from (8A), (9A) and (10A) we get

$$\begin{matrix}\begin{matrix}\frac{\partial Q}{\partial γ} = ( \frac{\partial β}{\partial γ} ) \frac{\partial log L}{\partial β} - diag {\{ \hat{γ} \}}^{- 2} γ \\ = [ \begin{matrix}{X}_{1}^{T} ( {e}_{1} - {p}_{1} ) \\ ⋮ \\ {X}_{G - 1}^{T} ( {e}_{G - 1} - {p}_{G - 1} )\end{matrix} ] - diag {\{ {\hat{γ}}_{\sim} \}}^{- 2} γ\end{matrix} \\ and & ( 15 A ) \\ \begin{matrix}\frac{{\partial }^{2} Q}{\partial {{γ}_{\sim}}^{2}} = ( \frac{\partial β}{\partial γ} ) \frac{{\partial }^{2} log L}{{\partial }^{2} β} {( \frac{\partial β}{\partial γ} )}^{T} - diag {\{ \hat{γ} \}}^{- 2} \\ = - \{ ( \begin{matrix}{X}_{1}^{T} {Δ}_{1 , 1} {X}_{1} & … & {X}_{1}^{T} {Δ}_{1 , G - 1} {X}_{G - 1} \\ ⋮ & & ⋮ \\ {X}_{G - 1} {Δ}_{G - 1 , 1} {X}_{1} & & {X}_{G - 1} {Δ}_{G - 1 , G - 1} {X}_{G - 1}\end{matrix} ) + \\ diag {\{ \hat{γ} \}}^{- 2} \}\end{matrix} \\ where \begin{matrix}{Δ}_{gh} = diag \{ {δ}_{gh} {p}_{g} - {p}_{g} {p}_{h} \} , \\ {δ}_{gh} = \{ \begin{matrix}1 , \\ 0 ,\end{matrix} \begin{matrix}g = h \\ otherwise\end{matrix}\end{matrix} \\ and & ( 16 A ) \\ {X}_{g}^{T} + {P}_{g}^{T} {X}^{T} , g = 1 , … G - 1. & ( 17 A )\end{matrix}$$

In a preferred embodiment, the iterative procedure may be simplified by using only the block diagonals of equation (16A) in equation (13A). For g=1, . . . G-1, this gives:

$${γ}_{g}^{t + 1} = {γ}_{g}^{t} + {α}^{t} {\{ {X}_{g}^{T} {Δ}_{gg} {X}_{g} + diag {\{ {\hat{γ}}_{g} \}}^{- 2} \}}^{- 1} \{ {X}_{g}^{T} ( {e}_{g} - {p}_{g} ) - diag {\{ {\hat{γ}}_{g} \}}^{- 1} {γ}_{g}^{t} \} \qquad ( 18 A )$$

Rearranging equation (18A) leads to

$$\begin{matrix}{γ}_{g}^{t + 1} = {γ}_{g}^{t} + {α}^{t} diag \{ {\hat{γ}}_{g} \} {( {Y}_{g}^{T} {Δ}_{gg} {Y}_{g} + I )}^{- 1} \\ {\{ {Y}_{g}^{T} ( {e}_{g} - {p}_{g} ) - diag {\{ {\hat{γ}}_{g} \}}^{- 1} {γ}_{g}^{t} \}}^{- 1} \\ where \\ {Y}_{g}^{T} = diag \{ {\hat{γ}}_{g} \} {X}_{g}^{T}\end{matrix} \qquad ( 19 A )$$

Writing p(g) for the number of columns of Y_{g}, (19A) requires the inversion of a p(g)×p(g) matrix which may be quite large. This can be reduced to an n×n matrix for p(g)>n by noting that:

$$\begin{matrix}{( {Y}_{g}^{T} {Δ}_{gg} {Y}_{g} + I )}^{- 1} = I - {{Y}_{g}^{t} ( {Y}_{g} {Y}_{g}^{T} + {Δ}_{gg}^{- 1} )}^{- 1} {Y}_{g} \\ = I - {{Z}_{g}^{T} ( {Z}_{g} {Z}_{g}^{T} + {I}_{n} )}^{- 1} {Z}_{g}\end{matrix} \qquad ( 20 A )$$

where

$$Z - g = {Δ}_{gg}^{\frac{1}{2}} {Y}_{g} .$$

Preferably, (19A) is used when p(g)<n and (19A) with (20A) substituted into equation (19A) is used when p(g)≧n.

In a preferred embodiment, the EM algorithm is performed as follows:

1. Set n=0, P_{g}=I and choose an initial value for \hat{γ}⁰. This is done by ridge regression of log(p_{ig}/p_{iG}) on xᵢ where p_{ig} is chosen to be near one for observations in group g and a small quantity >0 otherwise—subject to the constraint of all probabilities summing to one.

2. Do the E step i.e evaluate Q=Q(γ|{tilde under (y)},\hat{γ}ⁿ)

3. Set t=0. For g=1, . . . , G-1 calculate:
a) δ_{g}^{t}=γ_{g}^{t+1}−γ_{g}^{t} using (19A) with (20A) substituted into (19A) when p(g)≧n.
(b) Writing δ^{t}=(δ_{g}^{t},g=1, . . . , G-1) Do a line search to find the value of α^{t} in {tilde under (γ)}^{t+1}={tilde under (γ)}+α^{t}{tilde under (δ)}^{t} which maximises (or simply increases) (12A) as a function of α^{t}.
c) set {tilde under (γ)}^{t+1}={tilde under (γ)}^{t} and t=t+1
   Repeat steps (a) and (b) until convergence.

This produces γ^{*n+1} say which maximises the current Q function as a function of γ.

For g=1, . . . G-1 determine

$${S}_{g} = \{ j \text{:} \vert {γ}_{j g}^{* n + 1} \vert \leq ɛ {max}_{k} \vert {γ}_{k g}^{* n + 1} \vert \}$$

Where e<<1, say 10⁻⁵. Define P_{g} so that β_{ig}=0 for iεS_{g} and
\hat{γ}_{g}ⁿ⁺¹={γ_{jg}^{*n+1}, jS_{g}}

This step eliminates variables with small coefficients from the model.

4. Set n=n+1 and go to 2 until convergence.

A second embodiment relating to an categorical ordered logistic regression will now be described.

B. Ordered Categories Model

The method of this embodiment may utilise the training samples in order to identify a subset of components which can be used to determine whether a test sample belongs to a particular class. For example, to identify genes for assessing a tissue biopsy sample using microarray analysis, microarray data from a series of samples from tissue that has been previously ordered into classes of increasing or decreasing disease severity such as normal tissue, benign tissue, localised tumour and metastasised tumour tissue are used as training samples to identify a subset of components which is capable of indicating the severity of disease associated with the training samples. The subset of components can then be subsequently used to determine whether previously unclassified test samples can be classified as normal, benign, localised tumour or metastasised tumour. Thus, the subset of components is diagnostic of whether a test sample belongs to a particular class within an ordered set of classes. It will be apparent that once the subset of components have been identified, only the subset of components need be tested in future diagnostic procedures to determine to what ordered class a sample belongs.

The method of the invention is particularly suited for the analysis of very large amounts of data. Typically, large data sets obtained from test samples is highly variable and often differs significantly from that obtained from the training samples. The method of the present invention is able to identify subsets of components from a very large amount of data generated from training samples, and the subset of components identified by the method can then be used to classifying test samples even when the data generated from the test sample is highly variable compared to the data generated from training samples belonging to the same class. Thus, the method of the invention is able to identify a subset of components that are more likely to classify a sample correctly even when the data is of poor quality and/or there is high variability between samples of the same ordered class.

The minimum number of components is “predictive” for that particular ordered class. Essentially, from all the data which is generated from the system, the method of the present invention enables identification of a minimum number of components which can be used to classify the training data. Once those components have been identified by this method, the components can be used in future to classify test samples. The method of the present invention preferably utilises a statistical method to eliminate components that are not required to correctly classify the sample into a class that is a member of an ordered class.

In the following there are N samples, and vectors such as y, z and μ have components yᵢ, zᵢ and μᵢ for i=1, . . . , N. Vector multiplication and division is defined component-wise and diag{•} denotes a diagonal matrix whose diagonals are equal to the argument. We also use ∥•∥ to denote Euclidean norm.

Preferably, there are N observations yᵢ where yᵢ takes integer values 1, . . . ,G. The values denote classes which are ordered in some way such as for example severity of disease. Associated with each observation there is a set of covariates (variables, e.g gene expression values) arranged into a matrix X with N rows and p columns wherein N is the samples and p the components. The notation xᵢ^{T} denotes the i^{th} row of X. Individual (sample) i has probabilities of belonging to class k given by πᵢₖ=πₖ(xᵢ).

Define cumulative probabilities

$${γ}_{ik} = {\sum }_{g = 1}^{k} {π}_{ik} , k = 1 , … , G$$

Note that γᵢₖ is just the probability that observation i belongs to a class with index less than or equal to k. Let C be a n by p matrix with elements cᵢⱼ given by

$${c}_{ij} = \{ \begin{matrix}1 , if observation i in class j \\ 0 , otherwise\end{matrix}$$

and let R be an n by P matrix with elements rᵢⱼ given by

$${r}_{ij} = {\sum }_{g = 1}^{j} {c}_{ig}$$

These are the cumulative sums of the columns of C within rows.

For independent observations (samples) the likelihood of the data can be written as

$$L = {\prod }_{i = 1}^{N} {\prod }_{k = 1}^{G - 1} {( \frac{{γ}_{ik}}{{γ}_{ik + 1}} )}^{{r}_{ik}} {( \frac{{γ}_{ik + 1} - {γ}_{ik}}{{γ}_{ik + 1}} )}^{{r}_{ik + 1} - {r}_{ik}} \qquad ( 1 B )$$

and the log likelihood (log(L)) l can be written as

$$l = {\sum }_{i = 1}^{N} {\sum }_{k = 1}^{G - 1} {r}_{ik} log ( \frac{{γ}_{ik}}{{γ}_{ik + 1}} ) + ( {r}_{ik + 1} - {r}_{ik} ) log ( \frac{{γ}_{ik + 1} - {γ}_{ik}}{{γ}_{ik + 1}} ) \qquad ( 2 B )$$

The continuation ratio model may be adopted here as follows:

$$log it ( \frac{{γ}_{ik + 1} - {γ}_{ik}}{{γ}_{ik + 1}} ) = log it ( \frac{{π}_{ik}}{{γ}_{ik + 1}} ) = {θ}_{k} + {x}_{i}^{T} {β}^{*} \qquad ( 3 B )$$

for k2, . . . , G, see McCullagh and Nelder(1989) and McCullagh(1980) and the discussion therein. Note that

$$log it ( \frac{{γ}_{ik + 1} - {γ}_{ik}}{{γ}_{ik + 1}} ) = - log it ( \frac{{γ}_{ik}}{{γ}_{ik + 1}} ) . \qquad ( 4 B )$$

The likelihood is equivalent to a logistic regression likelihood with response vector y and covariate matrix X
y=vec{R}
X=[B₁^{T}B₂^{T} . . . B_{N}^{T}]^{T}
Bᵢ=[I_{G-1}|1_{G-1}xᵢ^{T}]
where I_{G-1} is the G-1 by G-1 identity matrix and 1_{G-1} is a G-1 by 1 vector of ones.

Here vec{ } takes the matrix and forms a vector row by row.

Typically, as discussed above, the component weights are estimated in a manner which takes into account the a priori assumption that most of the component weights are zero.

Following Figueiredo(2001), in order to eliminate redundant variables (covariates), a prior is specified for the parameters β* by introducing a p×1 vector of hyperparameters.

Preferably, the prior specified for the component weights is of the form

$$p ( {β}^{*} ) = {\int }_{{v}^{2}}^{} p ( {β}^{*} \vert {v}^{2} ) p ( {v}^{2} ) ⅆ {v}^{2} \qquad ( 5 B )$$

where p(β*|v²) is N(0,diag{v²}) and

$$p ( {v}^{2} ) α {\prod }_{i = 1}^{n} 1 / {v}_{i}^{2}$$

is a Jeffreys prior, Kotz and Johnson(1983). The elements of θ=(θ₂, . . . θ_{G})^{T} have a non informative prior.

Writing L({tilde under (y)}|β*θ) for the likelihood function, in a Bayesian framework the posterior distribution of β*, θ and v given y is
p(β*θv|y)αL(y|β*θ)p(β*|v)p(v) (6B)

Preferably, by treating v as a vector of missing data, an iterative algorithm such as an EM algorithm (Dempster et al, 1977) can be used to maximise (6B) to produce locally maximum a posteriori estimates of β* and θ. The prior above is such that the maximum a posteriori estimates will tend to be sparse i.e. if a large number of parameters are redundant, many components of β* will be zero.

Preferably β^{T}=(θ^{T},β^{*T}) in the following and diag( ) denotes a diagonal matrix:

For the ordered categories model above it can be shown that

$$\begin{matrix}\frac{\partial 1}{\partial β} = {X}^{t} ( y - μ ) & ( 7 B ) \\ E \{ \frac{{\partial }^{2} 1}{\partial {β}^{2}} \} = - {X}^{* t} diag \{ μ ( 1 - μ ) \} {X}^{*} where \\ {μ}_{i} = exp ( {x}_{i}^{T} β ) / ( 1 + exp ( {x}_{i}^{T} β ) ) and {β}^{T} = ( {θ}_{2} , … , {θ}_{G} , {β}^{* T} ) . & ( 8 B )\end{matrix}$$

As mentioned above, the component weights which maximise ti,e posterior distribution may be determined using an iterative procedure. Preferable, the iterative procedure for maximising the posterior distribution of the components and component weights is an EM algorithm, such as, for example, that described in Dempster et al, 1977. Preferably, the EM algorithm is performed as follows:
1. Set n=0, S₀={1,2, . . . , p}, φ⁽⁰⁾, and ε=10⁻⁵ (say). Set the regularisation parameter κ at a value much greater than 1, say 100. This corresponds to adding 1/κ² to the first G-1 diagonal elements of the second derivative matrix in the M step below.

If p≦N compute initial values β* by
β*=(X^{t}X+λI)⁻¹X^{T}g(y+ζ) (9B)
and if p>N compute initial values β* by

$${β}^{*} = \frac{1}{λ} ( I - {{X}^{T} ( {XX}^{T} + λ I )}^{- 1} X ) {X}^{T} g ( y + ζ ) \qquad ( 10 B )$$

where the ridge parameter λ satisfies 0<λ≦1 and ζ is small and chosen so that the logit link function g is well defined at y+ζ.
2. Define

$${β}_{i}^{( n )} = \{ \begin{matrix}{β}_{i}^{*} , & i ɛ {S}_{n} \\ 0 , & otherwise\end{matrix}$$

and let Pₙ be a matrix of zeroes and ones such that the nonzero elements γ⁽ⁿ⁾ of β⁽ⁿ⁾ satisfy
γ⁽ⁿ⁾=Pₙ^{T}β⁽ⁿ⁾, β⁽ⁿ⁾=Pₙγ⁽ⁿ⁾
γ=Pₙ^{T}β, β=Pₙγ

Define w_{β}=(w_{βi},i=1,p), such that

$${w}_{β i} = \{ \begin{matrix}1 , & i \geq G \\ 0 , & otherwise\end{matrix}$$

and let w_{γ}=Pₙw_{β}
3. Perform the E step by calculating

$$\begin{matrix}Q ( β \vert {β}^{( n )} ) = E \{ log ( p ( β , v \vert y ) ) \vert y , {β}^{( n )} \} \\ = 1 ( y \vert β ) - 0.5 ( {‖ ( {β}^{*} {w}_{β} ) / {β}^{( n )} ‖}^{2} )\end{matrix} \qquad ( 11 B )$$

where l is the log likelihood function of y.

Using β=Pₙγ and β⁽ⁿ⁾=Pₙγ⁽ⁿ⁾ (11B) can be written as
Q(γ|γ⁽ⁿ⁾)=1(y|Pₙγ)−0.5 (∥(γ*w_{γ})/γ⁽ⁿ⁾∥²) (12B)
4. Do the M step. This can be done with Newton Raphson iterations as follows. Set γ₀=γ⁽ⁿ⁾ and for r=0,1,2, . . . γᵣ₊₁=γᵣ+αᵣ δᵣ where αᵣ is chosen by a line search algorithm to ensure Q(γᵣ₊₁|γ⁽ⁿ⁾)>Q(γᵣ|γ⁽ⁿ⁾).
For p≦N use

$$\begin{matrix}{δ}_{r} = {diag ( {\hat{γ}}^{( n )} ) [ {Y}_{n}^{T} {V}_{r}^{- 1} {Y}_{n} + I ]}^{- 1} ( {Y}_{n}^{T} {z}_{r} - \frac{{w}_{γ} {γ}_{r}}{{γ}^{( n )}} ) \\ where \\ {\hat{γ}}_{i}^{( n )} = \{ \begin{matrix}{γ}_{i}^{( n )} , & i \geq G \\ κ , & otherwise\end{matrix} \\ {Y}_{n}^{T} = diag ( {\hat{γ}}^{( n )} ) {P}_{n}^{T} {X}^{T} \\ {V}_{r}^{- 1} = diag \{ {μ}_{r} ( 1 - {μ}_{r} ) \} \\ {z}_{r} = ( y - {μ}_{r} ) \\ and \\ {μ}_{r} = exp ( X {P}_{n} {γ}_{r} ) / ( 1 + exp ( X {P}_{n} {γ}_{r} ) ) .\end{matrix} \qquad ( 13 B )$$

For p>N use

$${δ}_{r} = diag ( {\hat{γ}}^{( n )} ) [ I - {{Y}_{n}^{T} ( {Y}_{n} {Y}_{n}^{T} + {V}_{r} )}^{- 1} {Y}_{n} ] ( {Y}_{n}^{T} {z}_{r} - \frac{{w}_{γ} {γ}_{r}}{{γ}^{( n )}} ) \qquad ( 14 B )$$

with Vᵣ and Zᵣ defined as before.

Let γ* be the value of γᵣ when some convergence criterion is satisfied e.g
∥γᵣ−γᵣ₊₁∥<ε (for example 10⁻⁵).
5. Define

$${β}^{*} = {P}_{n} {γ}^{*} , \qquad {S}_{n + 1} = \{ i \geq G : \vert {β}_{i} \vert > {max}_{j \geq G} ( \vert {β}_{j} \vert * {ɛ}_{1} ) \} ⋃ \{ 1 , 2 , … , G - 1 \}$$

where ε₁ is a small constant, say 1e-5. Set n=n+1.
6. Check convergence. If ∥γ*−γ⁽ⁿ⁾∥<ε₂ where ε₂ is suitably small then stop, else go to step 2 above.
   Recovering the Probabilities

Once we have obtained estimates of the parameters p are obtained, calculate

$${a}_{ik} = \frac{{\hat{π}}_{ik}}{{\hat{γ}}_{ik}}$$

for i=1, . . . ,N and k=2, . . . ,G.

Preferably, to obtain the probabilities we use the recursion

$$\begin{matrix}{π}_{iG} = {a}_{iG} \\ {π}_{ik - 1} = ( \frac{{a}_{ik - 1}}{{a}_{ik}} ) ( 1 - {a}_{ik} ) {π}_{ik}\end{matrix}$$

and the fact that the probabilities sum to one, for i=1, . . . ,N.

In one embodiment, the covariate matrix X with rows xᵢ^{T} can be replaced by a matrix K with ij^{th} element kᵢⱼ and kᵢⱼ=κ(xᵢ−xⱼ) for some kernel function κ. This matrix can also be augmented with a vector of ones. Some example kernels are given in Table 1 below, see Evgeniou et al(1999).

TABLE 1
Examples of kernel functions

| Kernel function | Formula for κ(x − y) |
|---|---|
| Gaussian radial basis function | exp(−\|\|x − y\|\|²/a), a > 0 |
| Inverse multiquadric | (\|\|x − y\|\|² + c²)^{-1/2} |
| Multiquadric | (\|\|x − y\|\|² + c²)^{1/2} |
| Thin plate splines | \|\|x − y\|\|²ⁿ⁺¹ |
| | \|\|x − y\|\|²ⁿln(\|\|x − y\|\|) |
| Multi layer perceptron | tanh(x · y − θ), for suitable θ |
| Ploynomial of degree d | (1 + x · y)^{d} |
| B splines | B₂ₙ₊₁(x − y) |
| Trigonometric polynomials | sin((d + 1/2) (x − y))/sin((x − y)/ |
| | 2) |

In Table 1 the last two kernels are preferably one dimensional i.e. for the case when X has only one column. Multivariate versions can be derived from products of these kernel functions. The definition of B₂ₙ₊₁ can be found in De Boor(1978). Use of a kernel function results in estimated probabilities which are smooth (as opposed to transforms of linear) functions of the covariates X. Such models may give a substantially better fit to the data.

A third embodiment relating to a generalised linear model will now be described.

C. Generalised Linear Models

The method of this embodiment utilises the training samples in order to identify a subset of components which can predict the characteristic of a sample. Subsequently, knowledge of the subset of components can be used for tests, for example clinical tests to predict unknown values of the characteristic of interest. For example, a subset of components of a DNA microarray may be used to predict a clinically relevant characteristic such as, for example, a blood glucose level, a white blood cell count, the size of a tumour, tumour growth rate or survival time.

In this way, the present invention identifies preferably a minimum number of components which can be used to predict a characteristic for a particular sample. The minimum number of components is “predictive” for that characteristic. Essentially, from all the data which is generated from the system, the method of the present invention enables identification of a minimum number of components which can be used to predict a particular characteristic. Once those components have been identified by this method, the components can be used in future to predict the characteristic for new samples. The method of the present invention preferably utilises a statistical method to eliminate components that are not required to correctly predict the characteristic for the sample.

The inventors have found that component weights of a linear combination of components of data generated from the training samples can be estimated in such a way as to eliminate the components that are not required to predict a characteristic for a training sample. The result is that a subset of components are identified which can correctly predict the characteristic for samples in the training set. The method of the present invention thus permits identification from a large amount of data a relatively small number of components which are capable of correctly predicting a characteristic for a training sample, for example, a quantity of interest.

The characteristic may be any characteristic of interest. In one embodiment, the characteristic is a quantity or measure. In another embodiment, they may be the index number of a group, where the samples are grouped into two sample groups (or “classes”) based on a pre-determined classification. The classification may be any desired classification by which the training samples are to be grouped. For example, the classification may be whether the training samples are from a leukemia cell or a healthy cell, or that the training samples are obtained from the blood of patients having or not having a certain condition, or that the training samples are from a cell from one of several types of cancer as compared to a normal cell. In another embodiment the characteristic may be a censored survival time, indicating that particular patients have survived for at least a given number of days. In other embodiments the quantity may be any continuously variable characteristic of the sample which is capable of measurement, for example blood pressure.

In one embodiment, the data may be a quantity yᵢ, where iε{1, . . . ,N}. We write the N×1 vector with elements yᵢ as y. We define a p×1 parameter vector β of component weights (many of which are expected to be zero), and a q×1 vector of parameters φ (not expected to be zero). Note that q could be zero (i.e. the set of parameters not expected to be zero may be empty).

In one embodiment, the input data is organised into an N×p data matrix X=(xᵢⱼ) with N test training samples and p components. Typically, p will be much greater than N.

In another embodiment, data matrix X may be replaced by an N×N kernel matrix K to obtain smooth functions of X as predictors instead of linear predictors. An example of the kernel matrix K is kᵢⱼ=exp(−0.5*(xᵢ−xⱼ)^{t}(xᵢ−xⱼ)/σ²) where the subscript on x refers to a row number in the matrix X. Ideally, subsets of the columns of K are selected which give sparse representations of these smooth functions.

Typically, as discussed above, the component weights are estimated in a manner which takes into account the a priori assumption that most of the component weights are zero.

In one embodiment, the prior specified for the component weights is of the form:

$$p ( β ) = {\int }_{{v}^{2}}^{} p ( β \vert {v}^{2} ) p ( {v}^{2} ) ⅆ {v}^{2} \qquad ( 1 C )$$

where

$$p ( β \vert {ν}^{2} ) is N ( 0 , diag \{ {ν}^{2} \} ) and p ( {ν}^{2} ) α {\prod }_{i = 1}^{n} 1 / {ν}_{i}^{2}$$

is a Jeffreys prior, Kotz and Johnson(1983). Preferably, an uninformative prior for φ is specified.

The likelihood function defines a model which fits the data based on the distribution of the data. Preferably, the likelihood function is derived from a generalised linear model. For example, the likelihood function L({tilde under (y)}|βφ) may be the form appropriate for a generalised linear model (GLM), such as for example, that described by Nelder and Wedderburn (1972). Preferably, the likelihood function is of the form:

$$1 = log p ( y \vert β , φ ) = {\sum }_{i = 1}^{N} \{ \frac{{y}_{i} {θ}_{i} - b ( {θ}_{i} )}{{a}_{i} ( φ )} + c ( {y}_{i} , φ ) \} \qquad ( 2 C )$$

where y=(y₁, . . . , yₙ)^{T} and aᵢ(φ)=φ/wᵢ with the wᵢ being a fixed set of known weights and φ a single scale parameter.

Preferably, the likelihood function is specified as follows:

We have
E{yᵢ}=b′(θᵢ)
Var{y}=b″(θᵢ)aᵢ(φ)=τᵢ²aᵢ(φ) (3C)

Each observation has a set of covariates xᵢ and a linear predictor ηᵢ=xᵢ^{T}β. The relationship between the mean of the i^{th} observation and its linear predictor is given by the link function ηᵢ=g(μᵢ)=g(b′(θᵢ)). The inverse of the link is denoted by h, i.e
μᵢ=b′(θᵢ)=h(ηᵢ).

In addition to the scale parameter, a generalised linear model may be specified by four components:
the likelihood or (scaled) deviance function,
the link function
the derivative of the link function
the variance function.

Some common examples of generalised linear models are given in table 2 below.

TABLE 2

| | | Derivative | | |
|---|---|---|---|---|
| | Link function | of link | Variance | Scale |
| Distribution | g (μ) | function | function | parameter |
| Gaussian | μ | 1 | 1 | yes |
| Binomial with n trials | $log ( \frac{μ}{1 - μ} )$ | $\frac{1}{μ ( 1 - μ )}$ | $\frac{μ}{n} ( 1 - μ )$ | no |
| Poisson | log (μ) | 1/μ | μ | no |
| Gamma | 1/μ | −1/μ² | μ² | yes |
| Inverse | 1/μ² | −2/μ³ | μ³ | yes |
| Gaussian | | | | |

In another embodiment, the likelihood function is derived from a multiclass logistical model.

In another embodiment, a quasi likelihood model is specified wherein only the link function and variance function are defined. In some instances, such specification results in the models in the table above. In other instances, no distribution is specified.

In one embodiment, the posterior distribution of β φ and v given y is estimated using:
p(βφv|y)αL(y|βφ)p(β|v)p(v) (4C)
wherein L({tilde under (y)}|βφ) is the likelihood function.

In one embodiment, v may be treated as a vector of missing data and an iterative procedure used to maximise equation (2C) to produce locally maximum a posteriori estimates of β. The prior of equation (5C) is such that the maximum a posteriori estimates will tend to be sparse i.e. if a large number of parameters are redundant, many components of β will be zero.

As stated above, the component weights which maximise the posterior distribution may be determined using an iterative procedure. Preferable, the iterative procedure for maximising the posterior distribution of the components and component weights is an EM algorithm, such as, for example, that described in Dempster et al, 1977.

In one embodiment, the EM algorithm comprises the steps:
(c) Initialising the algorithm by setting n=0, S0={1,2, . . . , p}, initialise φ⁽⁰⁾, β* and applying a value for ε, such as for example ε=10⁻⁵;
(d) Defining

$${β}_{i}^{( n )} = \{ \begin{matrix}{β}_{i}^{*} , & i ɛ {S}_{n} \\ 0 , & otherwise\end{matrix} \qquad ( 5 C )$$

and let Pn be a matrix of zeroes and ones such that the nonzero elements γ(n) of β(n) satisfy
γ⁽ⁿ⁾=Pₙ^{T}β⁽ⁿ⁾, β⁽ⁿ⁾=Pₙγ⁽ⁿ⁾
γ=Pₙ^{T}β, β=Pₙγ
(e) performing an estimation (E) step by calculating the conditional expected value of the posterior distribution of component weights using the function:

$$\begin{matrix}Q ( β \vert {β}^{( n )} , {φ}^{( n )} ) = E \{ log p ( β , φ , ν \vert y ) \vert y , {β}^{( n )} , {φ}^{( n )} \} \\ = 1 ( y \vert β , {φ}^{( n )} ) - 0.5 ( {‖ β / {β}^{( n )} ‖}^{2} )\end{matrix} \qquad ( 6 C )$$

where l is the log likelihood function of y. Using β=Pₙγ and β⁽ⁿ⁾=Pₙγ⁽ⁿ⁾ can be written as
Q(γ|γ⁽ⁿ⁾, φ⁽ⁿ⁾)=1(y|Pₙγ, φ⁽ⁿ⁾)−0.5 (∥(γ/γ⁽ⁿ⁾∥²) (7C)
(f) performing a maximisation (M) step by applying an iterative procedure to maximise Q as a function of γ whereby γ₀=γ⁽ⁿ⁾ and for r=0, 1, 2, . . .
(g) γᵣ₊₁=γᵣ+aᵣ δᵣ and where αᵣ is chosen by a line search algorithm to ensure Q(γᵣ₊₁|γ⁽ⁿ⁾, φ⁽ⁿ⁾)>Q(γᵣ|γ⁽ⁿ⁾, φ⁽ⁿ⁾) and

$$\begin{matrix}{δ}_{r} = {diag ( {γ}^{( n )} ) [ - diag ( {γ}^{( n )} ) \frac{{\partial }^{2} 1}{{\partial }^{2} {γ}_{r}} diag ( {γ}^{( n )} ) + I ]}^{- 1} ( \frac{\partial 1}{\partial {γ}^{( n )}} - \frac{{γ}_{r}}{{γ}^{( n )}} ) \\ where : & ( 8 C ) \\ \frac{\partial 1}{\partial {γ}_{r}} = {P}_{n}^{T} \frac{\partial 1}{\partial {β}_{r}} , \frac{{\partial }^{2} 1}{{\partial }^{2} {γ}_{r}} = {P}_{n}^{T} \frac{{\partial }^{2} 1}{{\partial }^{2} {β}_{r}} {P}_{n} \\ for {β}_{r} = {P}_{n} {γ}_{r} . & ( 9 C )\end{matrix}$$

Let γ* be the value of γr when some convergence criterion is satisfied, for example, ∥γr−γr+1∥<ε (for example 10 ⁻⁵);
(h) Defining

$${β}^{*} = {P}_{n} {γ}^{*} , {S}_{n + 1} = \{ i \text{:} \vert {β}_{i} \vert > {max}_{j} ( {\vert {β}_{j} \vert}^{*} {ɛ}_{1} ) \}$$

where εᵢ is a small constant, for example 1e-5.
(i) Set n=n+1 and choose φ⁽ⁿ⁺¹⁾=φ⁽ⁿ⁾+κₙ(φ*−φ⁽ⁿ⁾) where φ* satisfies

$$\frac{\partial }{\partial φ} 1 ( y \vert {P}_{n} {γ}^{*} , φ ) = 0$$

and κₙ is a damping factor such that 0<κₙ≦1; and
(j) Check convergence. If ∥γ*−γ⁽ⁿ⁾∥<ε₂ where ε₂ is suitably small then stop, else go to step (b) above.

In another embodiment, step (d) in the maximisation step may be estimated by replacing

$$\frac{{\partial }^{2} 1}{{\partial }^{2} {γ}_{r}}$$

with its expectation

$$E \{ \frac{{\partial }^{2} 1}{{\partial }^{2} {γ}_{r}} \} .$$

This is preferred when the model of the data is a generalised linear model.

For generalised linear models the expected value

$$E \{ \frac{{\partial }^{2} 1}{{\partial }^{2} {γ}_{r}} \}$$

may be calculated as follows:

$$\frac{\partial l}{\partial β} = {X}^{T} \{ diag ( \frac{1}{{τ}_{i}^{2}} \frac{\partial {μ}_{i}}{\partial {η}_{i}} ) ( \frac{{y}_{i} - {μ}_{i}}{{a}_{i} ( φ )} ) \} \qquad ( 10 C )$$

where X is the N by p matrix with i^{th} row xᵢ^{T} and

$$E \{ \frac{{\partial }^{2} 1}{{\partial }^{2} {β}^{2}} \} = - E \{ ( \frac{\partial 1}{\partial β} ) {( \frac{\partial 1}{\partial β} )}^{τ} \} = - {X}^{T} {diag ( {a}_{i} ( φ ) {{τ}_{i}^{2} ( \frac{\partial {η}_{i}}{\partial {μ}_{i}} )}^{2} )}^{- 1} X \qquad ( 11 C )$$

This can be written as

$$\begin{matrix}\frac{\partial 1}{\partial β} = {X}^{t} {V}^{- 1} ( \frac{\partial η}{\partial μ} ) ( y - μ ) & ( 12 C ) \\ E \{ \frac{{\partial }^{2} 1}{\partial {β}^{2}} \} = - {X}^{t} {V}^{- 1} X \\ where V = diag ( {a}_{i} ( φ ) {{τ}_{1}^{2} ( \frac{\partial {η}_{i}}{\partial {μ}_{i}} )}^{2} ) . & ( 13 C )\end{matrix}$$

Preferably, the EM algorithm comprises the steps:
(a) Initialising the algorithm by setting n=0, S0={1,2, . . . , p}, φ(0), applying a value for ε, such as for example ε=10^{-5,} and
If p≦N compute initial values β* by
β*=(X^{t}X+λI)⁻¹X^{T}g(y+ζ) (14C)
and if p>N compute initial values β* by

$${β}^{*} = \frac{1}{λ} ( I - {{X}^{T} ( {XX}^{T} + λ I )}^{- 1} X ) {X}^{T} g ( y + ζ ) \qquad ( 15 C )$$

where the ridge parameter λ satisfies 0<λ≦1 and ζ is small and chosen so that the link function g is well defined at y+ζ.
(b) Defining

$${β}_{i}^{( n )} = \{ \begin{matrix}{β}_{i}^{*} , & i ɛ {S}_{n} \\ 0 , & otherwise\end{matrix}$$

and let Pn be a matrix of zeroes and ones such that the nonzero elements γ(n) of β(n) satisfy
γ⁽ⁿ⁾=Pₙ^{T}β⁽ⁿ⁾, β⁽ⁿ⁾=Pₙγ⁽ⁿ⁾
γ=Pₙ^{T}β, β=Pₙγ
(c) performing an estimation (E) step by calculating the conditional expected value of the posterior distribution of component weights using the function:

$$\begin{matrix}Q ( β \vert {β}^{( n )} , {φ}^{( n )} ) = E \{ log p ( β , φ , v \vert y ) \vert y , {β}^{( n )} , {φ}^{( n )} \} \\ = 1 ( y \vert β , {φ}^{( n )} ) - 0.5 ( {‖ β / {β}^{( n )} ‖}^{2} )\end{matrix} \qquad ( 16 C )$$

where l is the log likelihood function of y. Using β=Pₙγ and β⁽ⁿ⁾=Pₙγ⁽ⁿ⁾ (16C) can be written as
Q(γ|γ⁽ⁿ⁾, φ⁽ⁿ⁾)=1(y|Pₙγ, φ⁽ⁿ⁾)−0.5 (∥(γ/γ⁽ⁿ⁾∥²) (17C)
(d) performing a maximisation (M) step by applying an iterative procedure, for example a Newton Raphson iteration, to maximise Q as a function of γ whereby γ₀=γ⁽ⁿ⁾ and for r=0, 1, 2, . . . γᵣ₊₁=γᵣ+αᵣ δᵣ where αᵣ is chosen by a line search algorithm to ensure Q(γᵣ₊₁|γ⁽ⁿ⁾, φ⁽ⁿ⁾)>Q(γᵣ|γ⁽ⁿ⁾, φ⁽ⁿ⁾), and

$$For p \leq N use \\ {δ}_{r} = {diag ( {γ}^{( n )} ) [ {Y}_{n}^{T} {V}_{r}^{- 1} {Y}_{n} + I ]}^{- 1} ( {Y}_{n}^{T} {V}_{r}^{- 1} {z}_{r} - \frac{{γ}_{r}}{{γ}^{( n )}} ) \\ where \\ {Y}_{n} = diag ( {γ}^{( n )} ) {P}_{n}^{T} X \\ V = diag ( {a}_{i} ( φ ) {{τ}_{i}^{2} ( \frac{\partial {η}_{i}}{\partial {μ}_{i}} )}^{2} ) \\ z = \frac{\partial η}{\partial μ} ( y - μ ) \qquad ( 18 C )$$

and the subscript r denotes that these quantities are evaluated at μ=h(XPₙγᵣ).
For p>N use

$${δ}_{r} = diag ( {γ}^{( n )} ) [ I - {{Y}_{n}^{T} ( {Y}_{n} {Y}_{n}^{T} + {V}_{r} )}^{- 1} {Y}_{n} ] ( {Y}_{n}^{T} {V}_{r}^{- 1} {z}_{r} - \frac{{γ}_{r}}{{γ}^{( n )}} ) \qquad ( 19 C )$$

with Vᵣ and zᵣ defined as before.

Let γ* be the value of γᵣ when some convergence criterion is satisfied e.g
∥γᵣ−γᵣ₊₁∥<ε (for example 10⁻⁵).
1) Define β*=Pₙγ*,

$${S}_{n + 1} = \{ i \text{:} \vert {β}_{i} \vert > {max}_{j} ( {\vert {β}_{j} \vert}^{*} {ɛ}_{1} ) \}$$

where ε₁ is a small constant, say 1e-5. Set n=n+1 and choose φⁿ⁺¹=φⁿ+κₙ(φ*−φⁿ) where φ* satisfies

$$\frac{\partial }{\partial φ} 1 ( y \vert {P}_{n} {γ}^{*} , φ ) = 0$$

and κₙ is a damping factor such that 0<κₙ≦1. Note that in some cases the scale parameter is known or this equation can be solved explicitly to get an updating equation for φ.

The above embodiments may be extended to incorporate quasi likelihood methods Wedderburn (1974) and McCullagh and Nelder (1983)). In such an embodiment, the same iterative procedure as detailed above will be appropriate, but with E the likelihood replaced by a quasi likelihood as shown above and, for example, Table 8.1 in McCullagh and Nelder (1983). In one embodiment there is a modified updating method for the scale parameter φ. To define these models requires specification of the variance function τ², the link function g and the derivative of the link function

$$\frac{\partial η}{\partial μ} .$$

Once these are defined the above algorithm can be applied. In one embodiment for quasi likelihood models, step 5 of the above algorithm is modified so that the scale parameter is updated by calculating

$${φ}^{( n + 1 )} = \frac{1}{N} {\sum }_{i = 1}^{N} \frac{{( {y}_{i} - {μ}_{i} )}^{2}}{{τ}_{i}^{2}}$$

where μ and τ are evaluated at β*=Pₙγ*. Preferably, this updating is performed when the number of parameters s in the model is less than N. A divisor of N-s can be used when s is much less than N.

In another embodiment, for both generalised linear models and Quasi likelihood models the covariate matrix X with rows xᵢ^{T} can be replaced by a matrix K with ijth element kᵢⱼ and kᵢⱼ=κ(xᵢ−xⱼ) for some kernel function κ. This matrix can also be augmented with a vector of ones. Some example kernels are given in Table 3 below, see Evgeniou et al(1999).

TABLE 3
Examples of kernel functions

| Kernel function | Formula for κ(x − y) |
|---|---|
| Gaussian radial basis | exp(−\|\|x − y\|\|²/a), |
| function | a > 0 |
| Inverse multiquadric | (\|\|x − y\|\|² + c²)^{-1/2} |
| multiquadric | (\|\|x − y\|\|² + c²)^{1/2} |
| Thin plate splines | \|\|x − y\|\|²ⁿ⁺¹ |
| | \|\|x − y\|\|²ⁿln(\|\|x − y\|\|) |
| Multi layer perceptron | tanh(x · y − θ), for suitable θ |
| Ploynomial of degree d | (1 + x · y)^{d} |
| B splines | B₂ₙ₊₁^{(x - y)} |
| Trigonometric polynomials | sin((d + 1/2) (x − y))/sin((x − y)/ |
| | 2) |

In Table 3 the last two kernels are one dimensional i.e. for the case when X has only one column. Multivariate versions can be derived from products of these kernel functions. The definition of B₂ₙ₊₁ can be found in De Boor(1978 ). Use of a kernel function in either a generalised linear model or a quasi likelihood model results in mean values which are smooth (as opposed to transforms of linear) functions of the covariates X. Such models may give a substantially better fit to the data.

A fourth embodiment relating to a proportional hazards model will now be described.

D. Proportional Hazard Models

The method of this embodiment may utilise training samples in order to identify a subset of components which are capable of affecting the probability that a defined event (eg death, recovery) will occur within a certain time period. Training samples are obtained from a system and the time measured from when the training sample is obtained to when the event has occurred. Using a statistical method to associate the time to the event with the data obtained from a plurality of training samples, a subset of components may be identified that are capable of predicting the distribution of the time to the event. Subsequently, knowledge of the subset of components can be used for tests, for example clinical tests to predict for example, statistical features of the time to death or time to relapse of a disease. For example, the data from a subset of components of a system may be obtained from a DNA microarray. This data may be used to predict a clinically relevant event such as, for example, expected or median patient survival times, or to predict onset of certain symptoms, or relapse of a disease.

In this way, the present invention identifies preferably a minimum number of components which can be used to predict the distribution of the time to an event of a system. The minimum number of components is “predictive” for that time to an event. Essentially, from all the data which is generated from the system, the method of the present invention enables identification of a minimum number of components which can be used to predict time to an event. Once those components have been identified by this method, the components can be used in future to predict statistical features of the time to an event of a system from new samples. The method of the present invention preferably utilises a statistical method to eliminate components that are not required to correctly predict the time to an event of a system.

As used herein, “time to an event” refers to a measure of the time from obtaining the sample to which the method of the invention is applied to the time of an event. An event may be any observable event. When the system is a biological system, the event may be, for example, time till failure of a system, time till death, onset of a particular symptom or symptoms, onset or relapse of a condition or disease, change in phenotype or genotype, change in biochemistry, change in morphology of an organism or tissue, change in behaviour.

The samples are associated with a particular time to an event from previous times to an event. The times to an event may be times determined from data obtained from, for example, patients in which the time from sampling to death is known, or in other words, “genuine” survival times, and patients in which the only information is that the patients were alive when samples were last obtained, or in other words, “censored” survival times indicating that the particular patient has survived for at least a given number of days.

In one embodiment, the input data is organised into an N×p data matrix X=(xᵢⱼ) with N test training samples and p components. Typically, p will be much greater than N.

For example, consider an N×p data matrix X=(xᵢⱼ) from, for example, a microarray experiment, with N individuals (or samples) and the same p genes for each individual. Preferably, there is associated with each individual i(i=1,2, . . . ,N) a variable yᵢ(yᵢ≧0) denoting the time to an event, for example, survival time. For each individual there may also be defined a variable that indicates whether that individual's survival time is a genuine survival time or a censored survival time. Denote the censor indicators as cᵢ where

$${c}_{i} = \{ \begin{matrix}1 , if {y}_{i} is uncensored \\ 0 , if {y}_{i} is censored\end{matrix}$$

The N×1 vector with survival times yᵢ may be written as {tilde under (y)} and the N×1 vector with censor indicators cᵢ as {tilde under (c)}.

Typically, as discussed above, the component weights are estimated in a manner which takes into account the a priori assumption that most of the component weights are zero.

Preferably, the prior specified for the component weights is of the form

$$P ( {β}_{1} , {β}_{2} , … , {β}_{n} ) = {\int }_{τ} {\prod }_{i = 1}^{N} P ( {β}_{i} \vert {τ}_{i} ) P ( {τ}_{i} ) ⅆ τ \qquad ( 1 D )$$

where β₁,β₂, . . . ,βₙ are component weights, P(βᵢ|τᵢ) is N(0,τᵢ²) and P(τᵢ)α1/τᵢ² is a Jeffreys prior (Kotz and Johnson, 1983).

The likelihood function defines a model which fits the data based on the distribution of the data. Preferably, the likelihood function is of the form:

$$Log ( Partial ) Likelihood = {\sum }_{i = 1}^{N} {g}_{i} ( {β}_{\sim} , {φ}_{\sim} ; X , {y}_{\sim} , {c}_{\sim} ) \qquad ( 2 D )$$

where {tilde under (β)}^{T}=(β₁,β₂, . . . ,βₚ) and {tilde under (φ)}^{T}=(φ₁,φ₂, . . . ,φ_{q}) are the model parameters. The model defined by the likelihood function may be any model for predicting the time to an event of a system.

In one embodiment, the model defined by the likelihood is Cox's proportional hazards model. Cox's proportional hazards model was introduced by Cox (1972) and may preferably be used as a regression model for survival data. In Cox's proportional hazards model, {tilde under (β)}^{T} is a vector of (explanatory) parameters associated with the components. Preferably, the method of the present invention provides for the parsimonious selection (and estimation) from the parameters {tilde under (β)}^{T}=(β₁,β₂, . . . ,βₚ) for Cox's proportional hazards model given the data X, {tilde under (y)} and {tilde under (c)}.

Application of Cox's proportional hazards model can be problematic in the circumstance where different data is obtained from a system for the same survival times, or in other words, for cases where tied survival times occur. Tied survival times may be subjected to a pre-processing step that leads to unique survival times. The pre-processing proposed simplifies the ensuing algorithm as it avoids concerns about tied survival times in the subsequent application of Cox's proportional hazards model.

The pre-processing of the survival times applies by adding an extremely small amount of insignificant random noise. Preferably, the procedure is to take sets of tied times and add to each tied time within a set of tied times a random amount that is drawn from a normal distribution that has zero mean and variance proportional to the smallest non-zero distance between sorted survival times. Such pre-processing achieves an elimination of tied times without imposing a draconian perturbation of the survival times.

The pre-processing generates distinct survival times. Preferably, these times may be ordered in increasing magnitude denoted as {tilde under (t)}=(t₍₁₎,t₍₂₎,. . . t_{(N)}), t₍ᵢ₊₁₎>t₍ᵢ₎.

Denote by Z the N×p matrix that is the re-arrangement of the rows of X where the ordering of the rows of Z corresponds to the ordering induced by the ordering of {tilde under (t)}; also denote by Zⱼ the j^{th} row of the matrix Z. Let d be the result of ordering c with the same permutation required to order {tilde under (t)}.

After pre-processing for tied survival times is taken into account and reference is made to standard texts on survival data analysis (eg Cox and Oakes, 1984), the likelihood function for the proportional hazards model may preferably be written as

$$L ( {t}_{\sim} \vert {β}_{\sim} ) = {\prod }_{j = 1}^{N} {( \frac{exp ( {Z}_{j} {β}_{\sim} )}{{\sum }_{i ∈ {ℛ}_{j}} exp ( {Z}_{i} {β}_{\sim} )} )}^{{d}_{j}} \qquad ( 3 D )$$

where {tilde under (β)}^{T}=(β₁,β₂, . . . ,βₙ), Zⱼ=the j^{th} row of Z, and [symbol] ⱼ={i:i=j,j+1, . . . ,N}=the risk set at the j^{th} ordered event time t₍ⱼ₎.

The logarithm of the likelihood (ie l=log(L)) may preferably be written as

$$\begin{matrix}l ( {t}_{\sim} \vert {β}_{\sim} ) = {\sum }_{i = 1}^{N} {d}_{i} ( {Z}_{i} {β}_{\sim} - log ( {\sum }_{j ∈ {ℛ}_{j}} exp ( {Z}_{j} {β}_{\sim} ) ) ) \\ = {\sum }_{i = 1}^{N} {d}_{i} ( {Z}_{i} {β}_{\sim} - log ( {\sum }_{j = 1}^{N} {ζ}_{i , j} exp ( {Z}_{j} {β}_{\sim} ) ) ) ,\end{matrix} \\ where \\ {ζ}_{i , j} = \{ \begin{matrix}0 , if j < i \\ 1 , if j \geq i\end{matrix} \qquad ( 4 D )$$

Notice that the model is non-parametric in that the parametric form of the survival distribution is not specified—preferably only the ordinal property of the survival times are used (in the determination of the risk sets). As this is a non-parametric case {tilde under (φ)} is not required (ie q=0).

In another embodiment of the method of the invention, the model defined by the likelihood function is a parametric survival model. Preferably, in a parametric survival model, {tilde under (β)}^{T} is a vector of (explanatory) parameters associated with the components, and {tilde under (φ)}^{T} is a vector of parameters associated with the functional form of the survival density function.

Preferably, the method of the invention provides for the parsimonious selection (and estimation) from the parameters {tilde under (β)}^{T} and the estimation of {tilde under (φ)}^{T}=(φ₁,φ₂, . . . ,φ_{q}) for parametric survival models given the data X, {tilde under (y)} and {tilde under (c)}.

In applying a parametric survival model, the survival times do not require pre-processing and are denoted as {tilde under (y)}. The parametric survival model is applied as follows: Denote by f(y;{tilde under (θ)},{tilde under (β)},X) the parametric density function of the survival time, denote its survival function by

$$𝕊 ( y ; {φ}_{\sim} , {β}_{\sim} , X ) = {\int }_{y}^{∞} f ( u ; {φ}_{\sim} , {β}_{\sim} , X ) ⅆ u$$

du where {tilde under (φ)} are the parameters relevant to the parametric form of the density function and {tilde under (β)},X are as defined above. The hazard function is defined as h(yᵢ;{tilde under (φ)},{tilde under (β)},X)=ƒ(yᵢ;{tilde under (φ)},{tilde under (β)},X)/ [symbol] (yᵢ;{tilde under (φ)},{tilde under (β)},X).

Preferably, the generic formulation of the log-likelihood function, taking censored data into account, is

$$l = {\sum }_{i = 1}^{N} \{ {c}_{i} log ( f ( {y}_{i} ; {φ}_{\sim} , {β}_{\sim} , X ) ) + ( 1 - {c}_{i} ) log ( 𝕊 ( {y}_{i} ; {φ}_{\sim} , {β}_{\sim} , X ) ) \}$$

Reference to standard texts on analysis of survival time data via parametric regression survival models reveals a collection of survival time distributions that may be used. Survival distributions that may be used include, for example, the Weibull, Exponential or Extreme Value distributions.

If the hazard function may be written as h(yᵢ;{tilde under (φ)},{tilde under (β)},X)=λ(yᵢ;{tilde under (φ)})exp(Xᵢ{tilde under (β)}) then [symbol] (yᵢ;{tilde under (φ)},{tilde under (β)},X)=exp(−Λ(yᵢ;{tilde under (φ)})e^{X}^{ᵢ}^{{tilde under (β)}}) and f(yᵢ;{tilde under (φ)},{tilde under (β)},X)=λ(yᵢ;{tilde under (φ)})exp(Xᵢ{tilde under (β)}−Λ(yᵢ)e^{X}^{ᵢ}^{{tilde under (β)}}) where

$$Λ ( {y}_{i} ; {φ}_{\sim} ) = {\int }_{- ∞}^{{y}_{i}} λ ( u ; {φ}_{\sim} ) ⅆ u$$

is the integrated hazard function and

$$λ ( {y}_{i} ; {φ}_{\sim} ) = \frac{ⅆ Λ ( {y}_{i} ; {φ}_{\sim} )}{ⅆ {y}_{i}} ;$$

Xᵢ is the i^{th} row of X.

The Weibull, Exponential and Extreme Value distributions have density and hazard functions that may be written in the form of those presented in the paragraph immediately above.

The application detailed relies in part on an algorithm of Aitken and Clayton (1980) however it permits the user to specify any parametric underlying hazard function.

Following from Aitkin and Clayton (1980) a preferred likelihood function which models a parametric survival model is:

$$l = {\sum }_{i = 1}^{N} \{ {c}_{i} log ( {μ}_{i} ) - {μ}_{i} + {c}_{i} ( log ( \frac{λ ( {y}_{i} )}{Λ ( {y}_{i} ; {φ}_{\sim} )} ) ) \} \qquad ( 5 D )$$

where μᵢ=Λ(yᵢ;{tilde under (φ)})exp(Xᵢ{tilde under (β)}). Aitkin and Clayton (1980) note that a consequence of equation (5D) is that the cᵢ's may be treated as Poisson variates with means μᵢ and that the last term in equation (11D) does not depend on {tilde under (β)} (although it depends on {tilde under (φ)}).

Preferably, the posterior distribution of {tilde under (β)}, {tilde under (φ)} and {tilde under (τ)} given {tilde under (y)} is
P({tilde under (β)},{tilde under (φ)},{tilde under (τ)}|{tilde under (y)})αL({tilde under (y)}|{tilde under (β)},{tilde under (φ)})P({tilde under (β)}|{tilde under (τ)})P({tilde under (τ)}) (6D)
wherein L({tilde under (y)}|{tilde under (β)},{tilde under (φ)}) is the likelihood function.

In one embodiment, r may be treated as a vector of missing data and an iterative procedure used to maximise equation (6D) to produce a posteriori estimates of {tilde under (β)}. The prior of equation (1D) is such that the maximum a posteriori estimates will tend to be sparse i.e. if a large number of parameters are redundant, many components of {tilde under (β)} will be zero.

Because a prior expectation exists that many components of {tilde under (β)}^{T} are zero, the estimation may be performed in such a way that most of the estimated βᵢ's are zero and the remaining non-zero estimates provide an adequate explanation of the survival times.

In the context of microarray data this exercise translates to identifying a parsimonious set of genes that provide an adequate explanation for the event times.

As stated above, the component weights which maximise the posterior distribution may be determined using an iterative procedure. Preferable, the iterative procedure for maximising the posterior distribution of the components and component weights is an EM algorithm, such as, for example, that described in Dempster et al, 1977.

In one embodiment, the EM algorithm comprises the steps:
1. Initialising the algorithm by setting n=0, S₀=[1,2, . . . , p}, initialise {tilde under (β)}⁽⁰⁾={tilde under (β)}*, {tilde under (φ)}⁽⁰⁾,
2. Defining

$${β}_{i}^{( n )} = \{ \begin{matrix}{β}_{i}^{*} , & i ɛ {S}_{n} \\ 0 , & otherwise\end{matrix}$$

and let Pₙ be a matrix of zeroes and ones such that the nonzero elements {tilde under (γ)}⁽ⁿ⁾ of {tilde under (β)}⁽ⁿ⁾ satisfy
{tilde under (γ)}⁽ⁿ⁾=Pₙ^{T}{tilde under (β)}⁽ⁿ⁾, {tilde under (β)}⁽ⁿ⁾=Pₙ{tilde under (γ)}⁽ⁿ⁾
{tilde under (γ)}=Pₙ^{T}{tilde under (β)}, {tilde under (β)}=Pₙ{tilde under (γ)} (7D)
3. Performing an estimation step by calculating the expected value of the posterior distribution of component weights. This may be performed using the function:

$$\begin{matrix}Q ( {β}_{\sim} \vert {{β}_{\sim}}^{( n )} , {φ}^{( n )} ) = E \{ log ( P ( {β}_{\sim} , {φ}_{\sim} , τ \vert {y}_{\sim} ) ) \vert {y}_{\sim} , {{β}_{\sim}}^{( n )} , {φ}^{( n )} \} \\ = l ( {y}_{\sim} \vert {β}_{\sim} , {φ}^{( n )} ) - \frac{1}{2} {\sum }_{i = 1}^{N} {( \frac{{β}_{i}}{{β}_{i}^{( n )}} )}^{2}\end{matrix} \qquad ( 8 D )$$

where l is the log likelihood function of {tilde under (γ)}. Using β=Pₙγ and β⁽ⁿ⁾=Pₙγ⁽ⁿ⁾ we have

$$Q ( {γ}_{\sim} \vert {{γ}_{\sim}}^{( n )} , {{φ}_{\sim}}^{( n )} ) = l ( {t}_{\sim} \vert {P}_{n} {γ}_{\sim} , {{φ}_{\sim}}^{( n )} ) - \frac{1}{2} {\sum }_{i = 1}^{N} {( \frac{{γ}_{i}}{{γ}_{i}^{( n )}} )}^{2} \qquad ( 9 D )$$
4. Performing the maximisation step. This may be performed using Newton Raphson iterations as follows:
Set {tilde under (γ)}₀={tilde under (γ)}^{(r)} and for r=0,1,2, . . . {tilde under (γ)}ᵣ₊₁={tilde under (γ)}ᵣ+αᵣ δᵣ where αᵣ is chosen by a line search algorithm to ensure

$$Q ( {{γ}_{\sim}}_{r + 1} \vert {{γ}_{\sim}}^{( n )} , {{φ}_{\sim}}^{( n )} ) > Q ( {{γ}_{\sim}}_{r} \vert {{γ}_{\sim}}^{( n )} , {{φ}_{\sim}}^{( n )} ) and \\ {{δ}_{\sim}}_{r} = \\ {diag ( {{γ}_{\sim}}^{( n )} ) [ - diag ( {{γ}_{\sim}}^{( n )} ) \frac{{\partial }^{2} l}{{\partial }^{2} {{γ}_{\sim}}_{r}} diag ( {{γ}_{\sim}}^{( n )} ) + I ]}^{- 1} ( \frac{\partial l}{\partial {{γ}_{\sim}}_{r}} - \frac{{{γ}_{\sim}}_{r}}{{{γ}_{\sim}}^{( n )}} ) where \\ \frac{\partial l}{\partial {{γ}_{\sim}}_{r}} = {P}_{n}^{T} \frac{\partial l}{\partial {{β}_{\sim}}_{r}} , \frac{{\partial }^{2} l}{{\partial }^{2} {{γ}_{\sim}}_{r}} = {P}_{n}^{T} \frac{{\partial }^{2} l}{{\partial }^{2} {{β}_{\sim}}_{r}} {P}_{n} for {{β}_{\sim}}_{r} = {P}_{n} {{γ}_{\sim}}_{r} \qquad ( 10 D )$$

Let {tilde under (γ)}* be the value of {tilde under (γ)}ᵣ when some convergence criterion is satisfied e.g ∥{tilde under (γ)}ᵣ−{tilde under (γ)}ᵣ₊₁∥<ε (for example ε=10⁻⁵).
5. Define

$${{β}_{\sim}}^{*} = {P}_{n} {{γ}_{\sim}}^{*} , {S}_{n} \{ i : \vert {β}_{i} \vert > {ɛ}_{1} {max}_{j} \vert {β}_{j} \vert \}$$

where ε₁ is a small constant, say 10⁻⁵. Set n=n+1, choose {tilde under (φ)}⁽ⁿ⁺¹⁾={tilde under (φ)}⁽ⁿ⁾+κₙ({tilde under (φ)}*−{tilde under (φ)}⁽ⁿ⁾) where {tilde under (φ)}* satisfies

$$\frac{\partial l ( {y}_{\sim} \vert {P}_{n} {{γ}_{\sim}}^{*} , {φ}_{\sim} )}{\partial {φ}_{\sim}} = 0$$

and κₙ is a damping factor such that 0<κₙ<1.
6. Check convergence. If ∥{tilde under (γ)}*−{tilde under (γ)}⁽ⁿ⁾∥<ε₂ where ε₂ is suitably small then stop, else go to step 2 above.

In another embodiment, step (4) in the maximisation step may be estimated by replacing

$$\frac{{\partial }^{2} 1}{{\partial }^{2} {γ}_{r}}$$

with its expectation

$$E \{ \frac{{\partial }^{2} 1}{{\partial }^{2} {γ}_{r}} \} .$$

In one embodiment, the EM algorithm is applied to maximise the posterior distribution when the model is Cox's proportional hazard's model.

To aid in the exposition of the application of the EM algorithm when the model is Cox's proportional hazards model, it is preferred to define “dynamic weights” and matrices based on these weights. The weights are—

$$\begin{matrix}{w}_{i , j} = \frac{{ζ}_{i , l} exp ( {Z}_{l} {β}_{\sim} )}{{\sum }_{j = 1}^{N} {ζ}_{i , l} exp ( {Z}_{l} {β}_{\sim} )} , \\ {w}_{l}^{*} = {\sum }_{i = 1}^{N} {d}_{i} {w}_{i , l} , \\ {\tilde{w}}_{l} = {d}_{l} - {w}_{l}^{*} .\end{matrix}$$

Matrices based on these weights are—

$${W}_{i} = ( \begin{matrix}{w}_{i , 1} \\ {w}_{i , 2} \\ ⋮ \\ {w}_{i , N}\end{matrix} ) , \tilde{W} = ( \begin{matrix}{\tilde{w}}_{1} \\ {\tilde{w}}_{2} \\ ⋮ \\ ⋮ \\ {\tilde{w}}_{N}\end{matrix} ) , \\ Δ ( {W}^{*} ) = ( \begin{matrix}{w}_{1}^{*} & ⋯ & 0 \\ ⋮ & ⋰ & ⋮ \\ 0 & ⋯ & {w}_{N}^{*}\end{matrix} ) , {W}^{**} = {\sum }_{i = 1}^{N} {d}_{i} {W}_{i} {W}_{i}^{T}$$

In terms of the matrices of weights the first and second derivatives of l may be written as—

$$\begin{matrix} \frac{\partial l}{\partial {β}_{\sim}} = {Z}^{T} \tilde{W} \\ \frac{{\partial }^{2} l}{\partial {{β}_{\sim}}^{2}} = {Z}^{T} ( {W}^{**} - Δ ( {W}^{*} ) ) Z = {Z}^{T} KZ\end{matrix} \} \qquad ( 11 D )$$

where K=W**−Δ(W*). Note therefore from the transformation matrix Pₙ described as part of Step (2) of the EM algorithm (Equation 7D) (see also Equations (10D)) it follows that

$$\begin{matrix} \frac{\partial l}{\partial {{γ}_{\sim}}_{r}} = {P}_{n}^{T} \frac{\partial l}{\partial {{β}_{\sim}}_{r}} = {P}_{n}^{T} {Z}^{T} \tilde{W} \\ \frac{{\partial }^{2} l}{\partial {{γ}_{\sim}}_{r}^{2}} = {P}_{n}^{T} \frac{{\partial }^{2} l}{\partial {{β}_{\sim}}_{r}^{2}} {P}_{n} = {P}_{n}^{T} {Z}^{T} ( {W}^{**} - Δ ( {W}^{*} ) ) {ZP}_{n} = {P}_{n}^{T} {Z}^{T} {KZP}_{n}\end{matrix} \} \qquad ( 12 D )$$

Preferably, when the model is Cox's proportional hazards model the E step and M step of the EM algorithm are as follows:
1.1. Set n=0, S₀={1,2, . . . , p}. Let v be the vector with components

$${V}_{i} = \{ \begin{matrix} 1 - ɛ , & if {c}_{i} = 1 \\ ɛ , & if {c}_{i} = 0\end{matrix}$$

for some small ε, say 0.001. Define f to be log(v/t).

If p≦N compute initial values {tilde under (β)}* by
{tilde under (β)}*=(Z^{T}Z+λI)⁻¹Z^{T}f.

If p>N compute initial values {tilde under (β)}* by

$${{β}_{\sim}}^{*} = \frac{1}{λ} ( I - {{Z}^{T} ( {ZZ}^{T} + λ I )}^{- 1} Z ) {Z}^{T f}$$

where the ridge parameter λ satisfies 0<λ≦1.
2. Define

$${β}_{i}^{( n )} = \{ \begin{matrix}{β}_{i}^{*} , \\ 0 ,\end{matrix} \begin{matrix}i ∈ {S}_{n} \\ otherwise\end{matrix}$$

Let Pₙ be a matrix of zeroes and ones such that the nonzero elements {tilde under (γ)}⁽ⁿ⁾ of {tilde under (β)}⁽ⁿ⁾ satisfy
{tilde under (γ)}⁽ⁿ⁾=Pₙ^{T}{tilde under (β)}⁽ⁿ⁾, {tilde under (β)}⁽ⁿ⁾=Pₙ{tilde under (γ)}⁽ⁿ⁾
{tilde under (γ)}=Pₙ^{T}{tilde under (β)}, {tilde under (β)}=Pₙ{tilde under (γ)}
3. Perform the E step by calculating

$$\begin{matrix}Q ( {β \vert}_{\sim} {{β}_{\sim}}^{( n )} ) = E \{ log ( P ( {β}_{\sim} , {φ}_{\sim} , τ \vert {t}_{\sim} ) ) \vert {t}_{\sim} , {{β}_{\sim}}^{( n )} \} \\ = l ( {t}_{\sim} {\vert β}_{\sim} ) - \frac{1}{2} {\sum }_{i = 1}^{N} {( \frac{{β}_{i}}{{β}_{i}^{( n )}} )}^{2}\end{matrix}$$

where l is the log likelihood function of {tilde under (t)} given by Equation (8D). Using β=Pₙγ and β⁽ⁿ⁾=Pₙγ⁽ⁿ⁾ we have

$$Q ( {γ}_{\sim} \vert {{γ}_{\sim}}^{( n )} ) = l ( {t}_{\sim} \vert {P}_{n } {γ}_{\sim} ) - \frac{1}{2} {\sum }_{i = 1}^{N} {( \frac{{γ}_{i}}{{γ}_{i}^{( n )}} )}^{2}$$
4. Do the M step. This can be done with Newton Raphson iterations as follows. Set {tilde under (y)}₀={tilde under (γ)}^{(r)} and for r=0,1,2, . . . {tilde under (γ)}ᵣ₊₁={tilde under (γ)}ᵣ+αᵣ {tilde under (δ)}ᵣ where αᵣ is chosen by a line search algorithm to ensure Q({tilde under (γ)}ᵣ₊₁|{tilde under (γ)}⁽ⁿ⁾,{tilde under (φ)}⁽ⁿ⁾)>Q({tilde under (γ)}^{r}|{tilde under (γ)}⁽ⁿ⁾,{tilde under (φ)}⁽ⁿ⁾).

For p<N use
{tilde under (δ)}ᵣ=diag({tilde under (γ)}⁽ⁿ⁾)(Y^{T}KY+I)⁻¹(Y^{T}\tilde{W}−diag(1/{tilde under (γ)}⁽ⁿ⁾){tilde under (γ)}),
where Y=ZPₙdiag({tilde under (γ)}⁽ⁿ⁾).

For p>N use
{tilde under (δ)}ᵣ=diag({tilde under (γ)}⁽ⁿ⁾)(I−Y^{T}(YY^{T}+K⁻¹)⁻¹Y)(Y^{T}\tilde{W}−diag(1/{tilde under (γ)}⁽ⁿ⁾){tilde under (γ)})

Let γ* be the value of γᵣ when some convergence criterion is satisfied e.g ∥γᵣ−γᵣ₊₁∥<ε (for example 10⁻⁵).
5. Define {tilde under (β)}*=Pₙ{tilde under (γ)}*,

$${S}_{n} = \{ i : \vert {β}_{i} \vert > {ɛ}_{1} {max}_{j} \vert {β}_{j} \vert \}$$

where ε₁ is a small constant, say 10 ⁻⁵. This step eliminates variables with very small coefficients.
6. Check convergence. If ∥{tilde under (γ)}*−{tilde under (γ)}⁽ⁿ⁾∥<ε₂ where ε₂ is suitably small then stop, else set n=n+1, go to step 2 above and repeat procedure until convergence occurs.

In another embodiment the EM algorithm is applied to maximise the posterior distribution when the model is a parametric survival model.

In applying the EM algorithm to the parametic survival model, a consequence of equation (5D) is that the cᵢ's may be treated as Poisson variates with means μᵢ and that the last term in equation (5D) does not depend on β (although it depends on φ).

Note that log(μᵢ)=log(Λ(yᵢ;{tilde under (φ)}))+Xᵢ{tilde under (β)} and so it is possible to couch the problem in terms a log-linear model for the Poisson-like mean. Preferably, an iterative maximization of the log-likelihood function is performed where given initial estimates of {tilde under (φ)} the estimates of {tilde under (β)} are obtained. Then given these estimates of {tilde under (β)}, updated estimates of {tilde under (φ)} are obtained. The procedure is continued until convergence occurs.

Applying the posterior distribution described above, we note that (for fixed φ)

$$\frac{\partial log ( μ )}{\partial {β}_{\sim}} = \frac{1 \partial μ}{μ \partial {β}_{\sim}} ⇔ \frac{\partial μ}{\partial {β}_{\sim}} = μ \frac{\partial log ( μ )}{\partial {β}_{\sim}} and \frac{\partial log ( {μ}_{i} )}{\partial {β}_{\sim}} = {X}_{i} \qquad ( 13 D )$$

Consequently from Equations (11D) and (12D) it follows that

$$\frac{\partial l}{\partial {β}_{\sim}} = {X}^{T } ( {c}_{\sim} - {μ}_{\sim} ) and \frac{{\partial }^{2} l}{\partial {{β}_{\sim}}^{2}} = - {X}^{T} diag ( {μ}_{\sim} ) X .$$

The versions of Equation (12D) relevant to the parametric survival models are

$$\begin{matrix}\frac{\partial l}{\partial {{γ}_{r}}_{\sim}} = {P}_{n}^{T} \frac{\partial l}{\partial {{β}_{r}}_{\sim}} = {P}_{n}^{T} {X}^{T} ( {c}_{\sim} - {μ}_{\sim} ) \\ \frac{{\partial }^{2} l}{\partial {{γ}_{r}^{2}}_{\sim}} = {P}_{n}^{T} \frac{{\partial }^{2} l}{\partial {{β}_{r}^{2}}_{\sim}} {P}_{n} = - {P}_{n}^{T} {X}^{T} diag ( {μ}_{\sim} ) {XP}_{n}\end{matrix} \} \qquad ( 14 D )$$

To solve for {tilde under (φ)} after each M step of the EM algorithm (see step 5 below) preferably put {tilde under (φ)}⁽ⁿ⁺¹⁾={tilde under (φ)}⁽ⁿ⁺¹⁾+κₙ({tilde under (φ)}*−{tilde under (φ)}⁽ⁿ⁾) where {tilde under (φ)}* satisfies

$$\frac{\partial l}{\partial {φ}_{\sim}} = 0$$

for 0<κₙ≦1 and β is fixed at the value obtained from the previous M step.

It is possible to provide an EM algorithm for parameter selection in the context of parametric survival models and microarray data. Preferably, the EM algorithm is as follows:
1. Set n=0, S₀=(1,2, . . . p} {tilde under (φ)}^{(initial)}={tilde under (φ)}⁽⁰⁾. Let v be the vector with components

$${V}_{i} = \{ \begin{matrix}1 - ɛ , \\ ɛ ,\end{matrix} \begin{matrix}if {c}_{i} = 1 \\ if {c}_{i} = 0\end{matrix}$$

for some small ε, say for example 0.001. Define f to be log (v/Λ(y, φ)).

If p≦N compute initial values {tilde under (β)}* by {tilde under (β)}*=(X^{T}X+λI)⁻¹X^{T}f If p>N compute initial values {tilde under (β)}* by

$${{β}_{∼}}^{*} \frac{1}{λ} ( I - {{X}^{T} ( {XX}^{T} + λ I )}^{- 1} X ) {X}^{T} f$$

where the ridge parameter λ satisfies 0<λ≦1.
2. Define

$${β}_{i}^{( n )} = \{ \begin{matrix}{β}_{i}^{*} , & i ∈ {S}_{n} \\ 0 , & otherwise\end{matrix}$$

Let Pₙ be a matrix of zeroes and ones such that the nonzero elements {tilde under (y)}⁽ⁿ⁾ of {tilde under (β)}⁽ⁿ⁾ satisfy
{tilde under (γ)}⁽ⁿ⁾=Pₙ^{T}{tilde under (β)}⁽ⁿ⁾, {tilde under (β)}⁽ⁿ⁾=Pₙ{tilde under (γ)}⁽ⁿ⁾
{tilde under (γ)}=Pₙ^{T}{tilde under (β)}, {tilde under (β)}=Pₙ{tilde under (γ)}
3. Perform the E step by calculating

$$\begin{matrix}Q ( {β}_{∼} \vert {{β}_{∼}}^{( n )} , {{φ}_{∼}}^{( n )} ) = E \{ log ( P ( {β}_{∼} , {φ}_{∼} , τ \vert {y}_{∼} ) ) \vert {y}_{∼} , {{β}_{∼}}^{( n )} , {{φ}_{∼}}^{( n )} \} \\ = l ( {y}_{∼} \vert {β}_{∼} , {{φ}_{∼}}^{( n )} ) - \frac{1}{2} {\sum }_{i = 1}^{N} {( \frac{{β}_{i}}{{β}_{i}^{( n )}} )}^{2}\end{matrix}$$

where l is the log likelihood function of {tilde under (γ)} and {tilde under (φ)}⁽ⁿ⁾.

Using β=Pₙγ and β⁽ⁿ⁾=Pₙγ⁽ⁿ⁾ we have

$$Q ( {γ}_{∼} \vert {{γ}_{∼}}^{( n )} , {{φ}_{∼}}^{( n )} ) = l ( {y}_{∼} \vert {P}_{n} {γ}_{∼} , {{φ}_{∼}}^{( n )} ) - \frac{1}{2 } {\sum }_{i = 1}^{N} {( \frac{{γ}_{i}}{{γ}_{i}^{( n )}} )}^{2}$$

4. Do the M step. This can be done with Newton Raphson iterations as follows. Set {tilde under (y)}₀={tilde under (γ)}^{(r)} and for r=0,1,2, . . . {tilde under (γ)}ᵣ₊₁={tilde under (γ)}ᵣ+αᵣ {tilde under (δ)}ᵣ where αᵣ is chosen by a line search algorithm to ensure Q({tilde under (γ)}ᵣ₊₁|{tilde under (γ)}⁽ⁿ⁾,{tilde under (φ)}⁽ⁿ⁾)>Q({tilde under (γ)}^{r}|{tilde under (γ)}⁽ⁿ⁾,{tilde under (φ)}⁽ⁿ⁾).

For p≦N use
{tilde under (δ)}ᵣ=diag({tilde under (γ)}⁽ⁿ⁾)[Yₙ^{T}diag({tilde under (μ)})Yₙ+I]⁻¹(Yₙ^{T}({tilde under (c)}−{tilde under (μ)})−diag(1/{tilde under (γ)}⁽ⁿ⁾){tilde under (γ)})
where Y=XPₙdiag({tilde under (γ)}⁽ⁿ⁾).

For p>N use
{tilde under (δ)}ᵣ=−diag({tilde under (γ)}⁽ⁿ⁾)(I−Y^{T}(YY^{T}+diag(1/{tilde under (μ)}))⁻¹Y)(Yₙ^{T}({tilde under (c)}−{tilde under (μ)})−diag(1/{tilde under (γ)}⁽ⁿ⁾){tilde under (γ)})

Let γ* be the value of γᵣ when some convergence criterion is satisfied e.g ∥γᵣ−γᵣ₊₁∥<e (for example 10⁻⁵).
5. Define

$${{β}_{∼}}^{*} = {P}_{n} {{γ}_{∼}}^{*} , {S}_{n} = \{ i \text{:} \vert {β}_{i} \vert > {ɛ}_{1} {max}_{j} \vert {β}_{j} \vert \}$$

where ε₁ is a small constant, say 10⁻⁵. Set n=n+1, choose {tilde under (φ)}⁽ⁿ⁺¹⁾={tilde under (φ)}⁽ⁿ⁾+κₙ({tilde under (φ)}*−{tilde under (φ)}⁽ⁿ⁾) where {tilde under (φ)}* satisfies

$$\frac{\partial l ( {y}_{∼} \vert {P}_{n} {{γ}_{∼}}^{*} , {φ}_{∼} )}{\partial {φ}_{∼}} = 0$$

and κₙ is a damping factor such that 0<κₙ<1.
6. Check convergence. If ∥{tilde under (γ)}*−{tilde under (γ)}⁽ⁿ⁾∥<ε₂ where ε₂ is suitably small then stop, else go to step 2.

In another embodiment, survival times are described by a Weibull survival density function. For the Weibull case {tilde under (φ)} is preferably one dimensional and
Λ(y;{tilde under (φ)})=y^{α},
λ(y;{tilde under (φ)})=αy^{α-1},
{tilde under (φ)}=α

Preferably,

$$\frac{\partial l}{\partial α} = \frac{N}{α} + {\sum }_{i = 1}^{N} ( {c}_{i} - {μ}_{i} ) log ( {y}_{i} ) = 0$$

is solved after each M step so as to provide an updated value of α. Following the steps applied for Cox's proportional hazards model, one may estimate α and select a parsimonious subset of parameters from {tilde under (β)} that can provide an adequate explanation for the survival times if the survival times follow a Weibull distribution.

Features and advantages of the present invention will become apparent following a description of examples.

### EXAMPLES

### Example 1

### Two Group Classification for Prostate Cancer Using a Logistic Regression Model

In order to identify subsets of genes capable of classifying tissue into prostate of non-prostate groups, the microarray data set reported and analysed by Luo et al. (2001) was subjected to analysis using the method of the invention in which a binomial logistic regression was used as the model. This data set involves microarray data on 6500 human genes. The study contains 16 subjects known to have prostate cancer and 9 subjects with benign prostatic hyperplasia. However, for brevity of presentation only, 50 genes were selected for analysis. The gene expression ratios for all 50 genes (rows) and 25 patients (columns) are shown in Table 4.

The results of applying the method are given below. The model had G=2 classes and commenced with all 50 genes as potential variables (components or basis functions) in the model. After 21 iterations (see below) the algorithm found 2 genes, (numbers 36 and 47 of table 5) which gave perfect classification.

To determine whether the result was an artefact due to the large number of genes (variables) available in the data set, we ran a permutation test whereby the class labels were randomly permuted and the algorithm subsequently applied. This was repeated 200 times.

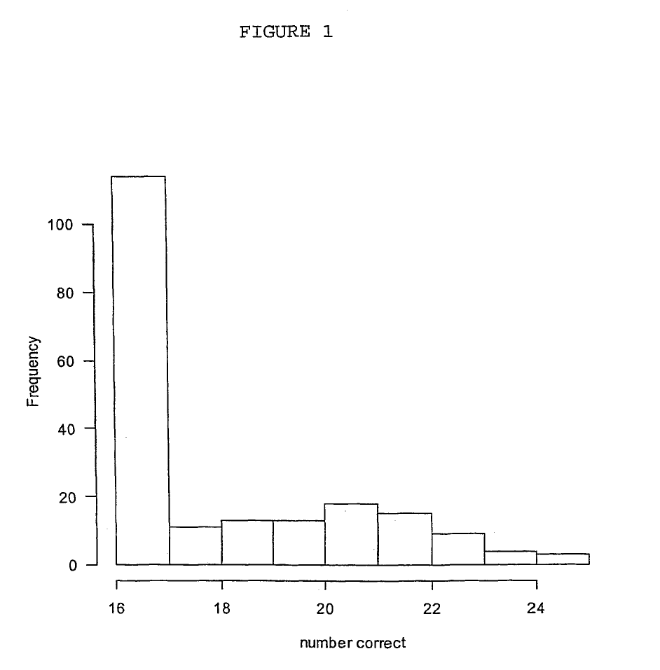

FIG. 1 gives a histogram of the number of cases correctly classified. The 100% accuracy for the actual data set is in the extreme tail of the permutation distribution with a p value of 0.015. This suggests the results are not due to chance.

The iteration details for the unpermuted data are shown below:

Iteration 1: 13 cycles, criterion −0.127695594930065 misclassification matrix

$$\begin{matrix} & 1 & 2 \\ 1 & 16 & 0 \\ 2 & 0 & 9\end{matrix}$$

row=true class

Class 1 Number of basis functions in model: 50

Iteration 2: 7 cycles, criterion −1.58111247310685 misclassification matrix

$$\begin{matrix} & 1 & 2 \\ 1 & 16 & 0 \\ 2 & 0 & 9\end{matrix}$$

row=true class

Class 1 Number of basis functions in model: 50

Iteration 3: 5 cycles, criterion −2.82347006228686 misclassification matrix

$$\begin{matrix} & 1 & 2 \\ 1 & 16 & 0 \\ 2 & 0 & 9\end{matrix}$$

row=true class

Class 1 Number of basis functions in model: 45

Iteration 4: 4 cycles, criterion −3.0353135992828 misclassification matrix

$$\begin{matrix} & 1 & 2 \\ 1 & 16 & 0 \\ 2 & 0 & 9\end{matrix}$$

row=true class

Class 1: Variables left in model 2 3 8 9 11 12 17 19 23 25 29 31 36 40 42 45 47 48 49 regression coefficients −0.00111392924172276 −3.66542218865611e-007 −1.18280157375022e-010 −1.15853525792239e-008 −2.23611388510839e-01 0 −1.99942263084115e-008 −0.00035412991046087 −0.844161298425504 −7.02985067116106e-011 −7.92510183180024e-011 −0.000286751487965763 −8.12273456244463e-008 −4.57102500405226 −0.000474781601043787 2.81670912477482e-011 −1.0 2591823605395e-008 1.20451375402485 −0.0120825667151016 −0.000171130745325351

Iteration 5: 4 cycles, criterion −2.82549351870821 misclassification matrix

$$\begin{matrix} & 1 & 2 \\ 1 & 16 & 0 \\ 2 & 0 & 9\end{matrix}$$

row=true class

Class 1 : Variables left in model 2 17 19 29 36 40 47 48 49 regression coefficients −1.01527560660479e-006 −6.47965734465826e-008 −0.36354429595162 −2.96434390382785e-008 −5.84197907608526 −8.399 36030488418e-008 1.22712881145334 −0.00041963284443207 −5.78172364089109e-008

Iteration 6: 4 cycles, criterion −2.49714605824366 misclassification matrix

$$\begin{matrix} & 1 & 2 \\ 1 & 16 & 0 \\ 2 & 0 & 9\end{matrix}$$

row=true class

Class 1: Variables left in model 19 36 47 48 regression coefficients −0.0598894592370422 −6.95130027598687 1.31485208225331 −4.34828258633208e-007

Iteration 7: 4 cycles, criterion −2.20181629904024 misclassification matrix

$$\begin{matrix} & 1 & 2 \\ 1 & 16 & 0 \\ 2 & 0 & 9\end{matrix}$$

row=true class

Class 1: Variables left in model 19 36 47 regression coefficients −0.00136540505944133 −7.61400108609408 1.40720739106609

Iteration 8: 3 cycles, criterion −2.02147819230974 misclassification matrix

$$\begin{matrix} & 1 & 2 \\ 1 & 16 & 0 \\ 2 & 0 & 9\end{matrix}$$

row=true class

Class 1: Variables left in model 19 36 47 regression coefficients −6.3429997893986e-007 −7.9815460139979 1.47084153596716

Iteration 9: 3 cycles, criterion −1.92333435556147 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.19142602569327 1.50856426381189

Iteration 10: 3 cycles, criterion −1.86996621406647 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.30998234780385 1.52999314044398

Iteration 11: 3 cycles, criterion −1.84085525990757 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.37612256703144 1.54195991212442

Iteration 12: 3 cycles, criterion −1.82494385332917 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.41273310098038 1.54858564046418

Iteration 13: 2 cycles, criterion −1.81623665404495 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.43290814197901 1.55223728701224

Iteration 14: 2 cycles, criterion −1.81146858213434 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.44399866057439 1.5542447583578

Iteration 15: 2 cycles, criterion −1.80885659137866 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.45008701361215 1.55534682956666

Iteration 16: 2 cycles, criterion −1.80742542023794 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.45342684192637 1.55595139130677

Iteration 17: 2 cycles, criterion −1.80664115725287 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.45525819006111 1.55628289706596

Iteration 18: 2 cycles, criterion −1.80621136412041 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.45626215911343 1.55646463370405

Iteration 19: 2 cycles, criterion −1.80597581993879 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.45681248047617 1.55656425211947

Iteration 20: 2 cycles, criterion −1.80584672964066 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.45711411647011 1.55661885392712

Iteration 21: 2 cycles, criterion −1.80577598079056 misclassification matrix

$$\begin{matrix} & 1 & 2 \\ 1 & 16 & 0 \\ 2 & 0 & 9\end{matrix}$$

row=true class

Class 1: Variables left in model 36 47 regression coefficients −8.45727943971564 1.5566487805773

TABLE 4

| | Disease | | | | | | | |
|---|---|---|---|---|---|---|---|---|
| | State | | | | | | | |
| | PC | PC | PC | PC | PC | PC | PC | PC |
| Gene 1 | 0.84 | 0.77 | 1.08 | 0.89 | 0.54 | 0.78 | 0.81 | 1.1 |
| Gene 2 | 0.93 | 0.92 | 0.67 | 1.05 | 0.62 | 0.47 | 0.57 | 0.46 |
| Gene 3 | 0.25 | 0.24 | 0.6 | 0.94 | 0.9 | 0.59 | 1.05 | 1.37 |
| Gene 4 | 1.02 | 0.86 | 0.76 | 1.11 | 1.12 | 0.86 | 0.83 | 1.6 |
| Gene 5 | 0.49 | 1.4 | 0.79 | 2.45 | 1.14 | 1.45 | 0.43 | 2.07 |
| Gene 6 | 1.05 | 1.36 | 0.97 | 0.88 | 1.09 | 0.76 | 1.08 | 0.49 |
| Gene 7 | 0.77 | 1.07 | 0.95 | 0.76 | 0.75 | 0.19 | 0.64 | 0.34 |
| Gene 8 | 0.89 | 3.92 | 1.11 | 0.8 | 0.63 | 1.65 | 1.01 | 1.23 |
| Gene 9 | 1.39 | 0.85 | 1.34 | 1.58 | 2.15 | 2.25 | 1.63 | 1.24 |
| Gene 10 | 0.63 | 0.88 | 0.56 | 0.94 | 0.67 | 0.42 | 0.6 | 0.42 |
| Gene 11 | 0.6 | 0.62 | 0.75 | 0.64 | 0.49 | 0.81 | 0.72 | 0.82 |
| Gene 12 | 0.84 | 0.15 | 0.67 | 0.84 | 0.79 | 0.93 | 0.61 | 0.77 |
| Gene 13 | 1.24 | 1.27 | 1.18 | 1.87 | 1.02 | 1.04 | 1.3 | 0.65 |
| Gene 14 | 1.23 | 1.04 | 0.97 | 0.87 | 0.81 | 0.95 | 1.17 | 1.13 |
| Gene 15 | 1.61 | 1.11 | 1.33 | 0.83 | 0.99 | 0.63 | 0.96 | 0.72 |
| Gene 16 | 0.59 | 0.68 | 1 | 1.11 | 1.39 | 0.86 | 0.86 | 0.63 |
| Gene 17 | 0.47 | 0.7 | 0.63 | 0.76 | 0.79 | 1.28 | 0.56 | 0.69 |
| Gene 18 | 1.4 | 1.4 | 0.6 | 0.88 | 1.33 | 1.61 | 2.05 | 1.05 |
| Gene 19 | 0.99 | 0.84 | 0.86 | 0.76 | 0.43 | 0.79 | 0.61 | 0.96 |
| Gene 20 | 0.73 | 0.92 | 0.73 | 0.73 | 0.67 | 0.61 | 0.81 | 0.91 |
| Gene 21 | 1.06 | 1.07 | 0.85 | 1.06 | 0.79 | 1.46 | 0.76 | 1.1 |
| Gene 22 | 1.08 | 0.67 | 1.16 | 2.3 | 0.85 | 1.55 | 1.29 | 1.15 |
| Gene 23 | 1.29 | 0.65 | 1.09 | 0.86 | 0.74 | 1.09 | 1 | 1.01 |
| Gene 24 | 0.9 | 1 | 1.04 | 1.08 | 0.92 | 0.99 | 0.79 | 0.93 |
| Gene 25 | 1.25 | 1.07 | 1.22 | 0.94 | 1.35 | 1.19 | 0.98 | 1.54 |
| Gene 26 | 0.9 | 1.34 | 1.13 | 0.95 | 0.53 | 1.5 | 0.94 | 0.8 |
| Gene 27 | 0.3 | 0.51 | 1.45 | 0.92 | 1.33 | 1.61 | 0.33 | 0.42 |
| Gene 28 | 0.39 | 0.71 | 0.68 | 0.57 | 0.55 | 0.57 | 0.6 | 0.46 |
| Gene 29 | 1.48 | 0.67 | 0.71 | 1.14 | 0.95 | 1.21 | 0.65 | 0.74 |
| Gene 30 | 0.9 | 0.34 | 0.9 | 1.1 | 0.97 | 1.01 | 0.97 | 1.06 |
| Gene 31 | 1.16 | 5.61 | 0.67 | 1.03 | 0.73 | 1.65 | 1.14 | 0.55 |
| Gene 32 | 0.88 | 0.86 | 1.09 | 0.96 | 0.58 | 1.27 | 0.94 | 0.76 |
| Gene 33 | 0.73 | 0.42 | 1.53 | 0.55 | 0.43 | 0.69 | 0.66 | 1.27 |
| Gene 34 | 0.84 | 0.76 | 0.72 | 1.61 | 0.73 | 1.76 | 0.82 | 1.88 |
| Gene 35 | 2.63 | 1.55 | 0.31 | 0.66 | 0.49 | 1.62 | 0.82 | 1.94 |
| Gene 36 | 0.15 | 0.16 | 0.1 | 0.22 | 1.06 | 0.12 | 0.22 | 0.08 |
| Gene 37 | 3.01 | 0.76 | 1.28 | 0.76 | 0.24 | 2.35 | 0.52 | 0.4 |
| Gene 38 | 1.46 | 0.98 | 0.94 | 0.99 | 1.03 | 1.51 | 1.33 | 1.88 |
| Gene 39 | 0.87 | 0.59 | 0.84 | 1.47 | 0.62 | 1.97 | 1.15 | 1.56 |
| Gene 40 | 0.77 | 0.93 | 0.92 | 1.23 | 0.86 | 0.89 | 0.59 | 0.82 |
| Gene 41 | 1.15 | 0.43 | 0.47 | 1 | 0.67 | 0.33 | 0.48 | 0.29 |
| Gene 42 | 1.12 | 0.91 | 0.71 | 0.63 | 1.06 | 0.61 | 0.81 | 0.78 |
| Gene 43 | 0.86 | 0.97 | 1.24 | 1.09 | 0.66 | 1 | 1.28 | 0.47 |
| Gene 44 | 1.33 | 1.12 | 1.10 | 0.92 | 1.43 | 1.12 | 1.15 | 0.97 |
| Gene 45 | 1.41 | 1.15 | 1.31 | 1.32 | 1.32 | 1.49 | 1.43 | 1.4 |
| Gene 46 | 1.14 | 1.18 | 0.86 | 0.99 | 0.88 | 0.97 | 0.92 | 1.32 |
| Gene 47 | 5.08 | 4.95 | 7.08 | 11.26 | 7.59 | 9.59 | 2.68 | 2.55 |
| Gene 48 | 0.66 | 0.72 | 1.18 | 0.92 | 0.91 | 1.27 | 1.16 | 1.27 |
| Gene 49 | 1.06 | 1.15 | 1.37 | 1.67 | 1.05 | 0.92 | 1 | 0.96 |
| Gene 50 | 32.91 | 12.32 | 8.35 | 4.93 | 10.99 | 14.22 | 4.72 | 3.15 |
| Gene 1 | 1.24 | 1.43 | 0.43 | 1.26 | 0.89 | 1.16 | 1.31 | 2.3 |
| Gene 2 | 0.3 | 0.82 | 2.55 | 0.39 | 0.87 | 1.16 | 0.55 | 0.63 |
| Gene 3 | 1.17 | 0.58 | 0.5 | 0.6 | 0.36 | 1.85 | 0.72 | 1.07 |
| Gene 4 | 1.56 | 1.24 | 1.34 | 1.84 | 1.08 | 1.06 | 1.47 | 0.87 |
| Gene 5 | 0.69 | 0.92 | 1.16 | 1.94 | 1.34 | 0.92 | 1.42 | 6.99 |
| Gene 6 | 0.23 | 0.98 | 0.57 | 0.71 | 0.57 | 0.73 | 0.81 | 0.84 |
| Gene 7 | 0.4 | 3.68 | 0.49 | 0.23 | 1.05 | 0.54 | 0.79 | 1.34 |
| Gene 8 | 1.23 | 0.61 | 2.04 | 1.3 | 0.79 | 1.32 | 3.96 | 1.64 |
| Gene 9 | 0.69 | 1.15 | 2.6 | 2.24 | 1.95 | 1.47 | 1.3 | 1.54 |
| Gene 10 | 0.48 | 0.39 | 0.44 | 0.8 | 0.58 | 0.79 | 0.42 | 1.85 |
| Gene 11 | 0.57 | 0.58 | 0.82 | 0.69 | 0.67 | 0.6 | 0.77 | 1.09 |
| Gene 12 | 0.49 | 0.94 | 0.85 | 0.81 | 1.04 | 0.83 | 0.83 | 0.35 |
| Gene 13 | 1.02 | 1.16 | 0.76 | 1.49 | 1.38 | 1.29 | 1.47 | 1.19 |
| Gene 14 | 1.15 | 0.85 | 1.38 | 1.23 | 2.06 | 0.72 | 1.16 | 0.98 |
| Gene 15 | 0.2 | 0.52 | 1.1 | 0.39 | 0.76 | 0.37 | 1.18 | 2.06 |
| Gene 16 | 0.68 | 1.32 | 0.99 | 0.78 | 1.16 | 0.9 | 1.03 | 1.67 |
| Gene 17 | 0.41 | 0.73 | 1.25 | 0.79 | 0.9 | 0.55 | 0.93 | 0.68 |
| Gene 18 | 0.25 | 0.56 | 1.71 | 0.86 | 3.07 | 0.99 | 2.42 | 2.28 |
| Gene 19 | 0.48 | 0.48 | 0.94 | 0.1 | 0.45 | 0.36 | 0.37 | 1.06 |
| Gene 20 | 0.46 | 0.5 | 0.46 | 0.4 | 0.47 | 0.78 | 0.57 | 1.31 |
| Gene 21 | 1.19 | 1.55 | 1.16 | 1.27 | 1.54 | 0.93 | 1.61 | 0.36 |
| Gene 22 | 2 | 0.84 | 0.86 | 1.7 | 1.01 | 0.6 | 2.22 | 0.99 |
| Gene 23 | 1.03 | 0.63 | 1.45 | 0.72 | 0.94 | 1.94 | 1.06 | 1.21 |
| Gene 24 | 0.87 | 1.11 | 0.86 | 1.37 | 1.18 | 0.8 | 1.19 | 1.74 |
| Gene 25 | 2.24 | 1.29 | 1.27 | 0.9 | 1.46 | 1.02 | 1.04 | 1.27 |
| Gene 26 | 0.28 | 0.75 | 0.89 | 0.85 | 0.66 | 1.52 | 0.43 | 0.58 |
| Gene 27 | 6.08 | 0.41 | 0.43 | 5.22 | 3 | 1.85 | 0.17 | 0.91 |
| Gene 28 | 0.4 | 1.07 | 0.93 | 1.63 | 0.92 | 0.46 | 0.67 | 0.95 |
| Gene 29 | 2.66 | 0.67 | 0.84 | 2.46 | 0.74 | 1.5 | 1.86 | 2.41 |
| Gene 30 | 1.17 | 0.55 | 0.83 | 0.98 | 1.12 | 1.52 | 1.29 | 1.01 |
| Gene 31 | 0.43 | 0.3 | 0.56 | 1.68 | 0.81 | 0.83 | 1.33 | 1.39 |
| Gene 32 | 0.59 | 1.1 | 1.86 | 1.08 | 1.32 | 0.59 | 1.17 | 0.65 |
| Gene 33 | 1.16 | 0.63 | 0.81 | 1.04 | 0.56 | 0.25 | 0.61 | 0.26 |
| Gene 34 | 1.32 | 0.63 | 1.18 | 0.82 | 0.73 | 0.23 | 0.81 | 0.45 |
| Gene 35 | 1.36 | 0.91 | 1.09 | 1.06 | 0.99 | 1.16 | 0.55 | 2.39 |
| Gene 36 | 0.2 | 0.23 | 0.11 | 0.13 | 0.18 | 0.12 | 0.24 | 0.59 |
| Gene 37 | 0.14 | 3.68 | 1.45 | 5.22 | 2.06 | 2.48 | 3.27 | 0.59 |
| Gene 38 | 1.64 | 0.46 | 2.15 | 2 | 1.66 | 0.87 | 2.78 | 1.27 |
| Gene 39 | 1.55 | 0.71 | 1.1 | 1.63 | 1.19 | 1.48 | 3.31 | 2.14 |
| Gene 40 | 0.74 | 0.39 | 0.47 | 1.14 | 0.87 | 0.9 | 1.16 | 2.42 |
| Gene 41 | 6.08 | 3.68 | 1.04 | 0.36 | 2.03 | 1.85 | 1.24 | 3.52 |
| Gene 42 | 0.4 | 4.67 | 1.3 | 5.22 | 1 | 1.07 | 0.47 | 3.52 |
| Gene 43 | 0.76 | 0.6 | 1.14 | 0.54 | 0.88 | 0.73 | 0.93 | 0.69 |
| Gene 44 | 1.07 | 0.84 | 1.03 | 0.95 | 1.36 | 0.89 | 1.15 | 1.20 |
| Gene 45 | 1.16 | 1.13 | 1.25 | 1.4 | 1.5 | 1.55 | 2.21 | 0.99 |
| Gene 46 | 1.08 | 0.87 | 0.66 | 0.79 | 0.61 | 1.06 | 1.46 | 0.98 |
| Gene 47 | 4.29 | 2.51 | 5.7 | 6.08 | 7.01 | 5.58 | 6.28 | 5.58 |
| Gene 48 | 1.18 | 1.22 | 1.35 | 1.31 | 1.66 | 1.2 | 1.13 | 1.93 |
| Gene 49 | 1.3 | 0.76 | 0.98 | 0.58 | 1.08 | 0.74 | 0.83 | 0.65 |
| Gene 50 | 1.53 | 1.79 | 6.49 | 5.28 | 4.52 | 5.41 | 22.03 | 4.6 |

| | Disease | | | | | | | | |
|---|---|---|---|---|---|---|---|---|---|
| | State | | | | | | | | |
| | BPH | BPH | BPH | BPH | BPH | BPH | BPH | BPH | BPH |
| Gene 1 | 3.91 | 2.56 | 0.52 | 1.33 | 0.93 | 0.97 | 1.68 | 1.29 | 0.98 |
| Gene 2 | 4 | 0.31 | 7.02 | 1.61 | 0.81 | 0.85 | 1.06 | 0.99 | 0.87 |
| Gene 3 | 0.91 | 10.51 | 0.57 | 2.56 | 1.37 | 1.1 | 1.2 | 1.34 | 0.91 |
| Gene 4 | 0.85 | 0.89 | 1 | 1.2 | 1.05 | 1.09 | 1.27 | 1.18 | 0.68 |
| Gene 5 | 0.91 | 4.2 | 0.45 | 0.47 | 1.11 | 1.48 | 0.81 | 2.3 | 1.13 |
| Gene 6 | 1.72 | 1.44 | 1.13 | 0.89 | 1.03 | 1.25 | 1.13 | 1.15 | 1 |
| Gene 7 | 0.8 | 0.74 | 1.25 | 1.19 | 0.94 | 1.01 | 1.04 | 0.92 | 1.15 |
| Gene 8 | 1.18 | 3.69 | 1.86 | 0.99 | 1.12 | 1.46 | 1.56 | 1.53 | 0.84 |
| Gene 9 | 1.27 | 1.28 | 1.49 | 1.36 | 0.87 | 1.21 | 0.84 | 1.02 | 0.95 |
| Gene 10 | 0.9 | 0.99 | 0.88 | 0.93 | 0.64 | 0.87 | 0.72 | 0.76 | 0.7 |
| Gene 11 | 0.88 | 1.12 | 1.02 | 0.96 | 1 | 0.96 | 1.1 | 0.79 | 0.9 |
| Gene 12 | 1.03 | 0.95 | 1.11 | 1.29 | 0.76 | 1.02 | 0.93 | 0.89 | 1.26 |
| Gene 13 | 1.02 | 0.91 | 1.02 | 0.87 | 0.94 | 1.04 | 0.93 | 0.92 | 1.05 |
| Gene 14 | 0.71 | 1.32 | 1.2 | 0.92 | 1.05 | 1.02 | 0.98 | 0.93 | 0.92 |
| Gene 15 | 0.75 | 0.82 | 0.57 | 0.76 | 0.91 | 0.76 | 0.86 | 1.09 | 1.22 |
| Gene 16 | 1.02 | 1.05 | 1.19 | 1.01 | 0.63 | 0.99 | 1.03 | 1.01 | 0.8 |
| Gene 17 | 2.14 | 3.42 | 1.34 | 1.61 | 0.58 | 0.86 | 0.67 | 0.82 | 0.77 |
| Gene 18 | 0.54 | 1.74 | 2.85 | 0.7 | 1.24 | 1.05 | 1.35 | 1.1 | 0.99 |
| Gene 19 | 1.41 | 1.27 | 0.81 | 0.81 | 1.48 | 1.19 | 1.23 | 1.16 | 0.86 |
| Gene 20 | 0.72 | 0.77 | 0.87 | 0.66 | 0.75 | 0.87 | 0.89 | 0.73 | 0.84 |
| Gene 21 | 1.11 | 0.63 | 0.95 | 1.16 | 0.95 | 1.16 | 1.62 | 1.03 | 0.91 |
| Gene 22 | 0.89 | 0.91 | 1.22 | 1.19 | 0.95 | 1.24 | 1.27 | 1.11 | 0.95 |
| Gene 23 | 0.86 | 2.77 | 0.92 | 1.2 | 1.15 | 1.72 | 1.71 | 1.45 | 1.09 |
| Gene 24 | 0.8 | 0.87 | 0.99 | 0.78 | 0.95 | 0.87 | 0.9 | 0.92 | 0.92 |
| Gene 25 | 1.51 | 1.17 | 1.19 | 1.38 | 0.91 | 1.21 | 1.43 | 1.07 | 0.92 |
| Gene 26 | 1.42 | 2.33 | 0.96 | 1.43 | 0.96 | 1.42 | 1.59 | 1.31 | 0.81 |
| Gene 27 | 2 | 0.79 | 0.7 | 1.18 | 0.88 | 0.78 | 0.71 | 0.93 | 0.99 |
| Gene 28 | 2.1 | 0.76 | 1.04 | 0.67 | 0.59 | 0.85 | 0.9 | 1.08 | 0.72 |
| Gene 29 | 0.74 | 1.2 | 1.01 | 1.08 | 1.08 | 1.21 | 1.36 | 1.38 | 1.19 |
| Gene 30 | 1.02 | 5.06 | 1.13 | 1.03 | 0.94 | 1.23 | 1.04 | 1.04 | 1.08 |
| Gene 31 | 0.64 | 2.18 | 1.71 | 0.87 | 1.29 | 2.09 | 1.85 | 1.29 | 1.89 |
| Gene 32 | 0.94 | 0.82 | 1.29 | 1.61 | 0.65 | 0.9 | 1.45 | 1.07 | 1.42 |
| Gene 33 | 0.71 | 0.65 | 0.69 | 0.65 | 1.14 | 1.05 | 1.1 | 0.85 | 0.81 |
| Gene 34 | 1.16 | 0.89 | 0.85 | 0.81 | 1.52 | 1.23 | 1.32 | 1.15 | 0.98 |
| Gene 35 | 1.14 | 1.09 | 0.72 | 0.55 | 1.35 | 1.39 | 1.59 | 1.48 | 0.91 |
| Gene 36 | 0.65 | 0.73 | 0.71 | 0.45 | 0.49 | 0.81 | 0.67 | 0.61 | 0.64 |
| Gene 37 | 0.79 | 0.41 | 0.9 | 1.66 | 0.99 | 1.01 | 1.03 | 0.88 | 0.82 |
| Gene 38 | 1.11 | 0.78 | 1.55 | 0.79 | 0.96 | 1.61 | 1.51 | 1.34 | 1.18 |
| Gene 39 | 0.87 | 0.91 | 0.93 | 1.15 | 1.1 | 1.49 | 1.27 | 1.39 | 1.36 |
| Gene 40 | 0.96 | 1.11 | 0.76 | 1.83 | 0.83 | 0.94 | 0.93 | 0.81 | 0.78 |
| Gene 41 | 1.78 | 3.68 | 1.75 | 1.44 | 0.88 | 1.23 | 1.31 | 1.05 | 1.4 |
| Gene 42 | 0.99 | 0.38 | 1.72 | 2.29 | 0.98 | 1 | 1.07 | 1.18 | 1.02 |
| Gene 43 | 0.67 | 0.81 | 1.38 | 0.8 | 0.82 | 0.97 | 0.88 | 0.75 | 0.88 |
| Gene 44 | 10.75 | 0.72 | 0.62 | 1.03 | 0.89 | 1.12 | 1.64 | 1.35 | 0.64 |
| Gene 45 | 1.03 | 0.85 | 1 | 0.81 | 1.27 | 1.29 | 1.34 | 1.4 | 1.27 |
| Gene 46 | 0.79 | 5.83 | 0.65 | 0.74 | 0.48 | 0.67 | 1.17 | 0.83 | 0.09 |
| Gene 47 | 1.45 | 1.04 | 0.74 | 0.91 | 1.37 | 1.05 | 1.1 | 1.85 | 1.68 |
| Gene 48 | 1.47 | 1.66 | 1.61 | 1.27 | 2.96 | 2.77 | 2.44 | 12.77 | 5.04 |
| Gene 49 | 0.79 | 0.79 | 1.3 | 0.82 | 2.96 | 2.77 | 2.44 | 2 | 10.91 |
| Gene 50 | 3.45 | 0.93 | 0.85 | 3.2 | 1.04 | 1.11 | 1.12 | 1.16 | 1.09 |

### Example 2

### Two Group Classification Using a Large Data Set and a Binomial Logistic Regression Model

In order to identify subsets of genes capable of classifying tissue into different clinical types of lymphoma, the data set reported and analysed in Alizadeh, A. A., et al. (2000) Distinct types of diffuse large B-cell lymphoma identified by gene expression profiling. Nature 403:503-511 was subjected to analysis using the method of the invention in which a binomial logistic regression was used as the model.

In the data set, there are n=4026 genes and n=42 samples. In the following DLBCL refers to “Diffuse large B cell Lymphoma”. The samples have been classified into two disease types GC B-like DLBCL (21 samples) and Activated B-like DLBCL (21 samples). We use this set to illustrate the use of the above methodology for rapidly discovering genes which are diagnostic of different disease types.

The results of applying the methodology are given below. The model had G=2 classes and commenced with all genes as potential variables (basis functions ) in the model. After 20 iterations the algorithm found 2 gene, numbers 1281 and 1312 (GENE3332X and GENE3258X) which gave the misclassification (table 5) below, and an overall classification success rate of 98%. This example ran in about 20 seconds on a laptop machine.

TABLE 5

| | Predicted class 1 | Predicted class 2 |
|---|---|---|
| True class 1 | 20 | 1 |
| True class 2 | 0 | 21 |

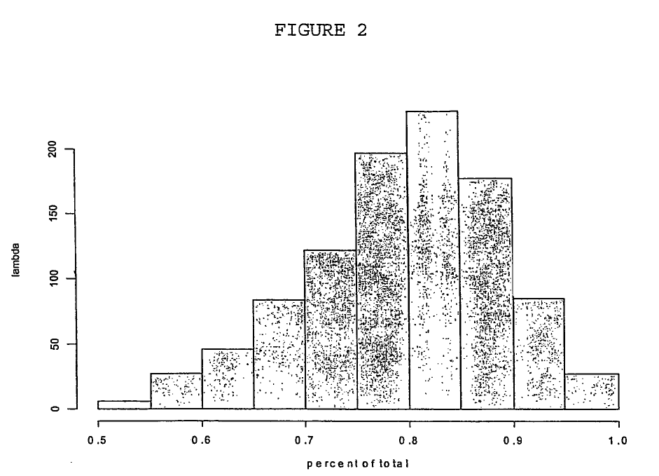

To determine whether the result was an artefact due to the large number of genes (variables) available in the data set, we ran a permutation test whereby the class labels were randomly permuted and the algorithm subsequently applied. This was repeated 1000 times. FIG. 2 gives a histogram of the percent of cases correctly classified (lambda). The 97.6% accuracy for the actual data set is in the extreme tail of the permutation distribution with a p value of 0.013. These observations suggests the results are not due to chance.

### Example 3

### Multi Group Classification

In order to identify genes capable of classifying samples into one of a multitude of classes, the data set reported and analyzed in Yeoh et al. Cancer Cell v1: 133-143 (2002) was subjected to analysis using the method of the invention in which a likelihood was used based on a multinomial logistic regression. The same pre-processing as described in Yeoh et al has been applied. This consisted of the following:
drop the following 8 arrays: BCR.ABL.R4, MLL.R5, Normal.R4, T.ALL.R7, T.ALL.R8,Hyperdip.50.2M.3, Hypodip.2M.3 , and Hypodip.2M.2
set the mean response value of each array to 2500
thresholding—values over 45000 are set to 45000 values less than 100 are set to 1
genes with less than 0.01 present are eliminated—this amounted to 1607 genes
genes for which the difference between the maximum and the minimum value was less than 100 are eliminated (1604 genes)

After preprocessing there are n=11005 genes and n=248 samples. The samples have been classified into 6 disease types:
1.BCR-ABL;
2. E2A-PBX1;
3. Hyperdip>50;
4. MLL;
5. T-ALL and
6. TEL-AML1.

This set was used to illustrate the use of the method for rapidly discovering genes which are diagnostic of different disease types. The results of applying the methodology are given below. The model had G=6 classes and commenced with all genes as potential variables (basis functions) in the model. After 20 iterations the algorithm found that the following 10 genes separated the classes:
X35823.at, X32562.at, X430.at, X39039.s.at, X39756.g.at, X1287.at, X40518.at, X38319.at, X41442.at, X1077.at.

A 15-fold cross validation gave the misclassification table below (Table 6), with 94% classification success:

TABLE 6

| subtype | 1 | 2 | 3 | 4 | 5 | 6 |
|---|---|---|---|---|---|---|
| BCR.ABL | 10 | 1 | 3 | 1 | 0 | 0 |
| E2A.PBX1 | 0 | 27 | 0 | 0 | 0 | 0 |
| Hyperdip > 50 | 3 | 0 | 60 | 1 | 0 | 0 |
| MLL | 1 | 1 | 2 | 16 | 1 | 2 |
| T-ALL | 0 | 0 | 1 | 0 | 42 | 0 |
| TEL-AML1 | 0 | 0 | 0 | 1 | 0 | 78 |

Confusion matrix for Multigroup classification cross-validation (15-fold)

A permutation test (permuting the class labels) showed that the cross validated error rate of 0.94% is highly significant (p=0.00).

### Example 4

### Standard Regression Using a Generalised Linear Model

This example illustrates how the method can be implemented in a generalised linear model framework. This example is a standard regression problem with 200 observations and 41 variables(basis functions). The true curve is observed with error (or noise) and is known to depend on only some of the variables. The responses are continuous and normally distributed. We analyse these data using our algorithm for generalised linear model variable selection.

This is a generalised linear model with:
Link function: g(μ)=μ
Derivative of link function:

$$\frac{\partial η}{\partial μ} = 1$$
Variance function: τ²=1
Scale parameter φ=σ²
Deviance (likelihood function):

$$- \frac{N}{2} log ( {σ}^{2} ) - 0.5 * {\sum }_{i = 1}^{N} \frac{{( {y}_{i} - {μ}_{i} )}^{2}}{{σ}^{2}}$$

The updating formula for σ² is

$${( {σ}^{2} )}^{n + 1} = \frac{1}{N} {\sum }_{i = 1}^{N} {( {y}_{i} - {μ}_{i}^{*} )}^{2}$$

where μ*ᵢ is the mean evaluated at β* in step 5 of the algorithm.

The output of the algorithm is given below.

EM Iteration: 1 expected post: −55.45434 basis fns 41 sigma squared 0.5607509

EM Iteration: 2 expected post: −43.96193 basis fns 41 sigma squared 0.5773566

EM Iteration: 3 expected post: −48.87198 basis fns 39 sigma squared 0.5943395

EM Iteration: 4 expected post: −52.79632 basis fns 31 sigma squared 0.6072137

EM Iteration: 5 expected post: −55.18578 basis fns 28 sigma squared 0.6161707

EM Iteration: 6 expected post: −56.5303 basis fns 23 sigma squared 0.6224545

EM Iteration: 7 expected post: −57.47589 basis fns 17 sigma squared 0.626674

EM Iteration: 8 expected post: −58.0566 basis fns 15 sigma squared 0.6293923

EM Iteration: 9 expected post: −58.41912 basis fns 13 sigma squared 0.6315789

EM Iteration: 10 expected post: −58.6923 basis fns 11 sigma squared 0.633089

EM Iteration: 11 expected post: −58.88766 basis fns 10 sigma squared 0.6343793

EM Iteration: 12 expected post: −59.05261 basis fns 10 sigma squared 0.635997

EM Iteration: 13 expected post: −59.24126 basis fns 9 sigma squared 0.6381456

EM Iteration: 14 expected post: −59.47668 basis fns 9 sigma squared 0.640962

EM Iteration: 15 expected post: −59.7677 basis fns 9 sigma squared 0.6443392

EM Iteration: 16 expected post: −60.10277 basis fns 9 sigma squared 0.6477088

EM Iteration: 17 expected post: −60.44193 basis fns 9 sigma squared 0.6508144

EM Iteration: 18 expected post: −60.7684 basis fns 9 sigma squared 0.6539145

EM Iteration: 19 expected post: −61.09251 basis fns 9 sigma squared 0.6565873

EM Iteration: 20 expected post: −61.38427 basis fns 8 sigma squared 0.6589498

EM Iteration: 21 expected post: −61.65061 basis fns 8 sigma squared 0.6615976

EM Iteration: 22 expected post: −61.92217 basis fns 8 sigma squared 0.664281

EM Iteration: 23 expected post: −62.17683 basis fns 7 sigma squared 0.6663748

EM Iteration: 24 expected post: −62.37402 basis fns 7 sigma squared 0.6679655

EM Iteration: 25 expected post: −62.51645 basis fns 7 sigma squared 0.6689011

EM Iteration: 26 expected post: −62.59567 basis fns 6 sigma squared 0.6689011

EM Iteration: 27 expected post: −62.6151 basis fns 6 sigma squared 0.6690962

EM Iteration: 28 expected post: −62.61717 basis fns 6 sigma squared 0.6691031

EM Iteration: 29 expected post: −62.61739 basis fns 5 sigma squared 0.6691035

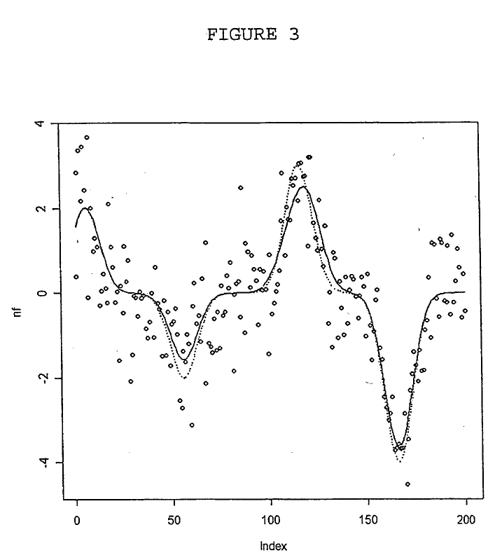

The algorithm converges with a model involving 5 of the 41 basis vectors (variables). A plot of the fitted curve (solid line) for the model with 5 variables (basis functions) selected by the algorithm, the true curve (dotted line) and the noisy data are given in FIG. 3 where the y variable is denoted nf.

### Example 5

### Small Linear Regression Example Using a Generalized Linear Model

This example is similar to example 4, but for brevity, a smaller number of variables (10) is used. This allows the full data set to be tabulated (see Table 7).The dependent variable is a function of the first four variables only, the remaining variables are noise.

The data were analysed as a generalised linear model, with identity link, constant variance, and a normal response. After 12 iterations the algorithm converged to a solution involving just the four variables known to have predictive information, and discarding all six of the noise variables.

TABLE 7

| Predictor Variables | | | | | | | | | | Dependent |
|---|---|---|---|---|---|---|---|---|---|---|
| V1 | V2 | V3 | V4 | V5 | V6 | V7 | V8 | V9 | V10 | Variable |
| 0.778801 | 0.852144 | 0.913931 | 0.960789 | 0.990050 | 1.000000 | 0.990050 | 0.960789 | 0.913931 | 0.852144 | 0.378571 |
| 0.778801 | 0.697676 | 0.612626 | 0.527292 | 0.444858 | 0.367879 | 0.298197 | 0.236928 | 0.184520 | 0.140858 | 2.832704 |
| 0.105399 | 0.077305 | 0.055576 | 0.039164 | 0.027052 | 0.018316 | 0.012155 | 0.007907 | 0.005042 | 0.003151 | 3.359711 |
| 0.001930 | 0.001159 | 0.000682 | 0.000394 | 0.000223 | 0.000123 | 0.000067 | 0.000036 | 0.000019 | 0.000010 | 2.170812 |
| 0.000005 | 0.000002 | 0.000001 | 0.000001 | 0.000000 | 0.000000 | 0.000000 | 0.000000 | 0.000000 | 0.000000 | 3.440226 |
| 0.000000 | 0.000000 | 0.000000 | 0.000000 | 0.000000 | 0.000000 | 0.000000 | 0.000000 | 0.000000 | 0.000000 | 2.424206 |
| 0.000000 | 0.000000 | 0.000000 | 0.000000 | 0.000000 | 0.000000 | 0.000000 | 0.000000 | 0.000000 | 0.000000 | −0.10464 |
| 0.000000 | 0.000000 | 0.000000 | 0.000000 | 0.000000 | 0.000000 | 0.000000 | 0.000000 | 0.000000 | 0.000000 | 3.672 |
| 0.000000 | 0.000000 | 0.000000 | 0.000000 | 0.000000 | 0.000000 | 0.000000 | 0.000000 | 0.000000 | 0.000000 | 2.003438 |
| 0.000000 | 0.000000 | 0.000000 | 0.000000 | 0.000000 | 0.000000 | 0.000000 | 0.000000 | 0.000000 | 0.000000 | 0.970833 |
| 0.000000 | 0.000000 | 0.000000 | 0.000000 | 0.000000 | 0.000000 | 0.000000 | 0.000000 | 0.000000 | 0.000000 | 1.28257 |
| 0.000000 | 0.000000 | 0.000000 | 0.000000 | 0.000000 | 0.000000 | 0.000000 | 0.000000 | 0.000000 | 0.000000 | 1.085955 |
| 0.000000 | 0.000000 | 0.000000 | 0.000000 | 0.000000 | 0.000000 | 0.000000 | 0.000000 | 0.000000 | 0.000000 | −0.30299 |
| 0.000000 | 0.000000 | 0.000000 | 0.000000 | 0.000000 | 0.000000 | 0.000000 | 0.000000 | 0.000000 | 0.000000 | 0.050082 |
| 0.000000 | 0.000000 | 0.000000 | 0.000000 | 0.000000 | 0.000000 | 0.000000 | 0.000000 | 0.000000 | 0.000000 | 0.457228 |
| 0.000000 | 0.000000 | 0.000000 | 0.000000 | 0.000000 | 0.000000 | 0.000000 | 0.000000 | 0.000000 | 0.000000 | 0.117205 |
| 0.000000 | 0.000000 | 0.000000 | 0.000000 | 0.000000 | 0.000000 | 0.000000 | 0.000000 | 0.000000 | 0.000000 | −0.22729 |
| 0.000000 | 0.000000 | 0.000000 | 0.000000 | 0.000000 | 0.000000 | 0.000000 | 0.000000 | 0.000000 | 0.000000 | 2.094908 |
| 0.000000 | 0.000000 | 0.000000 | 0.000000 | 0.000000 | 0.000000 | 0.000000 | 0.000000 | 0.000000 | 0.000000 | 1.084125 |
| 0.000000 | 0.000000 | 0.000000 | 0.000000 | 0.000000 | 0.000000 | 0.000000 | 0.000000 | 0.000000 | 0.000000 | 0.598052 |
| 0.000000 | 0.000000 | 0.000000 | 0.000000 | 0.000000 | 0.000000 | 0.000000 | 0.000000 | 0.000000 | 0.000000 | −0.22954 |
| 0.000000 | 0.000000 | 0.000000 | 0.000000 | 0.000000 | 0.000000 | 0.000000 | 0.000000 | 0.000001 | 0.000001 | 0.02262 |
| 0.000002 | 0.000005 | 0.000010 | 0.000019 | 0.000036 | 0.000067 | 0.000123 | 0.000223 | 0.000394 | 0.000682 | −1.5989 |
| 0.001159 | 0.001930 | 0.003151 | 0.005042 | 0.007907 | 0.012155 | 0.018316 | 0.027052 | 0.039194 | 0.055576 | 0.163323 |
| 0.077305 | 0.105399 | 0.140858 | 0.184520 | 0.236928 | 0.298197 | 0.367879 | 0.444858 | 0.527292 | 0.612626 | −0.46697 |
| 0.697676 | 0.778801 | 0.852144 | 0.913931 | 0.960789 | 0.990050 | 1.000000 | 0.990050 | 0.960789 | 0.913931 | 1.104836 |
| 0.852144 | 0.778801 | 0.697676 | 0.612626 | 0.527292 | 0.444858 | 0.367879 | 0.298197 | 0.236928 | 0.184520 | 0.257917 |
| 0.140858 | 0.105399 | 0.077305 | 0.055576 | 0.039164 | 0.027052 | 0.018316 | 0.012155 | 0.007907 | 0.005042 | 0.762435 |
| 0.003151 | 0.001930 | 0.001159 | 0.000682 | 0.000394 | 0.000223 | 0.000123 | 0.000067 | 0.000036 | 0.000019 | −2.08841 |
| 0.000010 | 0.000005 | 0.000002 | 0.000001 | 0.000001 | 0.000000 | 0.000000 | 0.000000 | 0.000000 | 0.000000 | −1.45189 |
| 0.000000 | 0.000000 | 0.000000 | 0.000000 | 0.000000 | 0.000000 | 0.000000 | 0.000000 | 0.000000 | 0.000000 | −0.08087 |
| 0.000000 | 0.000000 | 0.000000 | 0.000000 | 0.000000 | 0.000000 | 0.000000 | 0.000000 | 0.000000 | 0.000000 | −0.10876 |
| 0.000000 | 0.000000 | 0.000000 | 0.000000 | 0.000000 | 0.000000 | 0.000000 | 0.000000 | 0.000000 | 0.000000 | −0.55626 |
| 0.000000 | 0.000000 | 0.000000 | 0.000000 | 0.000000 | 0.000000 | 0.000000 | 0.000000 | 0.000000 | 0.000000 | 0.03139 |
| 0.000000 | 0.000000 | 0.000000 | 0.000000 | 0.000000 | 0.000000 | 0.000000 | 0.000000 | 0.000000 | 0.000000 | −0.12116 |
| 0.000000 | 0.000000 | 0.000000 | 0.000000 | 0.000000 | 0.000000 | 0.000000 | 0.000000 | 0.000000 | 0.000000 | −0.05413 |
| 0.000000 | 0.000000 | 0.000000 | 0.000000 | 0.000000 | 0.000000 | 0.000000 | 0.000000 | 0.000000 | 0.000000 | −0.83486 |
| 0.000000 | 0.000000 | 0.000000 | 0.000000 | 0.000000 | 0.000000 | 0.000000 | 0.000000 | 0.000000 | 0.000000 | −1.06148 |
| 0.000000 | 0.000000 | 0.000000 | 0.000000 | 0.000000 | 0.000000 | 0.000000 | 0.000000 | 0.000000 | 0.000000 | −0.69641 |
| 0.000000 | 0.000000 | 0.000000 | 0.000000 | 0.000000 | 0.000000 | 0.000000 | 0.000000 | 0.000000 | 0.000000 | −0.01406 |
| 0.000000 | 0.000000 | 0.000000 | 0.000000 | 0.000000 | 0.000000 | 0.000000 | 0.000000 | 0.000000 | 0.000000 | −1.04083 |
| 0.000000 | 0.000000 | 0.000000 | 0.000000 | 0.000000 | 0.000000 | 0.000000 | 0.000000 | 0.000000 | 0.000000 | 0.609888 |
| 0.000000 | 0.000000 | 0.000000 | 0.000000 | 0.000000 | 0.000000 | 0.000000 | 0.000000 | 0.000000 | 0.000000 | −0.24657 |
| 0.000000 | 0.000000 | 0.000000 | 0.000000 | 0.000000 | 0.000000 | 0.000000 | 0.000000 | 0.000000 | 0.000000 | −0.3763 |
| 0.000000 | 0.000000 | 0.000000 | 0.000000 | 0.000000 | 0.000000 | 0.000000 | 0.000000 | 0.000000 | 0.000000 | −1.49206 |
| 0.000000 | 0.000000 | 0.000000 | 0.000000 | 0.000000 | 0.000000 | 0.000000 | 0.000000 | 0.000000 | 0.000000 | −0.17637 |
| 0.000000 | 0.000000 | 0.000000 | 0.000000 | 0.000000 | 0.000000 | 0.000000 | 0.000000 | 0.000000 | 0.000000 | −1.47338 |
| 0.000000 | 0.000000 | 0.000000 | 0.000000 | 0.000000 | 0.000000 | 0.000000 | 0.000000 | 0.000000 | 0.000001 | −0.45066 |
| 0.000001 | 0.000002 | 0.000005 | 0.000010 | 0.000019 | 0.000036 | 0.000067 | 0.000123 | 0.000223 | 0.000394 | −1.71334 |
| 0.000682 | 0.001159 | 0.001930 | 0.003151 | 0.005042 | 0.007907 | 0.012155 | 0.018316 | 0.027052 | 0.039164 | −0.74203 |
| 0.055576 | 0.077305 | 0.105399 | 0.140858 | 0.184520 | 0.236928 | 0.298197 | 0.367879 | 0.444858 | 0.527292 | −0.66797 |
| 0.612626 | 0.697676 | 0.778801 | 0.852144 | 0.913931 | 0.960789 | 0.990050 | 1.000000 | 0.990050 | 0.960789 | −0.36114 |
| 0.913931 | 0.852144 | 0.778801 | 0.697676 | 0.612626 | 0.527292 | 0.444858 | 0.367879 | 0.298197 | 0.236928 | −0.97318 |
| 0.184520 | 0.140858 | 0.105399 | 0.077305 | 0.055576 | 0.039164 | 0.027052 | 0.018316 | 0.012155 | 0.007907 | −2.54985 |
| 0.005042 | 0.003151 | 0.001930 | 0.001159 | 0.000682 | 0.000394 | 0.000223 | 0.000123 | 0.000067 | 0.000036 | −2.71749 |
| 0.000019 | 0.000010 | 0.000005 | 0.000002 | 0.000001 | 0.000001 | 0.000000 | 0.000000 | 0.000000 | 0.000000 | −1.37393 |
| 0.000000 | 0.000000 | 0.000000 | 0.000000 | 0.000000 | 0.000000 | 0.000000 | 0.000000 | 0.000000 | 0.000000 | −1.62491 |
| 0.000000 | 0.000000 | 0.000000 | 0.000000 | 0.000000 | 0.000000 | 0.000000 | 0.000000 | 0.000000 | 0.000000 | −0.98101 |
| 0.000000 | 0.000000 | 0.000000 | 0.000000 | 0.000000 | 0.000000 | 0.000000 | 0.000000 | 0.000000 | 0.000000 | −1.19692 |
| 0.000000 | 0.000000 | 0.000000 | 0.000000 | 0.000000 | 0.000000 | 0.000000 | 0.000000 | 0.000000 | 0.000000 | −3.11507 |
| 0.000000 | 0.000000 | 0.000000 | 0.000000 | 0.000000 | 0.000000 | 0.000000 | 0.000000 | 0.000000 | 0.000000 | −0.31209 |
| 0.000000 | 0.000000 | 0.000000 | 0.000000 | 0.000000 | 0.000000 | 0.000000 | 0.000000 | 0.000000 | 0.000000 | 0.237347 |
| 0.000000 | 0.000000 | 0.000000 | 0.000000 | 0.000000 | 0.000000 | 0.000000 | 0.000000 | 0.000000 | 0.000000 | −0.72068 |
| 0.000000 | 0.000000 | 0.000000 | 0.000000 | 0.000000 | 0.000000 | 0.000000 | 0.000000 | 0.000000 | 0.000000 | −0.53267 |
| 0.000000 | 0.000000 | 0.000000 | 0.000000 | 0.000000 | 0.000000 | 0.000000 | 0.000000 | 0.000000 | 0.000000 | −1.14451 |
| 0.000000 | 0.000000 | 0.000000 | 0.000000 | 0.000000 | 0.000000 | 0.000000 | 0.000000 | 0.000000 | 0.000000 | 0.323257 |
| 0.000000 | 0.000000 | 0.000000 | 0.000000 | 0.000000 | 0.000000 | 0.000000 | 0.000000 | 0.000000 | 0.000000 | −2.1319 |
| 0.000000 | 0.000000 | 0.000000 | 0.000000 | 0.000000 | 0.000000 | 0.000000 | 0.000000 | 0.000000 | 0.000000 | 1.188074 |
| 0.000000 | 0.000000 | 0.000000 | 0.000000 | 0.000000 | 0.000000 | 0.000000 | 0.000000 | 0.000000 | 0.000000 | −1.18391 |
| 0.000000 | 0.000000 | 0.000000 | 0.000000 | 0.000000 | 0.000000 | 0.000000 | 0.000000 | 0.000000 | 0.000000 | −1.27328 |
| 0.000000 | 0.000000 | 0.000000 | 0.000000 | 0.000000 | 0.000000 | 0.000000 | 0.000000 | 0.000000 | 0.000000 | −1.40458 |
| 0.000000 | 0.000000 | 0.000000 | 0.000000 | 0.000000 | 0.000000 | 0.000000 | 0.000000 | 0.000000 | 0.000000 | −0.60408 |
| 0.000000 | 0.000000 | 0.000000 | 0.000000 | 0.000000 | 0.000000 | 0.000000 | 0.000000 | 0.000000 | 0.000000 | −1.35922 |
| 0.000001 | 0.000001 | 0.000002 | 0.000005 | 0.000010 | 0.000019 | 0.000036 | 0.000067 | 0.000123 | 0.000223 | −0.45079 |
| 0.000394 | 0.000682 | 0.001159 | 0.001930 | 0.003151 | 0.005042 | 0.007907 | 0.012155 | 0.018316 | 0.027052 | −1.29463 |
| 0.039164 | 0.055576 | 0.077305 | 0.105399 | 0.140858 | 0.184520 | 0.236928 | 0.298197 | 0.367879 | 0.444858 | 0.162774 |
| 0.527292 | 0.612626 | 0.697676 | 0.778801 | 0.852144 | 0.913931 | 0.960789 | 0.990050 | 1.000000 | 0.990050 | −0.53674 |
| 0.960789 | 0.913931 | 0.852144 | 0.778801 | 0.697676 | 0.612626 | 0.527292 | 0.444858 | 0.367879 | 0.298197 | −0.45683 |
| 0.236928 | 0.184520 | 0.140858 | 0.105399 | 0.077305 | 0.055576 | 0.039164 | 0.027052 | 0.018316 | 0.012155 | 0.391253 |
| 0.007907 | 0.005042 | 0.003151 | 0.001930 | 0.001159 | 0.000682 | 0.000394 | 0.000223 | 0.000123 | 0.000067 | 0.117457 |
| 0.000036 | 0.000019 | 0.000010 | 0.000005 | 1.000000 | 1.000000 | 1.000000 | 1.000000 | 1.000000 | 1.000000 | 0.69869 |
| 1.000000 | 1.000000 | 1.000000 | 1.000000 | 1.000000 | 1.000000 | 1.000000 | 1.000000 | 1.000000 | 1.000000 | −1.85312 |
| 1.000000 | 1.000000 | 1.000000 | 1.000000 | 1.000000 | 1.000000 | 1.000000 | 1.000000 | 1.000000 | 1.000000 | −0.04861 |
| 1.000000 | 1.000000 | 1.000000 | 1.000000 | 1.000000 | 1.000000 | 1.000000 | 1.000000 | 1.000000 | 1.000000 | 0.214684 |
| 1.000000 | 1.000000 | 1.000000 | 1.000000 | 1.000000 | 1.000000 | 1.000000 | 1.000000 | 1.000000 | 1.000000 | 0.261316 |
| 1.000000 | 1.000000 | 1.000000 | 1.000000 | 1.000000 | 1.000000 | 1.000000 | 1.000000 | 1.000000 | 1.000000 | −0.57448 |
| 1.000000 | 1.000000 | 1.000000 | 1.000000 | 1.000000 | 1.000000 | 1.000000 | 1.000000 | 1.000000 | 1.000000 | 2.468938 |
| 1.000000 | 1.000000 | 1.000000 | 1.000000 | 1.000000 | 1.000000 | 1.000000 | 1.000000 | 1.000000 | 1.000000 | −0.93785 |
| 1.000000 | 1.000000 | 1.000000 | 1.000000 | 1.000000 | 1.000000 | 1.000000 | 1.000000 | 1.000000 | 1.000000 | 1.165921 |
| 1.000000 | 1.000000 | 1.000000 | 1.000000 | 1.000000 | 1.000000 | 1.000000 | 1.000000 | 1.000000 | 1.000000 | 0.966748 |
| 1.000000 | 1.000000 | 1.000000 | 1.000000 | 1.000000 | 1.000000 | 1.000000 | 1.000000 | 1.000000 | 1.000000 | 0.125721 |
| 1.000000 | 1.000000 | 1.000000 | 1.000000 | 1.000000 | 1.000000 | 1.000000 | 1.000000 | 1.000000 | 1.000000 | 0.867138 |
| 1.000000 | 1.000000 | 1.000000 | 1.000000 | 1.000000 | 1.000000 | 1.000000 | 1.000000 | 1.000000 | 1.000000 | 0.551458 |
| 1.000000 | 1.000000 | 1.000000 | 1.000000 | 1.000000 | 1.000000 | 1.000000 | 1.000000 | 1.000000 | 1.000000 | 0.287231 |
| 1.000000 | 1.000000 | 1.000000 | 1.000000 | 1.000000 | 1.000000 | 1.000000 | 1.000000 | 1.000000 | 1.000000 | −0.75881 |
| 1.000000 | 1.000000 | 1.000000 | 1.000000 | 1.000000 | 1.000000 | 1.000000 | 1.000000 | 1.000000 | 1.000000 | 0.551283 |
| 1.000000 | 1.000000 | 1.000000 | 1.000000 | 1.000000 | 1.000000 | 1.000000 | 1.000000 | 1.000000 | 1.000000 | 0.066577 |
| 1.000000 | 1.000000 | 1.000000 | 1.000000 | 1.000000 | 1.000000 | 1.000000 | 1.000000 | 1.000000 | 1.000000 | 0.503767 |
| 1.000000 | 1.000000 | 1.000000 | 1.000000 | 1.000000 | 1.000000 | 1.000000 | 1.000000 | 1.000000 | 1.000000 | 0.067802 |
| 1.000000 | 1.000000 | 1.000000 | 1.000000 | 1.000000 | 1.000000 | 1.000000 | 1.000000 | 1.000000 | 1.000000 | −1.44586 |
| 1.000000 | 1.000000 | 1.000000 | 1.000000 | 1.000000 | 0.000000 | 0.000000 | 0.000001 | 0.000001 | 0.000002 | 0.884697 |
| 0.000005 | 0.000010 | 0.000019 | 0.000036 | 0.000067 | 0.000123 | 0.000223 | 0.000394 | 0.000682 | 0.001159 | −0.49601 |
| 0.001930 | 0.003151 | 0.005042 | 0.007907 | 0.012155 | 0.018316 | 0.027052 | 0.039164 | 0.055576 | 0.077305 | −0.24083 |
| 0.105399 | 0.140858 | 0.184520 | 0.236928 | 0.298197 | 0.367879 | 0.444858 | 0.527292 | 0.612626 | 0.697676 | 0.027056 |
| 0.778801 | 0.852144 | 0.913931 | 0.960789 | 0.990050 | 1.000000 | 0.990050 | 0.960789 | 0.913931 | 0.852144 | 0.189064 |
| 0.778801 | 0.697676 | 0.612626 | 0.527292 | 0.444858 | 0.367879 | 0.298197 | 0.236928 | 0.184520 | 0.140858 | 0.517325 |
| 0.105399 | 0.077305 | 0.055576 | 0.039164 | 0.027052 | 0.018316 | 0.012155 | 0.007907 | 0.005042 | 0.003151 | 1.688736 |
| 0.001930 | 0.001159 | 0.000682 | 0.000394 | 0.000223 | 0.000123 | 0.000067 | 0.000036 | 0.000019 | 0.000010 | 2.813648 |
| 0.000005 | 0.000002 | 0.000001 | 0.000001 | 0.000000 | 0.000000 | 0.000000 | 0.000000 | 0.000000 | 0.000000 | 0.877579 |
| 0.000000 | 0.000000 | 0.000000 | 0.000000 | 0.000000 | 0.000000 | 0.000000 | 0.000000 | 0.000000 | 0.000000 | 2.008548 |
| 0.000000 | 0.000000 | 0.000000 | 0.000000 | 0.000000 | 0.000000 | 0.000000 | 0.000000 | 0.000000 | 0.000000 | 1.728837 |
| 0.000000 | 0.000000 | 0.000000 | 0.000000 | 0.000000 | 0.000000 | 0.000000 | 0.000000 | 0.000000 | 0.000000 | 1.712295 |
| 0.000000 | 0.000000 | 0.000000 | 0.000000 | 0.000000 | 0.000000 | 0.000000 | 0.000000 | 0.000000 | 0.000000 | 2.676133 |
| 0.000000 | 0.000000 | 0.000000 | 0.000000 | 0.000000 | 0.000000 | 0.000000 | 0.000000 | 0.000000 | 0.000000 | 2.522675 |
| 0.000000 | 0.000000 | 0.000000 | 0.000000 | 0.000000 | 0.000000 | 0.000000 | 0.000000 | 0.000000 | 0.000000 | 2.704179 |
| 0.000000 | 0.000000 | 0.000000 | 0.000000 | 0.000000 | 0.000000 | 0.000000 | 0.000000 | 0.000000 | 0.000000 | 2.171262 |
| 0.000000 | 0.000000 | 0.000000 | 0.000000 | 0.000000 | 0.000000 | 0.000000 | 0.000000 | 0.000000 | 0.000000 | 3.029813 |
| 0.000000 | 0.000000 | 0.000000 | 0.000000 | 0.000000 | 0.000000 | 0.000000 | 0.000000 | 0.000000 | 0.000000 | 3.048587 |
| 0.000000 | 0.000000 | 0.000000 | 0.000000 | 0.000000 | 0.000000 | 0.000000 | 0.000000 | 0.000000 | 0.000000 | 2.721537 |
| 0.000000 | 0.000000 | 0.000000 | 0.000000 | 0.000000 | 0.000000 | 0.000000 | 0.000000 | 0.000000 | 0.000000 | 2.74891 |
| 0.000000 | 0.000000 | 0.000000 | 0.000000 | 0.000000 | 0.000000 | 0.000000 | 0.000000 | 0.000000 | 0.000000 | 1.089289 |
| 0.000000 | 0.000000 | 0.000000 | 0.000000 | 0.000000 | 0.000000 | 0.000000 | 0.000000 | 0.000001 | 0.000001 | 3.187072 |
| 0.000002 | 0.000005 | 0.000010 | 0.000019 | 0.000036 | 0.000067 | 0.000123 | 0.000223 | 0.000394 | 0.000682 | 3.197012 |
| 0.001159 | 0.001930 | 0.003151 | 0.005042 | 0.007907 | 0.012155 | 0.018316 | 0.027052 | 0.039164 | 0.055576 | 1.648355 |
| 0.077305 | 0.105399 | 0.140858 | 0.184520 | 0.236928 | 0.298197 | 0.367879 | 0.444858 | 0.527292 | 0.612626 | 1.283097 |
| 0.697676 | 0.778801 | 0.852144 | 0.913931 | 0.960789 | 0.990050 | 1.000000 | 0.990050 | 0.960789 | 0.913931 | 1.001207 |
| 0.852144 | 0.778801 | 0.697676 | 0.612626 | 0.527292 | 0.444858 | 0.367879 | 0.298197 | 0.236928 | 0.184520 | 2.190649 |
| 0.140858 | 0.105399 | 0.077305 | 0.055576 | 0.039164 | 0.027052 | 0.018316 | 0.012155 | 0.007907 | 0.005042 | 1.037059 |
| 0.003151 | 0.001930 | 0.001159 | 0.000682 | 0.000394 | 0.000223 | 0.000123 | 0.000067 | 0.000036 | 0.000019 | 0.617336 |
| 0.000010 | 0.000005 | 0.000002 | 0.000001 | 0.000001 | 0.000000 | 0.000000 | 0.000000 | 0.000000 | 0.000000 | 1.56651 |
| 0.000000 | 0.000000 | 0.000000 | 0.000000 | 0.000000 | 0.000000 | 0.000000 | 0.000000 | 0.000000 | 0.000000 | −0.72404 |
| 0.000000 | 0.000000 | 0.000000 | 0.000000 | 0.000000 | 0.000000 | 0.000000 | 0.000000 | 0.000000 | 0.000000 | 0.015634 |
| 0.000000 | 0.000000 | 0.000000 | 0.000000 | 0.000000 | 0.000000 | 0.000000 | 0.000000 | 0.000000 | 0.000000 | −1.2866 |
| 0.000000 | 0.000000 | 0.000000 | 0.000000 | 0.000000 | 0.000000 | 0.000000 | 0.000000 | 0.000000 | 0.000000 | 0.9474 |
| 0.000000 | 0.000000 | 0.000000 | 0.000000 | 0.000000 | 0.000000 | 0.000000 | 0.000000 | 0.000000 | 0.000000 | 0.804177 |
| 0.000000 | 0.000000 | 0.000000 | 0.000000 | 0.000000 | 0.000000 | 0.000000 | 0.000000 | 0.000000 | 0.000000 | −1.07216 |
| 0.000000 | 0.000000 | 0.000000 | 0.000000 | 0.000000 | 0.000000 | 0.000000 | 0.000000 | 0.000000 | 0.000000 | 0.257943 |
| 0.000000 | 0.000000 | 0.000000 | 0.000000 | 0.000000 | 0.000000 | 0.000000 | 0.000000 | 0.000000 | 0.000000 | −0.36585 |
| 0.000000 | 0.000000 | 0.000000 | 0.000000 | 0.000000 | 0.000000 | 0.000000 | 0.000000 | 0.000000 | 0.000000 | −0.99646 |
| 0.000000 | 0.000000 | 0.000000 | 0.000000 | 0.000000 | 0.000000 | 0.000000 | 0.000000 | 0.000000 | 0.000000 | 0.360602 |
| 0.000000 | 0.000000 | 0.000000 | 0.000000 | 0.000000 | 0.000000 | 0.000000 | 0.000000 | 0.000000 | 0.000000 | −0.72222 |
| 0.000000 | 0.000000 | 0.000000 | 0.000000 | 0.000000 | 0.000000 | 0.000000 | 0.000000 | 0.000000 | 0.000000 | 0.066804 |
| 0.000000 | 0.000000 | 0.000000 | 0.000000 | 0.000000 | 0.000000 | 0.000000 | 0.000000 | 0.000000 | 0.000000 | 0.379405 |
| 0.000000 | 0.000000 | 0.000000 | 0.000000 | 0.000000 | 0.000000 | 0.000000 | 0.000000 | 0.000000 | 0.000000 | 0.307738 |
| 0.000000 | 0.000000 | 0.000000 | 0.000000 | 0.000001 | 0.000001 | 0.000002 | 0.000005 | 0.000010 | 0.000019 | −0.09646 |
| 0.000036 | 0.000067 | 0.000123 | 0.000223 | 0.000394 | 0.000682 | 0.001159 | 0.001930 | 0.003151 | 0.005042 | −0.59666 |
| 0.007907 | 0.012155 | 0.018316 | 0.027052 | 0.039164 | 0.055576 | 0.077305 | 0.105399 | 0.140858 | 0.184520 | −0.07479 |
| 0.236928 | 0.298197 | 0.367879 | 0.444858 | 0.527292 | 0.612626 | 0.697676 | 0.778801 | 0.852144 | 0.913931 | 0.366227 |
| 0.960789 | 0.990050 | 1.000000 | 0.990050 | 0.960789 | 0.913931 | 0.852144 | 0.778801 | 0.697676 | 0.612626 | 0.146715 |
| 0.527292 | 0.444858 | 0.367879 | 0.298197 | 0.236928 | 0.184520 | 0.140858 | 0.105399 | 0.077305 | 0.055576 | −1.03773 |
| 0.039164 | 0.027052 | 0.018316 | 0.012155 | 0.007907 | 0.005042 | 0.003151 | 0.001930 | 0.001159 | 0.000682 | 0.43298 |
| 0.000394 | 0.000223 | 0.000123 | 0.000067 | 0.000036 | 0.000019 | 0.000010 | 0.000005 | 0.000002 | 0.000001 | −0.77253 |
| 0.000001 | 0.000000 | 0.000000 | 0.000000 | 0.000000 | 0.000000 | 0.000000 | 0.000000 | 0.000000 | 0.000000 | −1.59873 |
| 0.000000 | 0.000000 | 0.000000 | 0.000000 | 0.000000 | 0.000000 | 0.000000 | 0.000000 | 0.000000 | 0.000000 | −0.91667 |
| 0.000000 | 0.000000 | 0.000000 | 0.000000 | 0.000000 | 0.000000 | 0.000000 | 0.000000 | 0.000000 | 0.000000 | −0.18372 |
| 0.000000 | 0.000000 | 0.000000 | 0.000000 | 0.000000 | 0.000000 | 0.000000 | 0.000000 | 0.000000 | 0.000000 | 0.05454 |
| 0.000000 | 0.000000 | 0.000000 | 0.000000 | 0.000000 | 0.000000 | 0.000000 | 0.000000 | 0.000000 | 0.000000 | −1.29388 |
| 0.000000 | 0.000000 | 0.000000 | 0.000000 | 0.000000 | 0.000000 | 0.000000 | 0.000000 | 0.000000 | 0.000000 | −1.58155 |
| 0.000000 | 0.000000 | 0.000000 | 0.000000 | 0.000000 | 0.000000 | 0.000000 | 0.000000 | 0.000000 | 0.000000 | −2.46637 |
| 0.000000 | 0.000000 | 0.000000 | 0.000000 | 0.000000 | 0.000000 | 0.000000 | 0.000000 | 0.000000 | 0.000000 | −2.70749 |
| 0.000000 | 0.000000 | 0.000000 | 0.000000 | 0.000000 | 0.000000 | 0.000000 | 0.000000 | 0.000000 | 0.000000 | −2.9947 |
| 0.000000 | 0.000000 | 0.000000 | 0.000000 | 0.000000 | 0.000000 | 0.000000 | 0.000000 | 0.000000 | 0.000000 | −2.85241 |
| 0.000000 | 0.000000 | 0.000000 | 0.000000 | 0.000000 | 0.000000 | 0.000000 | 0.000000 | 0.000000 | 0.000000 | −2.46247 |
| 0.000000 | 0.000000 | 0.000000 | 0.000000 | 0.000000 | 0.000000 | 0.000000 | 0.000000 | 0.000000 | 0.000000 | −3.73826 |
| 0.000000 | 0.000000 | 0.000000 | 0.000000 | 0.000000 | 0.000000 | 0.000000 | 0.000000 | 0.000000 | 0.000000 | −3.68025 |
| 0.000000 | 0.000000 | 0.000000 | 0.000000 | 0.000000 | 0.000000 | 0.000000 | 0.000000 | 0.000000 | 0.000000 | −3.57917 |
| 0.000000 | 0.000000 | 0.000000 | 0.000000 | 0.000000 | 0.000000 | 0.000000 | 0.000000 | 0.000000 | 0.000000 | −3.69291 |
| 0.000000 | 0.000000 | 0.000000 | 0.000000 | 0.000000 | 0.000001 | 0.000001 | 0.000002 | 0.000005 | 0.000010 | −3.69046 |
| 0.000019 | 0.000036 | 0.000067 | 0.000123 | 0.000223 | 0.000394 | 0.000682 | 0.001159 | 0.001930 | 0.003151 | −2.85299 |
| 0.005042 | 0.007907 | 0.012155 | 0.018316 | 0.027052 | 0.039164 | 0.055576 | 0.077305 | 0.105399 | 0.140858 | −4.54066 |
| 0.184520 | 0.236928 | 0.298197 | 0.367879 | 0.444858 | 0.527292 | 0.612626 | 0.697676 | 0.778801 | 0.852144 | −3.46635 |
| 0.913931 | 0.960789 | 0.990050 | 1.000000 | 0.990050 | 0.960789 | 0.913931 | 0.852144 | 0.778801 | 0.697676 | −2.3129 |
| 0.612626 | 0.527292 | 0.444858 | 0.367879 | 0.298197 | 0.236928 | 0.184520 | 0.140858 | 0.105399 | 0.077305 | −1.909 |
| 0.055576 | 0.039164 | 0.027052 | 0.018316 | 0.012155 | 0.007907 | 0.005042 | 0.003151 | 0.001930 | 0.001159 | −1.38891 |
| 0.000682 | 0.000394 | 0.000223 | 0.000123 | 0.000067 | 0.000036 | 0.000019 | 0.000010 | 0.000005 | 0.000002 | −1.70557 |
| 0.000001 | 0.000001 | 0.000000 | 0.000000 | 0.000000 | 0.000000 | 0.000000 | 0.000000 | 0.000000 | 0.000000 | −2.08043 |
| 0.000000 | 0.000000 | 0.000000 | 0.000000 | 0.000000 | 0.000000 | 0.000000 | 0.000000 | 0.000000 | 0.000000 | −1.34632 |
| 0.000000 | 0.000000 | 0.000000 | 0.000000 | 0.000000 | 0.000000 | 0.000000 | 0.000000 | 0.000000 | 0.000000 | −1.84107 |
| 0.000000 | 0.000000 | 0.000000 | 0.000000 | 0.000000 | 0.000000 | 0.000000 | 0.000000 | 0.000000 | 0.000000 | −1.83476 |
| 0.000000 | 0.000000 | 0.000000 | 0.000000 | 0.000000 | 0.000000 | 0.000000 | 0.000000 | 0.000000 | 0.000000 | −0.86864 |
| 0.000000 | 0.000000 | 0.000000 | 0.000000 | 0.000000 | 0.000000 | 0.000000 | 0.000000 | 0.000000 | 0.000000 | −0.65575 |
| 0.000000 | 0.000000 | 0.000000 | 0.000000 | 0.000000 | 0.000000 | 0.000000 | 0.000000 | 0.000000 | 0.000000 | 0.340095 |
| 0.000000 | 0.000000 | 0.000000 | 0.000000 | 0.000000 | 0.000000 | 0.000000 | 0.000000 | 0.000000 | 0.000000 | −1.0628 |
| 0.000000 | 0.000000 | 0.000000 | 0.000000 | 0.000000 | 0.000000 | 0.000000 | 0.000000 | 0.000000 | 0.000000 | 1.159148 |
| 0.000000 | 0.000000 | 0.000000 | 0.000000 | 0.000000 | 0.000000 | 0.000000 | 0.000000 | 0.000000 | 0.000000 | 1.126134 |
| 0.000000 | 0.000000 | 0.000000 | 0.000000 | 0.000000 | 0.000000 | 0.000000 | 0.000000 | 0.000000 | 0.000000 | −0.15135 |
| 0.000000 | 0.000000 | 0.000000 | 0.000000 | 0.000000 | 0.000000 | 0.000000 | 0.000000 | 0.000000 | 0.000000 | −0.57837 |
| 0.000000 | 0.000000 | 0.000000 | 0.000000 | 0.000000 | 0.000000 | 0.000000 | 0.000000 | 0.000000 | 0.000000 | 1.241583 |
| 0.000000 | 0.000000 | 0.000000 | 0.000000 | 0.000000 | 0.000000 | 0.000000 | 0.000000 | 0.000000 | 0.000000 | 1.165105 |
| 0.000000 | 0.000000 | 0.000000 | 0.000000 | 0.000000 | 0.000000 | 0.000000 | 0.000000 | 0.000000 | 0.000000 | −0.2 |
| 0.000000 | 0.000000 | 0.000000 | 0.000000 | 0.000000 | 0.000000 | 0.000000 | 0.000000 | 0.000000 | 0.000000 | −0.23279 |
| 0.000000 | 0.000000 | 0.000000 | 0.000000 | 0.000000 | 0.000000 | 0.000000 | 0.000000 | 0.000000 | 0.000000 | 1.092664 |
| 0.000000 | 0.000000 | 0.000000 | 0.000000 | 0.000000 | 0.000000 | 0.000000 | 0.000000 | 0.000000 | 0.000000 | −0.52286 |
| 0.000000 | 0.000000 | 0.000000 | 0.000000 | 0.000000 | 0.000000 | 0.000000 | 0.000000 | 0.000000 | 0.000000 | 1.348673 |
| 0.000000 | 0.000000 | 0.000000 | 0.000000 | 0.000000 | 0.000000 | 0.000000 | 0.000000 | 0.000000 | 0.000000 | −0.22802 |
| 0.000000 | 0.000001 | 0.000001 | 0.000002 | 0.000005 | 0.000010 | 0.000019 | 0.000036 | 0.000067 | 0.000123 | 0.260234 |
| 0.000223 | 0.000394 | 0.000682 | 0.001159 | 0.001930 | 0.003151 | 0.005042 | 0.007907 | 0.012155 | 0.018316 | 1.027092 |
| 0.027052 | 0.039164 | 0.055576 | 0.077305 | 0.105399 | 0.140858 | 0.184520 | 0.236928 | 0.298197 | 0.367879 | 0.585037 |
| 0.444858 | 0.527292 | 0.612626 | 0.697676 | 0.778801 | 0.852144 | 0.913931 | 0.960789 | 0.990050 | 1.000000 | −0.5898 |
| 0.990050 | 0.960789 | 0.913931 | 0.852144 | 0.778801 | 0.697676 | 0.612626 | 0.527292 | 0.444858 | 0.367879 | 0.439033 |
| 0.298197 | 0.236928 | 0.184520 | 0.140858 | 0.105399 | 0.077305 | 0.055576 | 0.039164 | 0.027052 | 0.018316 | −0.42928 |

TABLE 8
Gene Expression Data and Survival for 50 Genes from Alizadeh et al

| | Survival | Out- | | | | | | | | | | | | | |
|---|---|---|---|---|---|---|---|---|---|---|---|---|---|---|---|
| Patient | Time | come | X1554 | X1639 | X1777 | X1876 | X1908 | X1940 | X2045 | X2208 | X2339 | X2383 | X2395 | X2430 | X2491 |
| V32 | 1.3 | 1 | 0.270 | −0.730 | −0.100 | −0.080 | 0.570 | −0.510 | 0.520 | 1.830 | 0.500 | 0.110 | −0.630 | −0.250 | 1.940 |
| V17 | 2.4 | 1 | −0.170 | −0.480 | −0.560 | −0.470 | −0.350 | 0.860 | 0.830 | 2.320 | −0.080 | 0.770 | −0.740 | −0.230 | 0.220 |
| V18 | 2.9 | 1 | 0.040 | −0.010 | −1.110 | −0.880 | −0.540 | −0.340 | 0.380 | 2.730 | 0.580 | 0.300 | −0.580 | 0.120 | 1.390 |
| V6 | 3.2 | 1 | −0.300 | 0.020 | −0.440 | −0.300 | −0.220 | −0.140 | 1.430 | 0.640 | 0.100 | 0.370 | −0.480 | −0.530 | 0.110 |
| V2 | 3.4 | 1 | −0.050 | −0.096 | −0.700 | −0.390 | −0.140 | −0.140 | 0.540 | −0.230 | 0.090 | 1.130 | 0.090 | 0.000 | 0.480 |
| V12 | 4.1 | 1 | −0.050 | −0.200 | 0.570 | −0.190 | 0.360 | 0.400 | 0.040 | 0.000 | −0.120 | −0.190 | 0.270 | 0.090 | −0.530 |
| V20 | 4.6 | 1 | −0.360 | 1.100 | −0.620 | −0.520 | −0.160 | −0.290 | 0.570 | 0.900 | 0.460 | 0.100 | −0.520 | 0.000 | −0.180 |
| V25 | 5.1 | 1 | −0.010 | −0.300 | −0.410 | −1.070 | 0.160 | −0.410 | 0.620 | 1.860 | 0.020 | 0.500 | 0.050 | 0.050 | 1.720 |
| V21 | 8.2 | 1 | −0.810 | −0.295 | −1.190 | −0.434 | −0.330 | −0.640 | −0.470 | −0.480 | −0.250 | −0.209 | −0.148 | −0.290 | 0.220 |
| V7 | 8.3 | 1 | −0.230 | −0.750 | 0.320 | −0.260 | 0.220 | −0.270 | 0.750 | 0.540 | 0.440 | −0.620 | 0.260 | −0.050 | 0.640 |
| V39 | 9.5 | 1 | −0.250 | 0.370 | −0.340 | 0.980 | −0.380 | −0.370 | −3.210 | 2.470 | 0.930 | −0.220 | −0.770 | 0.650 | −0.920 |
| V24 | 11.8 | 1 | 0.000 | −0.140 | −0.460 | −0.340 | −0.170 | 0.000 | 0.310 | 0.630 | −0.020 | 0.000 | 0.270 | 0.660 | 1.000 |
| V29 | 12.3 | 1 | 0.390 | −0.360 | 0.120 | −0.240 | 0.180 | 0.890 | −1.180 | 0.600 | −0.080 | −0.870 | 0.480 | −0.310 | 0.930 |
| V33 | 12.7 | 1 | 0.260 | 0.060 | −0.040 | 0.150 | 0.190 | 0.800 | −0.310 | 0.290 | 0.170 | −0.170 | −0.370 | −0.130 | 0.260 |
| V16 | 15.5 | 1 | −0.290 | −0.210 | −0.660 | −0.980 | −0.030 | 0.340 | 0.350 | −0.620 | 0.630 | 0.380 | −0.160 | 0.280 | 0.080 |
| V40 | 22.3 | 1 | −0.150 | −0.380 | −0.080 | −0.500 | −0.090 | −0.220 | −0.760 | 1.670 | −0.490 | −0.009 | 0.550 | −0.400 | −0.290 |
| V13 | 23.7 | 1 | −0.920 | −0.460 | −1.150 | −0.380 | −0.440 | 0.460 | −0.660 | 0.700 | 0.790 | 0.220 | 0.000 | −0.270 | 0.070 |
| V11 | 27.1 | 1 | 0.060 | −1.620 | −0.590 | −0.340 | −0.080 | −1.300 | 0.890 | 1.450 | −0.080 | −0.025 | −1.080 | −0.560 | 1.620 |
| V37 | 31.5 | 1 | −0.090 | 0.050 | −0.290 | −0.230 | 0.070 | −0.820 | 0.740 | 1.190 | −0.340 | 0.370 | 0.760 | 0.610 | 0.640 |
| V23 | 32.5 | 1 | −0.380 | 0.060 | −0.150 | −0.570 | 0.120 | −0.470 | −0.530 | 0.250 | −0.480 | −0.390 | 0.390 | 0.320 | 0.700 |
| V38 | 39.6 | 1 | −0.145 | 0.060 | 0.340 | −0.270 | 1.240 | 0.280 | −1.320 | −2.580 | 0.180 | −0.040 | 0.510 | −0.040 | −1.570 |
| V5 | 51.2 | 0 | −0.070 | −0.380 | −0.080 | 0.000 | 0.130 | 0.050 | 0.190 | 0.130 | 0.220 | −0.760 | 0.190 | −0.110 | 0.190 |
| V36 | 53.7 | 0 | −0.200 | −0.410 | −0.320 | −0.430 | −0.600 | 0.240 | 2.170 | 0.350 | 0.310 | −0.050 | −0.320 | 0.370 | −0.090 |
| V15 | 56.6 | 0 | −0.820 | 0.160 | −0.040 | −1.250 | 0.500 | −0.550 | −0.380 | −0.010 | −0.760 | 0.460 | 0.110 | 0.200 | 0.790 |
| V14 | 59.0 | 0 | −0.340 | −0.043 | −0.700 | −0.056 | 0.198 | 1.000 | 0.630 | 0.290 | 0.000 | 0.298 | −0.090 | 0.120 | −0.060 |
| V31 | 68.8 | 0 | 0.080 | −0.140 | 0.200 | 0.110 | −0.080 | 0.160 | 0.230 | 1.330 | 0.290 | −0.250 | −0.050 | −0.050 | 0.430 |
| V30 | 69.1 | 0 | 0.380 | 0.720 | 0.700 | 0.390 | 0.000 | −0.580 | −0.670 | −0.480 | −0.610 | −0.640 | 0.440 | 1.630 | 0.590 |
| V4 | 69.6 | 0 | −0.060 | −0.570 | −0.380 | −0.830 | 0.060 | −0.010 | 0.470 | 1.230 | 0.010 | −0.060 | 0.210 | −0.090 | 0.150 |
| V3 | 71.3 | 1 | −0.400 | −0.280 | −0.390 | −0.490 | −0.040 | −0.080 | 1.640 | 2.110 | 0.220 | −0.100 | 0.210 | 0.010 | −0.700 |
| V28 | 71.3 | 0 | 0.700 | 0.160 | 0.100 | 0.160 | 0.310 | 0.260 | 0.650 | 0.720 | −0.290 | −1.200 | 0.630 | −0.140 | 0.370 |
| V34 | 72.0 | 0 | −0.940 | −0.050 | −0.060 | −0.240 | −0.070 | 0.440 | −1.500 | 0.170 | 0.090 | 0.147 | −0.050 | 0.340 | 3.630 |
| V1 | 77.4 | 0 | 0.000 | 0.530 | 0.980 | 0.380 | 0.910 | 1.080 | 3.210 | 2.580 | −0.220 | −0.140 | −0.870 | 0.100 | −0.970 |
| V19 | 80.4 | 0 | −0.190 | −0.340 | −0.950 | −0.430 | −0.410 | 0.150 | −0.110 | −0.800 | −0.050 | −0.870 | −0.780 | −0.100 | 0.170 |
| V27 | 83.8 | 0 | 0.280 | 0.000 | −1.110 | −1.040 | −0.570 | −0.150 | 0.720 | 1.080 | 0.070 | 0.220 | −0.180 | 0.620 | 0.000 |
| V10 | 88.1 | 0 | 0.690 | −0.370 | 0.000 | 0.130 | 0.060 | −0.160 | 0.670 | −0.910 | 0.120 | −0.130 | −0.590 | 0.220 | −0.600 |
| V9 | 89.8 | 0 | −0.220 | −0.700 | −0.790 | −0.340 | −0.260 | 0.190 | −1.130 | −1.960 | −0.150 | 0.490 | 0.540 | 0.320 | 0.710 |
| V26 | 90.2 | 0 | −0.200 | 0.420 | −0.270 | 0.240 | 0.470 | −0.670 | −0.280 | 0.380 | −0.890 | 0.850 | 0.000 | −0.210 | −0.440 |
| V35 | 91.3 | 0 | −0.560 | −0.660 | −0.810 | −0.530 | −0.250 | −0.250 | 0.720 | −1.160 | 0.230 | 0.090 | −0.350 | 0.940 | 0.720 |
| V8 | 102.4 | 0 | 0.260 | −0.800 | 0.420 | 0.260 | −0.030 | 0.450 | −0.870 | 0.550 | 0.380 | 0.280 | 0.120 | 0.170 | 0.260 |
| V22 | 129.9 | 0 | −0.680 | −0.120 | −0.210 | −0.460 | 0.690 | −0.390 | 0.070 | 0.490 | −0.670 | 0.910 | −0.220 | −0.150 | 1.200 |

| | Survival | Out- | | | | | | | | | | | | |
|---|---|---|---|---|---|---|---|---|---|---|---|---|---|---|
| Patient | Time | come | X2544 | X2640 | X2824 | X2882 | X2922 | X3041 | X3138 | X3171 | X3249 | X3346 | X3494 | X4021 |
| V32 | 1.3 | 1 | −0.110 | 0.280 | 0.120 | 0.560 | 1.440 | −0.300 | 0.440 | 2.470 | −0.230 | −0.150 | 0.300 | 0.090 |
| V17 | 2.4 | 1 | 0.050 | −0.150 | 0.050 | −0.260 | 0.610 | 0.050 | 0.070 | 1.490 | −0.370 | 0.060 | 0.180 | 0.010 |
| V18 | 2.9 | 1 | 0.380 | 2.030 | 1.740 | 1.050 | 0.080 | 1.480 | 0.840 | 0.000 | 0.570 | 1.110 | 0.035 | −0.620 |
| V6 | 3.2 | 1 | −0.480 | −0.180 | −0.220 | −0.270 | −0.770 | 0.180 | −0.410 | 1.520 | −0.820 | 0.670 | 0.040 | −0.190 |
| V2 | 3.4 | 1 | −0.120 | −0.260 | −0.510 | 0.240 | −0.250 | 0.220 | 0.290 | 0.670 | 0.340 | −0.280 | −0.080 | 0.240 |
| V12 | 4.1 | 1 | −0.210 | −0.160 | −0.960 | −0.450 | 0.620 | −0.330 | 0.210 | 0.860 | −0.340 | −0.310 | −0.310 | 1.640 |
| V20 | 4.6 | 1 | 0.010 | −0.120 | −0.480 | −0.130 | 0.400 | −0.060 | −0.070 | 0.470 | −0.250 | −0.090 | 0.040 | −0.160 |
| V25 | 5.1 | 1 | −0.520 | −0.530 | 0.070 | −1.010 | −2.590 | −0.480 | −0.030 | 2.010 | −0.990 | 0.810 | 0.890 | −0.180 |
| V21 | 8.2 | 1 | 0.150 | −0.100 | 0.250 | 0.400 | −0.340 | 0.820 | 0.520 | 0.990 | −0.120 | 0.600 | −0.440 | 0.610 |
| V7 | 8.3 | 1 | −0.250 | −0.090 | 0.060 | 0.240 | −0.260 | −0.230 | 0.130 | 1.040 | 0.440 | −0.440 | −0.200 | 0.030 |
| V39 | 9.5 | 1 | −0.060 | 0.630 | 0.510 | 0.890 | 0.410 | 0.280 | 0.000 | 1.040 | 0.380 | −1.210 | 0.630 | 0.290 |
| V24 | 11.8 | 1 | −0.660 | 0.350 | 0.140 | −0.140 | −0.630 | 0.070 | −0.350 | 1.280 | 0.260 | 0.420 | 0.310 | −0.030 |
| V29 | 12.3 | 1 | 0.010 | 0.030 | 0.070 | 0.000 | 0.530 | 0.090 | 0.240 | 1.360 | −0.240 | −0.050 | 0.000 | 0.100 |
| V33 | 12.7 | 1 | 0.120 | −0.250 | 0.040 | −0.220 | 0.720 | 0.110 | −0.100 | 1.540 | −0.270 | 0.500 | −0.260 | 0.550 |
| V16 | 15.5 | 1 | −0.290 | −0.510 | 0.570 | 0.140 | −1.020 | −0.080 | −0.030 | 0.090 | 0.360 | 0.460 | 0.190 | −0.300 |
| V40 | 22.3 | 1 | −0.130 | 0.010 | 0.150 | 0.590 | 0.970 | 0.440 | −0.160 | 1.480 | 0.530 | −0.280 | −0.450 | 1.080 |
| V13 | 23.7 | 1 | −0.470 | 0.120 | 0.590 | 0.260 | 0.570 | 0.550 | 0.133 | −0.950 | −0.280 | 0.010 | 0.140 | −0.007 |
| V11 | 27.1 | 1 | 0.560 | 0.700 | 0.400 | 0.780 | 0.040 | 0.010 | 0.330 | −0.130 | 0.230 | −0.070 | 0.980 | −0.560 |
| V37 | 31.5 | 1 | −0.130 | 1.090 | 0.880 | 0.910 | 0.060 | 0.350 | 0.170 | 0.750 | −0.200 | −0.460 | −0.470 | −0.340 |
| V23 | 32.5 | 1 | −0.290 | 0.000 | 0.360 | −0.560 | −1.180 | 0.020 | 0.170 | 0.710 | −0.740 | 0.330 | 0.180 | −0.300 |
| V38 | 39.6 | 1 | 0.040 | 0.220 | 0.880 | −0.250 | −1.150 | 0.380 | 0.250 | −0.160 | −0.410 | −0.110 | 0.380 | −0.620 |
| V5 | 51.2 | 0 | −0.051 | 0.460 | 0.210 | 0.390 | 0.260 | 0.280 | 0.270 | 1.830 | 0.030 | −0.040 | −0.700 | −0.080 |
| V36 | 53.7 | 0 | 0.110 | 0.140 | −0.310 | −0.160 | 0.040 | −0.160 | −0.150 | −0.520 | −0.180 | 0.130 | 0.100 | −1.410 |
| V15 | 56.6 | 0 | −0.460 | 0.160 | 0.030 | −0.340 | 1.000 | 0.170 | 0.360 | −0.820 | −0.310 | 0.420 | 0.280 | 0.240 |
| V14 | 59.0 | 0 | 0.110 | −0.250 | −0.150 | 0.040 | 0.030 | 0.180 | 0.040 | −0.470 | −0.280 | −0.050 | 0.268 | −0.310 |
| V31 | 68.8 | 0 | −0.140 | 0.010 | 0.000 | 0.350 | 0.890 | −0.010 | 0.000 | 0.880 | −0.170 | −0.090 | −0.400 | 0.060 |
| V30 | 69.1 | 0 | −0.670 | 0.240 | 0.450 | 1.240 | 1.180 | −0.110 | −0.080 | −0.080 | −0.210 | 0.010 | −0.790 | 0.280 |
| V4 | 69.6 | 0 | 0.130 | 0.380 | 0.480 | 0.450 | 0.920 | 0.250 | 0.100 | −0.790 | 0.420 | 0.290 | −0.300 | −0.090 |
| V3 | 71.3 | 1 | −0.070 | 0.470 | −0.090 | 0.140 | −0.320 | 0.250 | 0.790 | 0.040 | 0.100 | 0.010 | −0.890 | −0.610 |
| V28 | 71.3 | 0 | −0.580 | −0.240 | −0.010 | −0.050 | 0.200 | 0.080 | −0.210 | 0.770 | 0.000 | −0.010 | 0.060 | 0.090 |
| V34 | 72.0 | 0 | −0.280 | 0.120 | 0.690 | 0.120 | −0.080 | 0.260 | 0.210 | 2.460 | 0.220 | −0.440 | 0.170 | −0.640 |
| V1 | 77.4 | 0 | −0.110 | 0.130 | −1.610 | −1.150 | 0.550 | −0.420 | 0.230 | −1.190 | −0.010 | 0.180 | −0.390 | −0.810 |
| V19 | 80.4 | 0 | 0.000 | 0.360 | 0.890 | 0.710 | 0.530 | 0.370 | 0.230 | 0.440 | 0.510 | 0.710 | −0.590 | −0.540 |
| V27 | 83.8 | 0 | −0.020 | 0.590 | 0.580 | 0.630 | 0.310 | 0.160 | −0.070 | 0.700 | −0.240 | 0.380 | 0.140 | −0.500 |
| V10 | 88.1 | 0 | 0.080 | −0.590 | −0.570 | −0.410 | −0.100 | −0.290 | −0.490 | −0.270 | −0.730 | 0.320 | −0.180 | −0.330 |
| V9 | 89.8 | 0 | 0.110 | 0.250 | 0.600 | 0.760 | −0.020 | 0.770 | 0.300 | −0.610 | 0.750 | −0.350 | −0.300 | 0.640 |
| V26 | 90.2 | 0 | −0.140 | −0.250 | 0.120 | −0.380 | −0.160 | 0.010 | −0.030 | 0.170 | −0.540 | 0.520 | 0.840 | 0.730 |
| V35 | 91.3 | 0 | −0.550 | 1.050 | 1.290 | 0.700 | 0.180 | 0.290 | 0.790 | 0.450 | −0.660 | 0.090 | −0.380 | −0.180 |
| V8 | 102.4 | 0 | 0.200 | 0.340 | 1.620 | 1.350 | 1.550 | 0.210 | 0.440 | 1.050 | 0.030 | −0.530 | −0.090 | 0.490 |
| V22 | 129.9 | 0 | −0.210 | −0.330 | 0.300 | −0.210 | −0.190 | −0.200 | −0.160 | 1.630 | −0.540 | 0.000 | 0.500 | −0.030 |

| | Survival | Out- | Gene | | | | | | | | | | | | |
|---|---|---|---|---|---|---|---|---|---|---|---|---|---|---|---|
| Patient | Time | come | X9 | X206 | X234 | X281 | X286 | X388 | X396 | X456 | X482 | X690 | X827 | X1075 | X1098 |
| V32 | 1.3 | 1 | −1.110 | −0.150 | 0.920 | 0.000 | 0.520 | −0.140 | −0.440 | 0.250 | 0.510 | −0.260 | −0.120 | 1.340 | −0.710 |
| V17 | 2.4 | 1 | −0.520 | −0.100 | 1.580 | 0.580 | 0.270 | −0.040 | −0.040 | 1.040 | 0.170 | −0.860 | 0.260 | −1.320 | 0.290 |
| V18 | 2.9 | 1 | 0.350 | 1.000 | 0.010 | 3.840 | 0.450 | 0.880 | 0.640 | 0.510 | −0.740 | −0.890 | −1.080 | −0.160 | 0.130 |
| V6 | 3.2 | 1 | 0.390 | 0.130 | −0.140 | −0.830 | −0.330 | 0.430 | −0.580 | 0.030 | 0.120 | −0.700 | −0.880 | 0.960 | 0.200 |
| V2 | 3.4 | 1 | 0.110 | 0.100 | 2.100 | 0.370 | −0.090 | 0.690 | 0.520 | 0.530 | 0.170 | 0.660 | −0.360 | 0.910 | −0.013 |
| V12 | 4.1 | 1 | −1.020 | −0.070 | 0.810 | −0.010 | 0.310 | 0.440 | 0.850 | 0.330 | −0.020 | 0.380 | 0.160 | −0.790 | −0.350 |
| V20 | 4.6 | 1 | −0.070 | 0.030 | 1.460 | 0.670 | 0.060 | 0.560 | 0.800 | 0.270 | 0.150 | −0.910 | −0.550 | −0.410 | −0.140 |
| V25 | 5.1 | 1 | 0.410 | 0.230 | 0.340 | 0.050 | −0.910 | −0.300 | −0.820 | 0.350 | −0.460 | −0.330 | −1.810 | 0.880 | −0.800 |
| V21 | 8.2 | 1 | −0.690 | −0.060 | 1.140 | 1.800 | 0.270 | −1.190 | −1.420 | 0.090 | −0.350 | −0.405 | −0.400 | −0.290 | 1.910 |
| V7 | 8.3 | 1 | −0.380 | −0.110 | 0.190 | 0.110 | 0.000 | 0.210 | −0.110 | 0.300 | −0.070 | 0.630 | 0.030 | −1.280 | −0.160 |
| V39 | 9.5 | 1 | −0.490 | 0.340 | −0.420 | 0.650 | 0.970 | 1.170 | 1.030 | 0.530 | −1.200 | 1.330 | 0.000 | −0.950 | −0.060 |
| V24 | 11.8 | 1 | 0.460 | 0.330 | 0.080 | 1.770 | 0.950 | −0.100 | −0.040 | −0.090 | −0.140 | −0.470 | −0.210 | −0.900 | −0.040 |
| V29 | 12.3 | 1 | 0.250 | 0.050 | 0.520 | −1.160 | −0.420 | 0.180 | 0.510 | 0.090 | −0.100 | 0.580 | 0.360 | −0.140 | −1.180 |
| V33 | 12.7 | 1 | −1.150 | 0.000 | 1.340 | 0.590 | 0.400 | −2.140 | −1.880 | 0.410 | 0.020 | −0.960 | −0.140 | −1.710 | −0.460 |
| V16 | 15.5 | 1 | 0.280 | −0.140 | 0.500 | −2.220 | −1.220 | −0.200 | −0.910 | −0.840 | −0.610 | −1.010 | 0.160 | 0.190 | −0.680 |
| V40 | 22.3 | 1 | 0.100 | −0.090 | 0.120 | −0.030 | −1.080 | −0.600 | −0.750 | 0.450 | −0.160 | −0.570 | 0.130 | 0.210 | −0.243 |
| V13 | 23.7 | 1 | 0.070 | 0.180 | 0.850 | 1.270 | 0.200 | 0.570 | −1.170 | −0.330 | 0.090 | −1.390 | −0.340 | −1.010 | −0.030 |
| V11 | 27.1 | 1 | −0.340 | 0.260 | −0.110 | −0.850 | −0.740 | 0.440 | −1.750 | −0.640 | 0.900 | −0.680 | −0.790 | 0.280 | −0.560 |
| V37 | 31.5 | 1 | 0.380 | 0.310 | 0.630 | 2.760 | 1.750 | 0.220 | −0.310 | 0.030 | 0.100 | −0.120 | 0.140 | −1.220 | −0.030 |
| V23 | 32.5 | 1 | 0.230 | −0.180 | −0.040 | −0.640 | −1.100 | −0.990 | −0.980 | −0.270 | −0.690 | −0.790 | −0.580 | −0.850 | −0.220 |
| V38 | 39.6 | 1 | 0.220 | 0.050 | 0.000 | −2.080 | −0.930 | 0.630 | −1.590 | −0.290 | 0.000 | −1.280 | 0.540 | 0.570 | −0.070 |
| V5 | 51.2 | 0 | 0.150 | 0.050 | −2.480 | 1.260 | 0.680 | 0.730 | 1.020 | 0.220 | 0.480 | 0.020 | 0.340 | −0.780 | −0.210 |
| V36 | 53.7 | 0 | 0.370 | 0.430 | 0.600 | 0.700 | 0.580 | 1.510 | 0.540 | 0.130 | 0.320 | 0.380 | −0.260 | −0.430 | −0.100 |
| V15 | 56.6 | 0 | 0.880 | 0.440 | −0.050 | 1.350 | 0.560 | −2.360 | −1.070 | 0.300 | −0.300 | 0.320 | 0.450 | −1.580 | −0.040 |
| V14 | 59.0 | 0 | −0.450 | −0.190 | 0.020 | 0.010 | −0.460 | −1.300 | 0.020 | 0.100 | −0.350 | 0.820 | −0.280 | −0.730 | 0.071 |
| V31 | 68.8 | 0 | −1.090 | −0.210 | 0.450 | −0.090 | 0.170 | 0.400 | 0.640 | 0.470 | −0.330 | −0.810 | 0.080 | −0.510 | −0.420 |
| V30 | 69.1 | 0 | −0.610 | −0.130 | −0.180 | 0.390 | 0.110 | 0.030 | 0.720 | 0.070 | −0.290 | 0.000 | 0.730 | −1.140 | 0.180 |
| V4 | 69.6 | 0 | 0.100 | 0.360 | −0.690 | 0.590 | −0.120 | 0.280 | −0.280 | −0.090 | 0.350 | −0.100 | −0.130 | 0.180 | −0.110 |
| V3 | 71.3 | 1 | −0.250 | 0.390 | −0.150 | −0.250 | −0.470 | −1.630 | 0.350 | 0.360 | 0.560 | 0.730 | −0.290 | −1.060 | 0.080 |
| V28 | 71.3 | 0 | −0.160 | 0.000 | 0.290 | 0.160 | 0.260 | 0.130 | 0.400 | 0.040 | −0.500 | −0.550 | 0.190 | −1.530 | −0.490 |
| V34 | 72.0 | 0 | −0.400 | −0.100 | −0.210 | 0.490 | 0.460 | 0.500 | −0.260 | −0.360 | −0.270 | −1.580 | −0.890 | −0.870 | 0.850 |
| V1 | 77.4 | 0 | 0.390 | −0.990 | −1.750 | −2.460 | −0.127 | −1.240 | −1.240 | −1.190 | 0.380 | −1.060 | 0.140 | −0.980 | 0.660 |
| V19 | 80.4 | 0 | 0.000 | 0.520 | 0.550 | −0.230 | −0.490 | 0.520 | −0.440 | −0.100 | 0.460 | 0.680 | −0.410 | 0.730 | −0.310 |
| V27 | 83.8 | 0 | −0.660 | 0.540 | 0.490 | 1.890 | 0.800 | 0.110 | 0.320 | −0.210 | −0.440 | −1.340 | −1.390 | −0.090 | −0.490 |
| V10 | 88.1 | 0 | −0.260 | −0.230 | −0.670 | −0.490 | 0.030 | 0.200 | 0.000 | 0.370 | 0.330 | 0.660 | −0.090 | 0.520 | 0.140 |
| V9 | 89.8 | 0 | 0.170 | −0.280 | 0.540 | −0.270 | −0.440 | 0.100 | −0.320 | −0.040 | 0.760 | −1.430 | −0.240 | 0.980 | −0.446 |
| V26 | 90.2 | 0 | −0.030 | −0.350 | −0.070 | −0.870 | −0.610 | −0.660 | −0.170 | −0.380 | −0.320 | −0.640 | −0.380 | −1.310 | −0.146 |
| V35 | 91.3 | 0 | 0.750 | 0.220 | −1.840 | 0.040 | 0.540 | 0.810 | 0.440 | 0.430 | 0.370 | −0.760 | −0.530 | 0.760 | −0.270 |
| V8 | 102.4 | 0 | −0.300 | 0.020 | −0.590 | 0.370 | 0.160 | −1.390 | 1.140 | 0.090 | 0.110 | 0.040 | −0.030 | 0.040 | −0.050 |
| V22 | 129.9 | 0 | −0.110 | −0.190 | 0.040 | −0.370 | −0.810 | −0.250 | 0.000 | −0.190 | −1.200 | −0.500 | −1.000 | 0.370 | −0.150 |

| | Survival | Out- | | | | | | | | | | | | |
|---|---|---|---|---|---|---|---|---|---|---|---|---|---|---|
| Patient | Time | come | X1100 | X1108 | X1130 | X1135 | X1182 | X1202 | X1245 | X1341 | X1350 | X1421 | X1441 | X1535 |
| V32 | 1.3 | 1 | −0.150 | 0.000 | −1.070 | −0.050 | 1.420 | 0.010 | −1.400 | 0.110 | 0.310 | −0.470 | 0.080 | 0.630 |
| V17 | 2.4 | 1 | −0.460 | −0.010 | 0.120 | 0.690 | 1.740 | 0.260 | −2.750 | 1.260 | 0.440 | −0.380 | 0.150 | 0.130 |
| V18 | 2.9 | 1 | −1.120 | 0.030 | −0.410 | −0.210 | 0.344 | −0.390 | −2.140 | −1.360 | 0.050 | 0.560 | 0.100 | −0.340 |
| V6 | 3.2 | 1 | 0.280 | −0.150 | 0.400 | 0.010 | −0.120 | 0.090 | −1.360 | −1.040 | 0.104 | −0.550 | 0.420 | −0.050 |
| V2 | 3.4 | 1 | 0.004 | −0.210 | −0.240 | 0.140 | 0.430 | 0.580 | 0.060 | 1.380 | 0.230 | 0.470 | −0.370 | 0.340 |
| V12 | 4.1 | 1 | −0.070 | −0.310 | −0.250 | 0.520 | 0.080 | 0.950 | −0.690 | 0.380 | −0.330 | −0.620 | 0.110 | 0.310 |
| V20 | 4.6 | 1 | −0.780 | 0.180 | 1.120 | 1.240 | 0.900 | 0.170 | 0.070 | 1.680 | 0.080 | −0.470 | −0.170 | 0.100 |
| V25 | 5.1 | 1 | 0.920 | 0.270 | 0.300 | 0.730 | 0.910 | −0.250 | −0.360 | −0.030 | 0.910 | −0.030 | −0.200 | −0.720 |
| V21 | 8.2 | 1 | −0.145 | −0.580 | −1.190 | −0.630 | −0.590 | −0.006 | −0.224 | 0.205 | 0.190 | 0.130 | −0.110 | −1.220 |
| V7 | 8.3 | 1 | −0.310 | 0.090 | 0.350 | 0.460 | 0.480 | 0.160 | 0.320 | 0.630 | −0.170 | −0.010 | 0.060 | 0.250 |
| V39 | 9.5 | 1 | −0.290 | −0.040 | 1.170 | 0.800 | −0.570 | −0.050 | −0.166 | −0.840 | −0.720 | −0.120 | −0.150 | 0.160 |
| V24 | 11.8 | 1 | 0.110 | 0.040 | 0.890 | 1.210 | −0.090 | −0.620 | 0.030 | 0.190 | 0.140 | 0.130 | −0.190 | 0.080 |
| V29 | 12.3 | 1 | −0.250 | −0.070 | −0.280 | 0.240 | 0.090 | 0.240 | 0.950 | 1.420 | 0.160 | −0.340 | 0.000 | −0.060 |
| V33 | 12.7 | 1 | 0.080 | −0.110 | −1.560 | −0.410 | 0.290 | −0.240 | −0.150 | 2.090 | 0.480 | 0.340 | −0.730 | 0.070 |
| V16 | 15.5 | 1 | −0.120 | 0.200 | −0.600 | −0.430 | 1.560 | −0.140 | −0.970 | 0.970 | 0.570 | 0.240 | −0.110 | −0.480 |
| V40 | 22.3 | 1 | −0.310 | −0.220 | 0.140 | 0.110 | 0.220 | 0.790 | −0.050 | −0.210 | −0.220 | −0.960 | 0.070 | −0.330 |
| V13 | 23.7 | 1 | 0.130 | 0.020 | 0.460 | 0.230 | 0.380 | −0.570 | −0.370 | −1.550 | 0.480 | 0.070 | 0.090 | −0.160 |
| V11 | 27.1 | 1 | −0.950 | −0.370 | −0.960 | −0.110 | 0.390 | 0.120 | −1.170 | 1.230 | 0.530 | −0.100 | −0.250 | −0.420 |
| V37 | 31.5 | 1 | −0.160 | −1.070 | −1.200 | −0.690 | −0.500 | −0.190 | 0.370 | −0.360 | 0.119 | 0.120 | −0.150 | 0.630 |
| V23 | 32.5 | 1 | 0.180 | −0.030 | 0.530 | 0.700 | −0.010 | −0.540 | 1.480 | −0.870 | 0.280 | 0.270 | −0.220 | −0.310 |
| V38 | 39.6 | 1 | 0.160 | 0.400 | 0.760 | 0.450 | 0.440 | −0.510 | 0.150 | −2.250 | 0.140 | 0.320 | −0.570 | 0.010 |
| V5 | 51.2 | 0 | −0.070 | −0.380 | −0.730 | −0.070 | −0.090 | 0.060 | 0.890 | −0.410 | 0.375 | 0.050 | −0.120 | 0.370 |
| V36 | 53.7 | 0 | −0.380 | −0.260 | 0.410 | 0.620 | −0.560 | −0.010 | −0.240 | 0.330 | 0.130 | −0.360 | 0.400 | 0.080 |
| V15 | 56.6 | 0 | 0.200 | −0.180 | −1.060 | −0.590 | −0.230 | −0.900 | −0.620 | 0.223 | −0.060 | −0.540 | 0.100 | −0.210 |
| V14 | 59.0 | 0 | 0.250 | 0.550 | −0.087 | 0.373 | 0.510 | 0.190 | 0.110 | 0.334 | −0.010 | 0.990 | 0.500 | −0.150 |
| V31 | 68.8 | 0 | 0.200 | −0.110 | −0.680 | 0.000 | 0.210 | 0.280 | −0.140 | 1.230 | 0.130 | −0.460 | −0.190 | 0.080 |
| V30 | 69.1 | 0 | 0.380 | −0.410 | 0.010 | 0.500 | 0.000 | 0.010 | 0.960 | −0.320 | −0.240 | −0.530 | 0.180 | 0.410 |
| V4 | 69.6 | 0 | −0.340 | −0.380 | −1.040 | −0.220 | −0.350 | 0.480 | 0.860 | 0.680 | 0.220 | 0.330 | −0.200 | 0.170 |
| V3 | 71.3 | 1 | −0.360 | 0.170 | −0.450 | 0.070 | −0.110 | 0.110 | −1.220 | 0.150 | 0.190 | −0.270 | 0.440 | 0.100 |
| V28 | 71.3 | 0 | 0.210 | −0.100 | 0.130 | 0.440 | 0.160 | 0.390 | 1.170 | 0.790 | 0.200 | 0.110 | −0.260 | 0.130 |
| V34 | 72.0 | 0 | 0.510 | 0.610 | −0.150 | 0.320 | 0.500 | 0.430 | 0.760 | −0.340 | 0.270 | 0.150 | −0.460 | 0.220 |
| V1 | 77.4 | 0 | 0.120 | −0.430 | −0.990 | −0.170 | 0.600 | 0.220 | −1.590 | 0.300 | −0.370 | −0.250 | −0.180 | −0.610 |
| V19 | 80.4 | 0 | −0.170 | 0.300 | −0.390 | 0.170 | 0.280 | −0.950 | −0.370 | 0.550 | 0.780 | 0.410 | −0.350 | −0.570 |
| V27 | 83.8 | 0 | 0.300 | −0.010 | −0.240 | 0.000 | −0.930 | −0.530 | −0.410 | 0.170 | 0.470 | 0.420 | 0.020 | −1.430 |
| V10 | 88.1 | 0 | −0.080 | −0.050 | 0.170 | 0.040 | 0.560 | 0.670 | −0.070 | −0.060 | −0.200 | −0.250 | 0.110 | 0.010 |
| V9 | 89.8 | 0 | 0.000 | −0.240 | −1.080 | −0.410 | 0.270 | 0.220 | 0.680 | 1.740 | 0.130 | 0.190 | −0.580 | −0.050 |
| V26 | 90.2 | 0 | −0.041 | 0.360 | 0.190 | 0.310 | 0.660 | 0.070 | 2.990 | −0.370 | 0.270 | −1.000 | 0.080 | 0.000 |
| V35 | 91.3 | 0 | −0.240 | −0.370 | −0.800 | −0.350 | 0.900 | 0.190 | 0.920 | 0.650 | 0.137 | 0.740 | 0.070 | −0.110 |
| V8 | 102.4 | 0 | −0.550 | −0.540 | 0.210 | 0.450 | −0.480 | 0.630 | 1.450 | 0.080 | −1.080 | −0.040 | −0.030 | 0.000 |
| V22 | 129.9 | 0 | 0.350 | −0.030 | −0.400 | −0.100 | 0.800 | 0.220 | 0.890 | −0.400 | 0.380 | −0.140 | −0.030 | −0.310 |

### Example 6

### Lymphoma Survival Analysis

This example uses real survival data from http://llmpp.nih.gov/lymphoma/data.shtml

The companion article is Alizadeh AA, et al. (2000) Distinct types of diffuse large B-cell lymphoma identified by gene expression profiling. Nature 403 (6769):503-11

The data is microarray data consisting of data for 4026 genes and 40 samples (individuals) with survival times and censor indicator available for each sample. The results were analysed using the algorithm, implementing a Cox's proportional hazards model.

Note that the algorithm has selected 3 genes as being associated with survival time (gene: 3797X, 3302X, 356X).

### Example 7

### Reduced Lymphoma Survival Analysis

For completeness of documentation, we also present an example based on a subset of the genes from Alizadeh et al. 50 genes were selected, including 47 chosen at random and 3 genes identified as significant in the analysis of the full data set. The data are shown in the following table 9, which gives gene expression (for the reduced set of 50 genes), and survival for each patient.

The data were analysed using the version of the algorithm containing Cox's proportional hazard survival model. After 22 iterations, five genes were selected, including 2 genes from the solution for the full set. The full results (including an iteration history) are given below:

EM Iteration: 0 expected post: 2

Number of basis functions 50

EM Iteration: 1 expected post: −56.0195287084271

Number of basis functions 50

EM Iteration: 2 expected post: −54.947811363042

Number of basis functions 37

EM Iteration: 3 expected post: −54.3317631914479

Number of basis functions 21

EM Iteration: 4 expected post: −54.0607159790051

Number of basis functions 13

EM Iteration: 5 expected post: −53.7980836894172

Number of basis functions 10 ID(s) of the variable(s) left in model 3 4 14 16 17 20 25 33 43 50 regression coefficients 1.30171200916394 1.48405810198456e-005 −0.491799506481601 0.688155245054059 5.82517870544154e-007 −1.13172255995036 2.95075622492565e-008 0.000301721699857512 −0.748378079168908 1.2775730496471

EM Iteration: 6 expected post: −53.5560385409619

Number of basis functions 8 ID(s) of the variable(s) left in model 3 4 14 16 20 33 43 50 regression coefficients 1.30877141820174 1.11497455349489e-009 −0.440934673358609 0.731610034191797 −1.15246816508172 8.10391142899109e-007 −0.736752926831824 1.29017005214433

EM Iteration: 7 expected post: −53.4357726710363

Number of basis functions 6 ID(s) of the variable(s) left in model 3 14 16 20 43 50 regression coefficients 1.30981441669383 −0.377350760745259 0.751065294832691 −1.16718699172136 −0.722720884604726 1.29171119706608

EM Iteration: 8 expected post: −53.4338660629788

Number of basis functions 6 ID(s) of the variable(s) left in model 3 14 16 20 43 50 regression coefficients 1.30685231664004 −0.29722933884524 0.758547724825121 −1.17959350866281 −0.703886124955911 1.28487528071873

EM Iteration: 9 expected post: −53.5154485460488

Number of basis functions 6 ID(s) of the variable(s) left in model 3 14 16 20 43 50 regression coefficients 1.30125961104666 −0.199901821555315 0.760639983868042 −1.19192749808285 −0.679917691918485 1.27242335041331

EM Iteration: 10 expected post: −53.6545745873571

Number of basis functions 6 ID(s) of the variable(s) left in model 3 14 16 20 43 50 regression coefficients 1.29433188361771 −0.0976106309061782 0.760491979596701 −1.20394672329711 −0.653272803573524 1.25725914248418

EM Iteration: 11 expected post: −53.820846021012

Number of basis functions 6 ID(s) of the variable(s) left in model 3 14 16 20 43 50 regression coefficients 1.28789874198243 −0.0244121499875095 0.759681966852181 −1.21216963682011 −0.630795741658714 1.24350708784212

EM Iteration: 12 expected post: −53.9601661781558

Number of basis functions 6 ID(s) of the variable(s) left in model 3 14 16 20 43 50 regression coefficients 1.28354595931721 −0.00154101225658052 0.758893058476497 −1.21415984287542 −0.618231410989467 1.2344850269793

EM Iteration: 13 expected post: −54.0328345444009

Number of basis functions 6 ID(s) of the variable(s) left in model 3 14 16 20 43 50 regression coefficients 1.2812179536199 −6.11852419349075e-006 0.75822352070402 −1.2134621579905 −0.612781276468739 1.22967591873953

EM Iteration: 14 expected post: −54.06432139112

Number of basis functions 5 ID(s) of the variable(s) left in model 3 16 20 43 50 regression coefficients 1.28009759620513 0.757715617722854 −1.21278912622521 −0.610380879961096 1.22727470412141

EM Iteration: 15 expected post: −54.0802180622945

Number of basis functions 5 ID(s) of the variable(s) left in model 3 16 20 43 50 regression coefficients 1.27956525855826 0.757384281713778 −1.21240801636852 −0.609289206977176 1.22609802569321

EM Iteration: 16 expected post: −54.0881669099217

Number of basis functions 5 ID(s) of the variable(s) left in model 3 16 20 43 50 regression coefficients 1.27931094048991 0.75718874424491 −1.21221126091477 −0.608784296852685 1.22552534756029

EM Iteration: 17 expected post: −54.0920771115648

Number of basis functions 5 ID(s) of the variable(s) left in model 3 16 20 43 50 regression coefficients 1.27918872576943 0.757080124746806 −1.21211237581804 −0.608548335650073 1.22524731506564

EM Iteration: 18 expected post: −54.0939910705254

Number of basis functions 5 ID(s) of the variable(s) left in model 3 16 20 43 50 regression coefficients 1.27912977236735 0.757022055016955 −1.2120632265046 −0.608437260261357 1.22511245075764

EM Iteration: 19 expected post: −54.0949258560397

Number of basis functions 5 ID(s) of the variable(s) left in model 3 16 20 43 50 regression coefficients 1.27910127561155 0.7569917935789 −1.2120389492013 −0.608384684306891 1.22504705594823

EM Iteration: 20 expected post: −54.0953817354683

Number of basis functions 5 ID(s) of the variable(s) left in model 3 16 20 43 50 regression coefficients 1.27908748612817 0.756976302198781 −1.21202700813484 −0.608359689289364 1.22501535228942

EM Iteration: 21 expected post: −54.0956037952427

Number of basis functions 5 ID(s) of the variable(s) left in model 3 16 20 43 50 regression coefficients 1.27908080980647 0.756968473084121 −1.21202115330035 −0.608347764395965 1.2249999841173

EM Iteration: 22 expected post: −54.0957118531261

Number of basis functions 5 ID(s) of the variable(s) left in model 3 16 20 43 50 regression coefficients 1.27907757649105 0.756964553746695 −1.21201828961347 −0.608342058719735 1.2249925351853

### Example 8

### Survival Analysis with a Parametric Hazard

The data is 1694w.dat from http://www.wpi.edu/˜mhchen/survbook/. This is data on survival of melanoma. There are n=255 individuals, 100 of whom have censored survival times. Each individual has four covariates, namely treatment, thickness, age and sex. To illustrate the methodology we added 4000 dummy genes to this data set to give a data matrix with 4004 columns and 255 rows. By design the 4000 “genes” are not associated with survival time. Algorithmically, the challenge is to identify the important variables from 4004 potential predictors, most of which carry no information. The data were analysed using a parameteric Weibull model for the hazard function.

The algorithm selected only on variable: age. All of the pseudo gene variables were discarded rapidly. The Weibull shape parameter was estimates as 0.68.

### Example 9

### Ordered Categorical Analysis for Prostate Cancer

The example is from Dhanasekaran et al 2001. See also http://www.nature.com/cgi-taf/DynaPage.taf?file=/nature/journal/v412/n6849/full/412 822a0_fs.html

and the Supplementary files at

http://www.nature.com/nature/journal/v412/n6849/extref/412822aa.html

There are 15 samples (individuals) with 9605 genes. Missing values were replaced by row means+column means minus the grand mean. There were four ordered categories (G=4) namely
1. NAP normal
2. BPH benign
3. PCA localised
4. MET metastasised

The algorithm found 1 gene (gene number 6611, their accession ID R31679) which could correctly classify all the individuals apart from 1 misclassification.

The iterations from the EM algorithm are as follows:

Iteration 1: 10 cycles, criterion −6.346001 misclassification matrix fhat

$$\begin{matrix}f & & 1 & 2 \\ & 1 & 23 & 0 \\ & 2 & 0 & 22\end{matrix}$$

row=true class

Class 1 Number of basis functions in model : 9608

Iteration 2: 5 cycles, criterion −13.21228 misclassification matrix fhat

$$\begin{matrix}f & & 1 & 2 \\ & 1 & 22 & 1 \\ & 2 & 1 & 21\end{matrix}$$

row=true class

Class 1 Number of basis functions in model : 6127

Iteration 3: 4 cycles, criterion −14.11706 misclassification matrix fhat

$$\begin{matrix}f & & 1 & 2 \\ & 1 & 22 & 1 \\ & 2 & 2 & 20\end{matrix}$$

row=true class

Class 1 Number of basis functions in model : 359

Iteration 4: 4 cycles, criterion −12.14269 misclassification matrix fhat

$$\begin{matrix}f & & 1 & 2 \\ & 1 & 23 & 0 \\ & 2 & 2 & 20\end{matrix}$$

row=true class

Class 1 Number of basis functions in model 44

Iteration 5: 5 cycles, criterion −9.134629 misclassification matrix fhat

$$\begin{matrix}f & & 1 & 2 \\ & 1 & 23 & 0 \\ & 2 & 1 & 21\end{matrix}$$

row=true class

Class 1 Number of basis functions in model: 18

Iteration 6: 5 cycles, criterion −6.549706 misclassification matrix fhat

$$\begin{matrix}f & & 1 & 2 \\ & 1 & 23 & 0 \\ & 2 & 1 & 21\end{matrix}$$

row=true class

Class 1 Number of basis functions in model

Iteration 7: 5 cycles, criterion −4.988667 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 408 6614 7191 8077 regression coefficients 16.0404 8.799716 4.196934 −0.004482982 −9.059594 0.01061934 −1.245061e-09

Iteration 8: 5 cycles, criterion −4.278911 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 408 6614 7191 regression coefficients 20.00335 10.90405 5.268265 −1.996441e-05 −11.30149 0.001403909

Iteration 9: 4 cycles, criterion −3.980305 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 408 6614 7191 regression coefficients 22.18902 12.03594 5.834313 −3.711782e-10 −12.53288 2.460434e-05

Iteration 10: 4 cycles, criterion −3.860487 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 7191 regression coefficients 23.18785 12.54724 6.089298 −13.09617 7.553351e-09

Iteration 11: 4 cycles, criterion −3.813712 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 regression coefficients 23.60507 12.76061 6.1956 −13.33150

Iteration 12: 3 cycles, criterion −3.795452 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 regression coefficients 23.7726 12.84627 6.238258 −13.42600

Iteration 13: 3 cycles, criterion −3.788319 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 regression coefficients 23.83879 12.88010 6.255108 −13.46334

Iteration 14: 3 cycles, criterion −3.785531 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 regression coefficients 23.86477 12.89339 6.261721 −13.47800

Iteration 15: 3 cycles, criterion −3.784442 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 regression coefficients 23.87494 12.89859 6.26431 −13.48373

Iteration 16: 2 cycles, criterion −3.784016 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 regression coefficients 23.87892 12.90062 6.265323 −13.48598

Iteration 17: 2 cycles, criterion −3.783849 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 regression coefficients 23.88047 12.90142 6.265719 −13.48686

Iteration 18: 2 cycles, criterion −3.783784 misclassification matrix fhat

$$\begin{matrix}f & & 1 & 2 \\ & 1 & 23 & 0 \\ & 2 & 1 & 21\end{matrix}$$

row=true class

Class 1: Variables left in model 1 2 3 6614 regression coefficients 23.88108 12.90173 6.265874 −13.48720

Final misclassification table

pred

| y | 1 | 2 | 3 | 4 |
|---|---|---|---|---|
| 1 | 4 | 0 | 0 | 0 |
| 2 | 0 | 2 | 1 | 0 |
| 3 | 0 | 0 | 4 | 0 |
| 4 | 0 | 0 | 0 | 4 |

Identifiers of variables left in ordered categories model 6611

Estimated theta 23.881082 12.901727 6.265874

Estimated beta −13.48720

A plot of the fitted probabilities is given in FIG. 6 below. The lines denote classes as follows: dashed line=class 1, solid line=class 2, dotted line=class 3, dotted and dashed line=class 4. Observations (index) 1 to 3 were in class 2, 4 to 7 were in class 1, 8-11 were in class 3 and 12 to 15 were in class 4.

### Example 10

### Ordered Categorical Analysis for Prostate Cancer—Selected Genes

This example is identical to that of Example 9, with the exception that the data set has been reduced to 50 selected genes. One of these genes is the gene found significant in example 9, the others were selected at random. The purpose of this example is to provide an illustration based on a completely tabulated data set (Table 10).

Missing values were replaced by row means+column means minus the grand mean. There were four ordered categories (G=4) namely
1. NAP normal
2. BPH benign
3. PCA localized
4. MET metastasised

The algorithm found one predictive gene (gene 1 of table 10), which was equivalent to gene 6611 (Accession R31679) of Example 9. The prediction success was, of course, identical to that of example 9 (since it was based upon the same single gene).

TABLE 10
Disease Stage and Gene Expression for Selected Genes

| | Disease Stage | | | | | | | | | | | | | | |
|---|---|---|---|---|---|---|---|---|---|---|---|---|---|---|---|
| Gene | 2 | 2 | 2 | 1 | 1 | 1 | 1 | 3 | 3 | 3 | 3 | 4 | 4 | 4 | 4 |
| 1 | 1.6520 | 1.1480 | 0.8600 | 2.2490 | 3.0190 | 4.0320 | 1.8900 | 0.9430 | 0.8890 | 0.7960 | 0.6340 | 0.1040 | 0.2040 | 0.2740 | 0.0830 |
| 2 | 1.0464 | 1.7040 | 1.0655 | 1.0860 | 1.0133 | 1.0509 | 1.0006 | 1.0568 | 1.0286 | 1.1060 | 0.9700 | 1.1016 | 0.6020 | 0.8080 | 1.0843 |
| 3 | 1.2402 | 1.2304 | 1.2594 | 0.9830 | 1.0700 | 1.2447 | 1.1945 | 1.2507 | 1.2225 | 0.4030 | 1.2067 | 1.2954 | 1.6620 | 1.8870 | 1.4340 |
| 4 | 0.4990 | 0.7100 | 0.7230 | 0.6700 | 0.7190 | 0.5520 | 0.9630 | 1.6230 | 1.0120 | 0.8945 | 1.2380 | 0.6350 | 0.8170 | 0.7040 | 1.4860 |
| 5 | 1.4324 | 1.1230 | 1.4516 | 1.1350 | 1.5340 | 1.3290 | 1.3867 | 2.3590 | 1.6770 | 1.2430 | 1.2450 | 1.4620 | 1.3950 | 1.3510 | 1.3320 |
| 6 | 0.9800 | 0.9580 | 1.0100 | 1.1800 | 1.0360 | 1.0610 | 1.3030 | 0.6610 | 0.9913 | 1.0209 | 1.1540 | 1.0643 | 0.7440 | 1.0190 | 1.0470 |
| 7 | 1.7784 | 1.9060 | 1.7976 | 0.8400 | 1.0520 | 1.4500 | 1.0560 | 4.7570 | 2.0600 | 1.2960 | 1.0810 | 1.4070 | 1.4900 | 1.7884 | 2.9420 |
| 8 | 0.8440 | 1.0800 | 1.1070 | 0.6570 | 1.0240 | 0.7510 | 1.1790 | 1.1830 | 1.0329 | 1.3040 | 1.1200 | 0.8010 | 1.3110 | 0.9640 | 1.3790 |
| 9 | 1.3625 | 1.6750 | 1.4220 | 0.9400 | 0.9850 | 1.8830 | 1.3168 | 1.3730 | 1.3448 | 1.3744 | 1.3290 | 1.4177 | 1.5270 | 1.3724 | 1.1030 |
| 10 | 0.7741 | 0.7850 | 0.5550 | 0.8690 | 0.6110 | 0.5410 | 0.7530 | 0.8450 | 0.9940 | 0.9300 | 0.9460 | 0.5990 | 0.7190 | 0.7030 | 0.9920 |
| 11 | 1.1284 | 1.1185 | 1.1475 | 1.0953 | 1.0953 | 1.1329 | 1.0826 | 1.1388 | 1.1106 | 1.1402 | 1.0949 | 1.1836 | 1.1541 | 1.1383 | 1.1280 |
| 12 | 0.8580 | 1.1825 | 1.0500 | 1.4560 | 1.0630 | 0.8470 | 1.0810 | 2.8890 | 1.1550 | 1.2042 | 1.0490 | 1.0310 | 0.9940 | 1.2023 | 0.8310 |
| 13 | 0.9030 | 0.9600 | 0.7650 | 1.2030 | 0.9290 | 1.2830 | 0.9800 | 0.9923 | 1.0480 | 0.8100 | 1.0060 | 0.9370 | 0.9120 | 0.9870 | 1.0170 |
| 14 | 1.7000 | 2.0640 | 1.9900 | 2.1290 | 1.8380 | 1.9030 | 1.6590 | 1.8620 | 1.5200 | 2.0130 | 1.2440 | 1.2500 | 0.9360 | 2.2600 | 0.8790 |
| 15 | 0.8690 | 0.7930 | 0.8210 | 1.0060 | 0.8310 | 0.8410 | 0.8250 | 0.8290 | 0.8643 | 0.9080 | 0.8250 | 0.9373 | 0.7280 | 0.8920 | 1.3040 |
| 16 | 0.9720 | 1.0620 | 1.1040 | 0.8750 | 1.0280 | 0.9890 | 0.9260 | 0.8670 | 1.1260 | 1.2760 | 0.9860 | 0.8640 | 1.3490 | 1.5980 | 1.5790 |
| 17 | 0.9820 | 1.8410 | 1.0790 | 2.4510 | 0.9130 | 1.5380 | 0.9790 | 0.8130 | 0.8750 | 1.1919 | 1.1465 | 0.9150 | 1.2058 | 1.1899 | 0.5900 |
| 18 | 0.5040 | 0.7860 | 0.6460 | 0.7280 | 0.8910 | 0.6320 | 0.8390 | 0.4910 | 1.0340 | 0.6880 | 0.6200 | 0.3890 | 0.4400 | 0.6110 | 0.4640 |
| 19 | 1.1427 | 1.2020 | 1.3440 | 1.0730 | 1.1840 | 1.1472 | 1.0970 | 1.1532 | 1.1250 | 1.1546 | 1.1092 | 1.1979 | 1.1685 | 1.1160 | 0.9350 |
| 20 | 1.2235 | 1.2136 | 0.5470 | 1.1904 | 0.5230 | 0.5400 | 1.0620 | 1.2339 | 1.2057 | 0.6590 | 0.6020 | 5.0830 | 0.8880 | 1.2820 | 1.0450 |
| 21 | 0.4920 | 0.7360 | 0.6500 | 0.6520 | 0.5910 | 0.5610 | 0.7050 | 0.6170 | 0.6860 | 0.7080 | 0.7410 | 0.5170 | 0.9250 | 1.0530 | 1.6110 |
| 22 | 1.0880 | 0.7180 | 0.8170 | 0.9870 | 0.6760 | 1.2960 | 0.7440 | 0.5040 | 0.7100 | 0.5290 | 0.6840 | 0.5970 | 0.4910 | 0.5040 | 0.4740 |
| 23 | 0.8035 | 0.6580 | 0.8226 | 0.7705 | 0.5800 | 0.7730 | 0.7578 | 0.8140 | 0.7858 | 0.6750 | 0.7770 | 0.8587 | 0.8430 | 0.9720 | 1.1470 |
| 24 | 2.1321 | 2.4360 | 2.7240 | 1.6260 | 2.2290 | 2.7950 | 2.0864 | 2.7400 | 2.2740 | 2.1490 | 1.3600 | 3.0110 | 1.4560 | 1.0680 | 1.8450 |
| 25 | 0.8875 | 0.7710 | 0.8860 | 0.7840 | 0.9430 | 0.7260 | 0.9860 | 0.8980 | 0.8698 | 0.9440 | 0.7230 | 0.9428 | 1.1010 | 0.8320 | 1.0630 |
| 26 | 1.0330 | 1.0140 | 1.0050 | 1.0330 | 0.9580 | 1.1380 | 0.8830 | 0.7020 | 0.8170 | 0.8365 | 0.7400 | 0.6160 | 0.4830 | 0.5420 | 0.5750 |
| 27 | 0.8324 | 0.8225 | 0.8515 | 0.7993 | 0.7993 | 0.8369 | 0.8470 | 0.8428 | 0.8146 | 0.2880 | 0.7989 | 0.8876 | 0.8581 | 1.3610 | 0.8703 |
| 28 | 0.6400 | 0.8610 | 0.7840 | 0.9300 | 0.7740 | 0.7460 | 0.8090 | 0.8980 | 0.9080 | 0.7800 | 0.8180 | 1.3400 | 0.9380 | 0.8500 | 0.9690 |
| 29 | 1.1340 | 0.8940 | 0.9030 | 0.9320 | 0.9130 | 0.9630 | 0.9370 | 1.0760 | 1.0020 | 0.7160 | 0.9970 | 0.8790 | 0.8980 | 0.9820 | 1.4650 |
| 30 | 0.7230 | 0.6410 | 0.4990 | 0.7190 | 0.6390 | 0.5680 | 0.6970 | 0.7320 | 0.6130 | 0.5620 | 0.8380 | 0.7782 | 0.7340 | 0.9250 | 1.2270 |
| 31 | 1.6570 | 1.0600 | 1.4730 | 1.1390 | 1.3130 | 1.2250 | 1.0770 | 0.7370 | 0.8930 | 0.9840 | 0.8300 | 1.1270 | 0.6860 | 0.9930 | 0.5080 |
| 32 | 0.5460 | 0.5370 | 0.4830 | 0.8570 | 0.5820 | 0.5560 | 0.7520 | 0.6900 | 0.8480 | 0.7360 | 0.6210 | 0.6410 | 0.7410 | 0.6990 | 1.2750 |
| 33 | 0.8792 | 0.6450 | 0.5600 | 0.9270 | 0.7950 | 1.1120 | 0.8335 | 0.8897 | 0.8615 | 0.8911 | 0.8070 | 0.9345 | 0.9170 | 1.1900 | 0.9570 |
| 34 | 0.8244 | 0.6000 | 1.1050 | 0.9200 | 0.9440 | 0.8289 | 0.9430 | 0.8020 | 0.8067 | 0.7580 | 0.6690 | 0.8797 | 0.9030 | 0.5890 | 0.8320 |
| 35 | 0.9160 | 0.7790 | 0.7770 | 1.2340 | 0.7430 | 1.1970 | 0.7860 | 0.6580 | 0.8250 | 0.3920 | 0.5450 | 0.8440 | 0.5240 | 0.6310 | 0.7320 |
| 36 | 0.8912 | 0.5390 | 0.7970 | 1.1880 | 0.6820 | 0.7010 | 0.8760 | 0.9970 | 0.8000 | 0.9060 | 0.8980 | 1.1740 | 1.0260 | 0.7550 | 1.1330 |
| 37 | 1.1840 | 1.2700 | 1.4890 | 0.8670 | 1.2400 | 1.2230 | 1.0870 | 1.2670 | 1.3870 | 1.9100 | 1.2300 | 1.2190 | 1.2703 | 0.8150 | 1.2300 |
| 38 | 1.1304 | 1.1205 | 1.1495 | 1.0973 | 1.0973 | 1.5090 | 0.6400 | 1.1408 | 1.1126 | 1.1422 | 1.0969 | 1.1856 | 1.1561 | 1.1403 | 1.2410 |
| 39 | 1.4857 | 2.0350 | 1.5048 | 1.1970 | 1.9620 | 1.5820 | 1.7220 | 1.9630 | 1.4430 | 1.8120 | 1.9020 | 1.2850 | 0.8840 | 0.9620 | 0.5600 |
| 40 | 1.9650 | 1.6730 | 1.7710 | 1.4780 | 1.3830 | 1.7990 | 1.0340 | 0.7250 | 0.7970 | 0.7560 | 1.0390 | 0.4410 | 0.4940 | 0.7770 | 0.4780 |
| 41 | 0.8110 | 0.9690 | 1.0640 | 1.0330 | 0.7280 | 0.7810 | 0.8790 | 0.9281 | 0.7830 | 0.9610 | 1.1140 | 1.2200 | 0.7270 | 0.9320 | 0.8390 |
| 42 | 1.5686 | 2.6710 | 2.6750 | 1.3670 | 1.2040 | 1.7650 | 1.4580 | 1.5791 | 1.0230 | 1.5810 | 2.0400 | 1.8630 | 1.0030 | 1.1640 | 0.5730 |
| 43 | 0.9814 | 0.9715 | 1.0005 | 0.9483 | 0.9483 | 0.9859 | 0.9810 | 0.9918 | 0.9636 | 0.9932 | 0.9479 | 1.0366 | 1.0071 | 0.9913 | 1.0193 |
| 44 | 1.1596 | 1.7120 | 1.1760 | 1.1980 | 1.3410 | 1.0080 | 1.1139 | 1.2340 | 1.1419 | 1.1715 | 1.1262 | 0.8310 | 1.1854 | 1.1695 | 0.7740 |
| 45 | 0.9870 | 1.1340 | 1.2600 | 0.8850 | 1.0880 | 0.8450 | 1.0060 | 0.9790 | 1.0850 | 1.1040 | 1.2680 | 2.4300 | 0.9370 | 0.8080 | 0.9910 |
| 46 | 1.1520 | 1.0002 | 0.9720 | 0.7860 | 1.1950 | 0.9610 | 1.0550 | 0.9800 | 0.9923 | 0.8080 | 1.0300 | 1.0653 | 1.0410 | 1.2110 | 0.9250 |
| 47 | 0.9300 | 0.9154 | 0.8450 | 0.5610 | 0.8790 | 0.7310 | 0.8796 | 0.7120 | 0.9076 | 1.0470 | 0.9990 | 0.9805 | 0.9450 | 1.2500 | 1.2750 |
| 48 | 0.5700 | 0.7360 | 0.5800 | 0.7800 | 0.5720 | 0.8418 | 0.6720 | 0.6990 | 0.8196 | 0.8960 | 0.8450 | 0.8570 | 1.2200 | 1.2220 | 1.2310 |
| 49 | 1.4900 | 1.3340 | 0.9800 | 1.1665 | 1.0320 | 1.2690 | 1.1310 | 1.2100 | 1.1818 | 1.2114 | 1.0980 | 1.3380 | 1.3520 | 1.1020 | 1.0650 |
| 50 | 1.4590 | 1.2200 | 1.4490 | 1.7810 | 1.7520 | 1.3200 | 1.2210 | 1.0720 | 1.1140 | 1.4820 | 1.1160 | 0.5410 | 0.4620 | 0.4840 | 0.4910 |

### Example 11

### Apparatus for Use of the Method

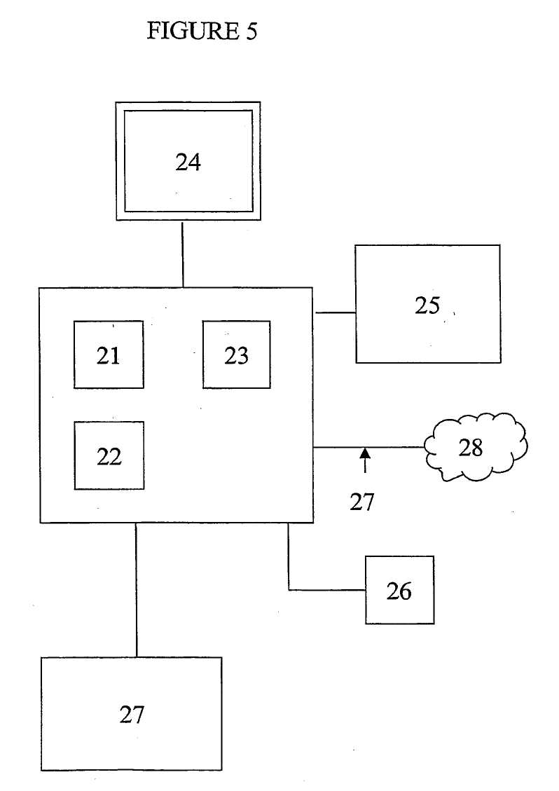

Referring to FIG. 5, a personal computer 20 suitable for implementing methods according to embodiments of the present invention is shown. Computer 20 operates under the instruction of a software program stored on hard disk data storage device 21. Computer 20 further includes a processor 22, memory 23, display screen 24, printer 25 and input devices mouse 26 and keyboard 27. The computer may have communication means such as a network connection 27 to the internet 28 or data collecting means 28 to facilitate downloading or collection and sharing of data.

The data collection means collects or downloads data from a system. The computer includes a manipulation means embodied in software which communicates with mouse 26 and keyboard 27 to allow a user to implement the method according to the embodiments of the invention on the data. The systems includes a means embodied in the software to implement the method according to the embodiments of the present invention, and means to create a graphic. After the method has been implemented, the output may be illustrated graphically on display screen 24 and/or printed on printer 25.

In the above examples, implementation of the invention has been described in relation to a biological system. As discussed previously, the invention may be applied to any “system” requiring features of samples to be predicted. Examples of systems include chemical systems, agricultural systems, weather systems, financial systems including, for example, credit risk assessment systems, insurance systems, marketing systems or company record systems, electronic systems, physical systems, astrophysics systems and mechanical systems.

Modifications and variations as would be apparent to a skilled addressee are deemed to be within the scope of the present invention.

### REFERENCES

Aitkin, M. and Clayton, C. (1980), The Fitting of Exponential, Weibull and Extreme Value Distributions to Complex Censored Survival Data using GLIM. Applied Statistics, 29: 156-163.

Breslow, N. (1972), Contribution to the discussion of a paper by D. R. Cox. JRSS (B), 34: 216-217.

Cox, D. R. (1972), Regression Models and Life-tables (with discussion) JRSS (B), 34: 187-220.

Cox, D. R., and Oakes, D. (1984), Analysis of Survival Data. Chapman & Hall, London.

Dhanasekaran, S. M., Barrette, T. R., Ghosh, D., Shah, R Varambally, S., Kurachi, K., Pienta, K. J., Rubin, M. A., and Chinnaiyan , A. M. (2001) Delineation of prognostic biomarkers in prostate cancer. Nature 412, 822-826.

De Boor, C. (1978), A practical guide to splines. New York: Springer-Verlag.

Dempster, A. P., Laird, N. M., and Rubin, D. B. (1977) Maximum likelihood from incomplete data via the EM algorithm. Journal of the Royal Statistical Society, B, 39: 1-21.

Efron, B. (1977), The efficiency of Cox's likelihood function for censored data. JASA, 72: 557-565.

Evgeniou, T., Pontil, M., and Poggio, T,. (1999). A unified framework for regularization networks and support vector machines. MIT AI memo 1654.

Figueiredo, M. A. T (2001) Unsupervised sparse regression. Seminar presentation available at: http://www.msri.org/publications/ln/msri/2001/nle/figueire do/1/index.html

Kotz, S., and Johnson, N. L., (1983) Encyclopedia of Statistical Sciences, Volume 4, pp 639.

McCullagh, P., & Nelder, J. A. (1989). Generalized Linear Models, 2nd Edition, Chapman & Hall.

McCullagh, P., (1980). Regression models for ordinal data. Journal of the Royal Statistical Society B, 2, 109-142.

Nelder, J. A. and Wedderburn, R. W. M. (1972) Generalised linear models. Journal of the Royal Statistical Society A, 135, 370-384.

Oakes, D. (1977), The asymptotic information in censored survival data. Biometrika, JRSS (B), 64: 441-448.

Payne, C. D., (1985) The GLIM System manual, release 3.77. NAG algorithms group.

Wedderburn, R. W. M,. (1974) Quasi-likelihood functions, generalised linear models, and the Gauss-Newton method. Biometrika, 64, 439-447.

1. A method for identifying a subset of components of a system, the subset being capable of predicting a feature of a test sample, the method comprising the steps of;
(a) generating a linear combination of components and component weights in which values for each component are introduced from data generated from a plurality of training samples, each training sample having a known feature;
(b) defining a model for the probability distribution of a feature wherein the model is conditional on the linear combination and wherein the model is not a combination of a binomial distribution for a two class response with a probit function linking the linear combination and the expectation of the response;
(c) constructing a prior distribution for the component weights of the linear combination comprising a hyperprior having a high probability density close to zero;
(d) combining the prior distribution and the model to generate a posterior distribution;
(e) identifying a subset of components having component weights that maximise the posterior distribution.

2. The method of claim 1 wherein the model is a likelihood function based on a model selected from the group comprising a multinomial or binomial logistic regression, generalised linear model, Cox's proportional hazards model and parametric survival model.

3. The method of claim 1 wherein the model is a likelihood function based on a multinomial or binomial logistic regression.

4. The method of claim 2 wherein the logistic regression models a feature having a multinomial or binomial distribution.

5. The method of claim 1 wherein the subset of components is capable of classifying a sample into one of a plurality of pre-defined groups by defining a logistic regression which comprises grouping the samples into a plurality of sample groups, each sample group having a common group identifier.

6. The method of claim 1 wherein the logistic regression is of the form:
$$L = {\prod }_{i = 1}^{n} ( {\prod }_{g = 1}^{G - 1} {\{ \frac{{ⅇ}^{{x}_{i}^{T} {β}_{g}}}{( 1 + {\sum }_{g = 1}^{G - 1} {ⅇ}^{{x}_{i}^{T} {β}_{g}} )} \}}^{{e}_{ig}} {\{ \frac{1}{1 + {\sum }_{h = 1}^{G - 1} {ⅇ}^{{x}_{i}^{T} {β}_{h}}} \}}^{{e}_{iG}} )$$
wherein
xᵢ^{T}β_{g} is a linear combination generated from input data from training sample i with component weights β_{g};
x_{hu T} or is the components for the i^{th} Row of X and β_{g} is a set of component weights for sample class g;
e_{ig}=1 if training sample i is a member of class g, e_{ig}=0 otherwise; and
X is data from n training samples comprising p components.

7. The method of claim 1 wherein the subset of components is capable of classifying a sample into a class wherein the class is one of a plurality of predefined ordered classes, by defining a logistic regression which comprises defining a series of group identifiers in which each group identifier corresponds to a member of an ordered class, and grouping the samples into one of the ordered classes.

8. The method of claim 7 wherein the logistic regression is of the form:
$$L = {\prod }_{i = 1}^{N} {\prod }_{k = 1}^{G - 1} {( \frac{{γ}_{ik}}{{γ}_{ik + 1}} )}^{{r}_{ik}} {( \frac{{γ}_{ik + 1} - {γ}_{ik}}{{γ}_{ik + 1}} )}^{{r}_{ik + 1} - {r}_{ik}}$$
$$log it ( \frac{{γ}_{ik + 1} - {γ}_{ik}}{{γ}_{ik + 1}} ) = log it ( \frac{{π}_{ik}}{{γ}_{ik + 1}} ) = {θ}_{k} + {x}_{i}^{T} {β}^{*}$$
wherein
γᵢₖ is the probability that training sample i belongs to a class with identifier less than or equal to k (where the total of ordered classes is G);
xᵢ^{T}β* is a linear combination generated from input data from training sample i with component weights β*;
X is data from n training samples comprising p components;
xᵢ^{T} is the components for the i^{th} Row of X;
rᵢⱼ is as defined as
$${r}_{ij} = {\sum }_{g = 1}^{j} {c}_{ig}$$
$$where$$
$${c}_{ij} = \{ \begin{matrix}1 , if observation i in class j \\ 0 , otherwise\end{matrix}$$

9. The method of claim 1 wherein the model is a likelihood function is based on a generalised linear model.

10. The method of claim 9 wherein the generalised linear model models a feature that is distributed as a regular exponential family of distributions.

11. The method of claim 10 wherein the regular exponential family of distributions is selected from the group consisting of normal distribution, Gaussian distribution, Poisson distribution, exponential distribution, gamma distribution, Chi Square distribution and inverse gamma distribution.

12. The method of claim 1 or wherein the subset of components is capable of predicting a predefined characteristic of a sample by defining a generalised linear model which comprises modelling the characteristic to be predicted.

13. The method of claims 9 wherein the generalised linear model is of the form:
$$log p ( y \vert β , ψ ) = {\sum }_{i = 1}^{N} \{ \frac{{y}_{i} {θ}_{i} - b ( {θ}_{i} )}{{a}_{i} ( ψ )} + c ( {y}_{i} , ψ ) \}$$
wherein
y=(y₁, . . . , yₙ)^{T}, and yᵢ is the characteristic measured on the i^{th} sample;
aᵢ(φ)=φ/wᵢ with the wᵢ being a fixed set of known weights and φ a single scale parameter;
the functions b(.) and c(.) are as defined by Nelder and Wedderburn (1972);
E{yᵢ}=b′(θᵢ)
Var{y}=b″(θᵢ)aᵢ(φ)=τᵢ²aᵢ(φ);
and wherein each observation has a set of covariates xᵢ and a linear predictor ηᵢ=xᵢ^{T} β.

14. The method of claim 1 wherein the model is a likelihood function based on a model selected from the group consisting of Cox's proportional hazards model, parametric survival model and accelerated survival times model.

15. The method of claim 1 wherein the subset of components is capable of predicting the time to an event for a sample by defining a likelihood based on Cox's proportional standards model, a parametric survival model or an accelerated survival times model, which comprises measuring the time elapsed for a plurality of samples from the time the sample is obtained to the time of the event.

16. The method of claim 14 wherein Cox's proportional hazards model is of the form:
$$L ( {t}_{\sim} \vert {β}_{\sim} ) = {\prod }_{j = 1}^{N} {( \frac{exp ( {Z}_{j} {β}_{\sim} )}{{\sum }_{{iεℜ}_{j}} exp ( {Z}_{i} {β}_{\sim} )} )}^{{d}_{j}}$$
wherein
X is data from n training samples comprising p components;
Z is a matrix that, is the re-arrangement of the rows of X where the ordering of the rows of Z corresponds to the ordering induced by the ordering of the survival times;
d is the result of ordering the censoring index with the same permutation required to order survival times;
Zⱼ is the j^{th} row of the matrix Z and dⱼ is the j^{th} element of d;
{tilde under (β)}^{T}=(β₁,β₂, . . . ,βₚ); [symbol]
ⱼ={i:i=j,j+1, . . . ,N}=the risk set at the j^{th} ordered event time t₍ⱼ₎.

17. The method of claim 14 wherein the parametric hazards model is of the form:
$$log ( L ) = {\sum }_{i = 1}^{N} \{ {c}_{i} log ( {μ}_{i} ) - {μ}_{i} + {c}_{i} ( log ( \frac{λ ( {y}_{i} )}{Λ ( {y}_{i} ; {ψ}_{\sim} )} ) ) \}$$
where
μᵢ=Λ(yᵢ;{tilde under (φ)})exp(Xᵢ{tilde under (β)});
cᵢ=1 if the i^{th} sample is uncensored and cᵢ=0 if the i^{th} sample is uncensored;
the functions λ(.) and Λ(.) are as defined by Aitkin and Clayton (1980);
Xᵢ is the i^{th} row of X and X is data from n training samples comprising p components.

18. The method of claim 1 wherein the prior distribution is of the form:
$$p ( β ) = {\int }_{{v}^{2}}^{} p ( β \vert {v}^{2} ) p ( {v}^{2} ) ⅆ {v}^{2}$$
where p(β|v²) is N(0,diag{v²});
v is a hyper parameter;
p(v²) is a hyperprior distribution.

19. The method of claim 1 wherein the hyperprior is a Jeffreys prior of the form:
$$p ( {v}^{2} ) α {\prod }_{i = 1}^{n} 1 / {v}^{2}$$

20. The method of claim 1 wherein posterior distribution is of the form:
p(βφv|y)αL(y|βφ)p(β|v²)p(v²)
wherein L({tilde under (y)}|{tilde under (β)},{tilde under (φ)}) is the likelihood function.

21. The method of claim 1 wherein the posterior distribution is maximised using an iterative procedure.

22. The method of claim 21 wherein the iterative procedure is an EM algorithm.

23. The method of claim 1 wherein the system is a biological system.

24. The method of claim 23 wherein the biological system is a biotechnology array.

25. The method of claim 24 wherein the biotechnology array is selected from the group consisting of DNA array, protein array, antibody array, RNA array, carbohydrate array, chemical array, lipid array.

26. A method for identifying a subset of components of a subject which are capable of classifying the subject into one of a plurality of predefined groups wherein each group is defined by a response to a test treatment comprising the steps of:
(d) exposing a plurality of subjects to the test treatment and grouping the subjects into response groups based on responses to the treatment;
(e) measuring components of the subjects;
(f) identifying a subset of components that is capable of classifying the subjects into response groups using the methods according to claim 1.

27. The method of claim 26 wherein the components are selected from the group consisting of genes, small nucleotide polymorphisms (SNPs), proteins, antibodies, carbohydrates, lipids.

28. An apparatus for identifying a subset of components of a system from data generated from the system from a plurality of samples from the system, the subset being capable of predicting a feature of a test sample, the apparatus comprising:
(a) means for generating a linear combination of components and component weights in which values for each component are introduced from data generated from a plurality of training samples, each training sample having a known feature;
(b) means for defining a model for the probability distribution of a feature wherein the model is conditional on the linear combination and wherein the model is not a combination of a binomial distribution for a two class response with a probit function linking the linear combination and the expectation of the response;
(c) means for constructing a prior distribution for the component weights of the linear combination comprising a hyperprior having a high probability density close to zero;
(d) means for combining the prior distribution and the model to generate a posterior distribution;
(e) means for identifying a subset of components having component weights that maximise the posterior distribution.

29. A computer program arranged, when loaded onto a computing apparatus, to control the computing apparatus to implement a method in accordance with claim 1.

30. The computer program of claim 29 implemented with the method of claim 1.

31. A computer readable medium providing a computer program in accordance with claim 29.

32. A method of testing a sample from a system to identify a feature of the sample, the method comprising the steps of testing for a subset of components which is diagnostic of the feature, the subset of components having been determined by a method in accordance with claim 1.

33. An apparatus for testing a sample from a system to determine a feature of the sample, the apparatus including means for testing for components identified in accordance with the method of claim 1.

34. A computer program which when run on a computing device, is arranged to control the computing device, in a method of identifying components from a system which are capable of predicting a feature of a test sample from the system, and wherein a linear combination of components and component weights is generated from data generated from a plurality of training samples, each training sample having a known feature, and a posterior distribution is generated by combining a prior distribution for the component weights comprising a hyperprior having a high probability distribution close to zero, and a model that is conditional on the linear combination wherein the model is not a combination of a binomial distribution for a two class response with a probit function linking the linear combination and the expectation of the response, to estimate component weights which maximise the posterior distribution.

35. A method for identifying a subset of components of a biological system, the subset being capable of predicting a feature of a test sample from the biological system, the method comprising the steps of:
(a) generating a linear combination of components and component weights in which values for each component are determined from data generated from a plurality of training samples, each training sample having a known feature;
(b) defining a model for the probability distribution of a feature wherein the model is conditional on the linear combination;
(c) constructing a prior distribution for the component weights of the linear combination comprising a hyperprior having a high probability density close to zero;
(d) combining the prior distribution and the model to generate a posterior distribution;
(e) identifying a subset of components having component weights that maximise the posterior distribution.
